(19) United States
(12) Patent Application Publication
(10) Pub. No.: US 2026/0245496 A1
(43) Pub. Date: Aug. 20, 2026

(54) SYSTEMS AND METHODS FOR INTEGRATED CONTROLLER/DRIVERS MODULE ON ONE PCB FOR LED DISPLAY

(71) Applicant: ALPHASCALE TECHNOLOGIES, INC., HILLSBOROUGH, CA (US)

(72) Inventors: GUFENG XI, HILLSBOROUGH, CA (US); WENJIE YANG, HILLSBOROUGH, CA (US); QI DONG, Changzhou, Jiangsu (CN)

(21) Appl. No.: 18/871,356

(22) PCT Filed: May 6, 2024
(86) PCT No.: PCT/US2024/028068

§ 371 Date: Dec. 3, 2024

Related U.S. Application Data
(60) Provisional application No. 63/500,054, filed on May 4, 2023.
(60) Provisional application No. 63/471,112, filed on Jun. 5, 2023.
(60) Provisional application No. 63/602,068, filed on Nov. 22, 2023.
(60) Provisional application No. 63/602,078, filed on Nov. 22, 2023.
(60) Provisional application No. 63/602,083, filed on Nov. 22, 2023.
(60) Provisional application No. 63/602,086, filed on Nov. 22, 2023.
(60) Provisional application No. 63/602,096, filed on Nov. 22, 2023.
(60) Provisional application No. 63/602,097, filed on Nov. 22, 2023.
(60) Provisional application No. 63/602,106, filed on Nov. 22, 2023.
(60) Provisional application No. 63/602,121, filed on Nov. 22, 2023.
(60) Provisional application No. 63/602,127, filed on Nov. 22, 2023.
(60) Provisional application No. 63/602,136, filed on Nov. 22, 2023.
(60) Provisional application No. 63/602,142, filed on Nov. 22, 2023.
(60) Provisional application No. 63/602,146, filed on Nov. 22, 2023.
(60) Provisional application No. 63/602,155, filed on Nov. 22, 2023.

(51) Int. Cl. G09G 3/32; G09G 3/20

(52) U.S. Cl. CPC G09G 3/32; G09G 3/2007; G09G 3/2096; G09G 2300/026; G09G 2310/08; G09G 2330/02; G09G 2370/14

(57) ABSTRACT

Systems and methods for Light Emitting Diode (LED) display. A LED display includes display panels connected to form the LED display. The LED display includes modules for controlling multiple LED lights in the LED display based on content of an image. Each of the modules integrates therein at least one controller and multiple drivers operating together to determine and control an amount of light emitted by each of the multiple LED lights in at least some of the display panels according to pixel values in a corresponding portion of the image. The at least one controller and the multiple drivers in each of the modules communicate via low voltage differential signaling (LVDS) signals.

### CROSS REFERENCE

The present application claims priority to U.S. provisional patent application no. 63/500,054, filed May 4, 2023; U.S. provisional patent application no. 63/471,112, filed Jun. 5, 2023; U.S. provisional patent application no. 63/602,068, filed Nov. 22, 2023; U.S. provisional patent application no. 63/602,078, filed Nov. 22, 2023; U.S. provisional patent application no. 63/602,083, filed Nov. 22, 2023; U.S. provisional patent application no. 63/602,086, filed Nov. 22, 2023; U.S. provisional patent application no. 63/602,096, filed Nov. 22, 2023; U.S. provisional patent application no. 63/602,097, filed Nov. 22, 2023; U.S. provisional patent application no. 63/602,106, filed Nov. 22, 2023; U.S. provisional patent application no. 63/602,121, filed Nov. 22, 2023; U.S. provisional patent application no. 63/602,127, filed Nov. 22, 2023; U.S. provisional patent application no. 63/602,136, filed Nov. 22, 2023; U.S. provisional patent application no. 63/602,142, filed Nov. 22, 2023; U.S. provisional patent application no. 63/602,146, filed Nov. 22, 2023; and U.S. provisional patent application no. 63/602,155, filed Nov. 22, 2023, the contents of which are incorporated herein in their entirety.

### BACKGROUND

### 1. Technical Field

The present disclosure relates to LED (Light Emitting Diode). More specifically, the present teaching relates to systems and methods for LED architecture.

### 2. Introduction

LEDs operate using a combination of drivers and controllers. LED drivers regulate and supply current and voltage to an LED light. LED drivers can also protect LEDs from voltage or current fluctuations. LED controllers can alter the power on each of the three channels (Red, Green, and Blue (RGB)), allowing to make a particular color mix on each pixel. In traditional architectures, the LED controllers and associated drivers reside on different modules and are therefore separated, requiring certain way to communicate, causing delays, degraded performance, additional power/processing requirements, and increased costs.

### SUMMARY

The teachings disclosed herein relate to methods, systems, and programming for information management. More particularly, the present teaching relates to methods, systems, and programming related to LED:

In one example, a system is disclosed for light emitting diode (LED) display, which includes display panels connected to form the LED display with multiple LED lights, modules for controlling the multiple LED lights in the LED display based on content of image. Each of the modules includes therein at least one controller and multiple drivers integrated therein to operate together to control an amount of light emitted by each LED light in the multiple LED lights in some of the display panels according to pixel values in a corresponding portion of the image, where the at least one controller and the multiple drivers in each of the modules communicate via low voltage differential signaling (LVDS) signals.

In another example, a method, implemented on a machine for achieving functions for displaying content of an image on display panels in an LED display, including controlling multiple LED lights in the LED display based on content of the image by determining an amount of light emitted by each LED light in the LED display according to pixel values in a corresponding portion of the image. The functions also include generating for at least one controller LVDS signals based on the content of the image and centralized grayscale clock signals to be transmitted to multiple drivers integrated with the at least controller so that such LVDS signals are used by the multiple drivers to determine the amount of light emitted by each LED light.

Additional advantages and novel features will be set forth in part in the description which follows, and in part will become apparent to those skilled in the art upon examination of the following and the accompanying drawings or may be learned by production or operation of the examples. The advantages of the present teachings may be realized and attained by practice or use of various aspects of the methodologies, instrumentalities and combinations set forth in the detailed examples discussed below.

### BRIEF DESCRIPTION OF THE DRAWINGS

The methods, systems and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1A illustrates a known example of multiple receiving cards interconnected using network wires, with each receiving card connected to multiple modules with drivers;

FIG. 1B illustrates a known example of the exterior of an LED screen;

FIG. 1C illustrates a known example of LED box including LED controllers, drivers, and LED lights;

FIG. 1D illustrates a known example mechanism for distributing video signals to LED drivers via serially connected receiving cards;

FIG. 2A illustrates a known example of internal architecture of a receiving card operating as a controller in traditional LED display;

FIG. 2B illustrates a known example of serial connections among receiving cards with physical network wires;

FIG. 2C illustrates a known example of receiving cards distributing control signals to RGB drivers via single-ended signals;

FIG. 3A illustrates a known example of a receiving card distributing information to a driver via single-ended signals and exemplary construct of a driver;

FIG. 3B illustrates a known example of distributing power to LED drivers;

FIG. 3C illustrates a known example of a driver with analog and digital modules where the digital module operates based DVDD signals generated internally by a driver based on VCC;

FIG. 3D illustrates a known example of a driver that generates its own GCLK signal internally based on DCLK provided by a controller;

FIG. 3E shows two-frame delays between transmission of frame data from a transmitting card to display of the frame data (or a portion of a frame) carried out by a driver;

FIG. 3F illustrates a known example of packaging for a driver chip with 24 in/out pins;

FIG. 4A depicts an example architecture where modules integrate both controllers and drivers on the same PCB, according to the present teaching;

FIG. 4B illustrates example connections of LED boxes, having integrated modules each of which incorporating both controllers and drivers on the same PCB, according to the principles disclosed herein;

FIG. 5A illustrates an example partial internal structure of an integrated module with an LED controller connected via LVDS signals to multiple drivers, according to the present teaching;

FIG. 5B shows an example of a controller in an integrated module to provide both RGB and GCLK (grayscale clock) via LVDS (Low Voltage Differential Signaling) with common shared DVDD (Digital Voltage Drain Drain) supplied to all drivers in the same PCB, according to the present teaching;

FIG. 5C illustrates an example of supplying both VCC and a DVDD (digital power) to all drivers on the same PCB, according to the present teaching;

FIG. 6A shows that each driver is supplied with DVDD signal so that it no longer needs to generate the DVDD signal internally, according to the present teaching;

FIG. 6B illustrates an example of the internal structure of two serially connected drivers via RGB LVDS signals, according to the present teaching;

FIG. 7A illustrates an example of integrated modules serially connected via 4-way SGMII (Serial Gigabit Media-Independent Interface) with self-error detection and dynamic re-routing for fault tolerance, according to the present teaching;

FIG. 7B shows that the delay in LED display using the present teaching is reduced to one-frame delay as compared to the illustrated in FIG. 3E;

FIG. 8A illustrates an example 4-way SerDes (Serializer/De-serializer) with 4 normal routes (two in one direction and two in the opposite direction);

FIG. 8B illustrates an example 4-way SerDes with four alternative routes that may be configured on-the-fly when a failure is detected;

FIG. 8C illustrates an example transmission path across different controllers serially connected via multiple 4-way SerDes in a normal operation;

FIG. 8D illustrates an example of a reconfigured transmission path across different controllers dynamically realized via a 4-way SerDes when a failure is detected in a normal path;

FIG. 8E illustrates another exemplary of a reconfigured transmission path across different controllers via multiple 4-way SerDes to avoid points of failure detected in operation;

FIG. 9A illustrates an example internal construct of a 4-way SerDes with a buffer for each route and a protocol analyzer that controls the buffering of data/instruction directed thereto;

FIG. 9B illustrates an exemplary flowchart of normal operation of a SerDes;

FIG. 9C illustrates an exemplary flowchart of performing a test on A-terminals (left to right) to determine whether the normal routes are functioning properly;

FIG. 9D illustrates an exemplary flowchart of performing a test on B-terminals (right to left) to determine whether the normal routes are functioning properly;

FIG. 10A illustrates an exemplary construct of an LED controller in an integrated module that generates both RGB and GCLK LVDS signals based on data that is enhanced and PC (parasitic capacitance) corrected centrally in the controller via SRAM (Static Random Access Memory), according to the present teaching;

FIG. 10B illustrates exemplary types of corrections to be carried out centrally by a controller, according to the present teaching;

FIG. 10C illustrates an exemplary flowchart of operations centrally performed by an LED controller;

FIG. 11A illustrates an exemplary construct of a time-spatial enhancement unit in connection with an SRAM in a controller for performing centrally both time and spatial data enhancement, according to the present teaching;

FIG. 11B illustrates an exemplary flowchart of a time-spatial enhancement unit to carry out both time and spatial domain data enhancement, according to the present teaching;

FIG. 11C illustrates the concept of the Floyd-Stenberg's spatial enhancement scheme;

FIG. 11D illustrates an exemplary space allocation within an SRAM in an LED controller for realizing temporal-spatial enhancement, according to the present teaching;

FIG. 12A illustrates an exemplary construct of an image scan controller in an LED controller in an integrated module, according to the present teaching;

FIG. 12B illustrates an exemplary flowchart of an image scan controller, according to the present teaching;

FIG. 13A illustrates an exemplary construct of a computation module in an image scan controller of an LED controller, according to the present teaching;

FIG. 13B illustrates an exemplary flowchart of a computation module, according to the present teaching;

FIG. 14 illustrates that GCLK LVDS from a controller to all drivers in the same integrated module (shown in FIG. 5B) are generated based on clock signals from a centrally located PLL (Phase-Locked Loop) in the controller so that a PLL circuit is no longer needed in each driver (as compared with FIG. 3D), according to the present teaching;

FIG. 15A illustrates an example of a 4-times scheme that may be used to generate a variable grayscale clock, according to the present teaching;

FIG. 15B illustrates an example of using a 4-times scheme to generate a grayscale clock with a more refined and higher resolution;

FIG. 15C illustrates an example timing which may be used to achieve frequency conversion, according to the present teaching;

FIG. 15D illustrates an example of using a subtraction to derive a variable grayscale clock, according to the present teaching;

FIG. 16A illustrates an example LVDS connection between a controller and RGB drivers that are in the same integrated module, according to the present teaching;

FIG. 16B illustrates an exemplary construct of a driver, according to the present teaching;

FIG. 17A illustrates an exemplary flowchart of a driver in a configuration mode, according to the present teaching;

FIG. 17B illustrates an exemplary flowchart of a driver in a screen refreshing mode, according to the present teaching;

FIG. 18A illustrates exemplary event sequence and timing thereof associated with each LED light in a traditional LED system;

FIG. 18B illustrates an example of inference due to high low grayscale coupling;

FIG. 19 illustrates an example of an updated event sequence and timing for minimizing interference associated with high low grayscale coupling, according to the present teaching;

FIG. 20A-20C illustrate different scenarios where synchronous data/clock may become misaligned from a transmission end to a receiving end;

FIG. 21 illustrates a new scheme to ensure correct data sampling to overcome the impact of unintended data/clock misalignment, according to the present teaching;

FIG. 22 illustrates an exemplary chip packaging with the same number of pins as a conventional packaging (as in FIG. 3F) yet accommodating LVDS based signal communication between chips, according to the present teaching; and

FIG. 23 illustrates the architecture of a computing device that can be used to implement the present teaching.

### DETAILED DESCRIPTION

Various embodiments of the disclosure are described in detail below. While specific implementations are described, this is done for illustration purposes only. Other components and configurations may be used without parting from the spirit and scope of the disclosure.

The present teaching is directed to the architecture of LED display. Conventionally, controllers (receivers) and drivers reside in different and separate modules and PCBs. As such, the serial connections between different receivers are via network wires, limiting the transmission speed, causing the bottleneck, and leading to a ceiling on the performance of the LED display. Also due to the separation of controllers from drivers, certain processing tasks have to be performed in individual drivers, e.g., generation of needed clock signals, data enhancement/correction, DVDD signals for facilitating the digital processing within a driver, and accordingly the need to have SRAM in each driver. As such needed operations to be performed within each driver, corresponding circuitries are also needed in each driver. This not only increases the cost of drivers but also degrades their performances.

The present teaching discloses an improved architecture for LED display, where controllers and drivers reside together in integrated modules on the same PCB. The improved architecture enables various enhanced features. This includes transmitting data (including RGB pixel data and instructions) and grayscale clocks (GCLK) from controllers to drivers or to other serially connected controllers via LVDS to allow a much-enhanced speed. Because of that, certain processing performed by drivers can be centrally carried out. For example, data correction, data enhancement, and parasitic capacitance correction may now be centrally carried out by controllers and the processed data may then be transmitted to drivers for display. As such, circuitries and memory storage (e.g., SRAM) traditionally included in drivers to enable such functions locally in each driver are now no longer needed, making drivers according to the present teaching much more light weight and cost effective. As controllers and drivers in integrated modules reside on the same PCB, various signals traditionally generated on each driver such as DVDD may also be centrally generated and sent to all drivers on the same PCB. The integrated modular structure according to the present teaching yields an improved frame delay as compared with that of the traditional LED display architecture.

The present teaching utilizes 4-way SerDes for information (data or instructions) transmission across serially connected controllers with fault tolerant capabilities. Failures in connections may be detected dynamically and viable transmission path(s) may be accordingly reconfigured on-the-fly. This enhances the reliability of data transport at a high speed in transmitting RGB LVDS and GCLK LVDS. Due to the enhanced speed, a controller according to the present teaching is provided with the capability of carrying out both time and spatial domain image data enhancement.

There are other aspects of the present teaching for making the LED display constructed based on the new architecture to achieve further enhanced performances. A k-times scheme is disclosed which enables generation of variable grayscale clock signals at different frequencies, making it possible to achieve LED display at different higher resolutions. In addition, to accommodate the timing difference between GCLK LVDS received in parallel by drivers and the RGB LVDS received from integrated controllers via a serial manner, delays are introduced at drivers to control data sampling with a timing that ensures correct data sampling.

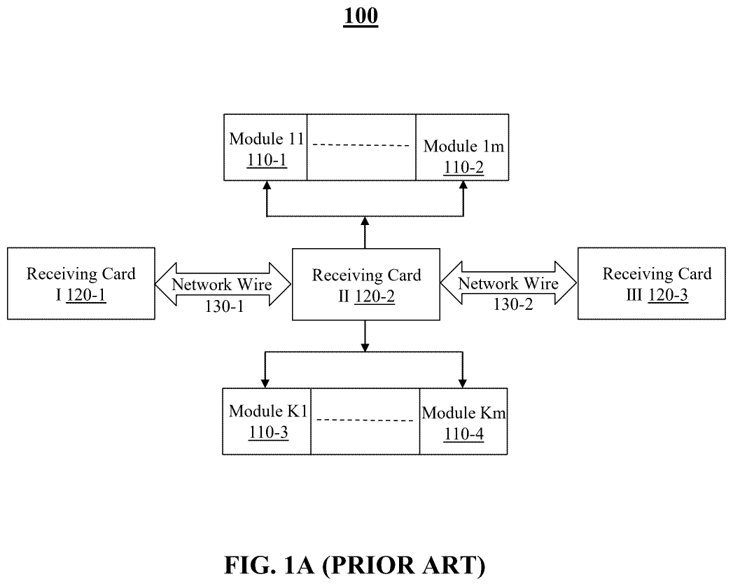

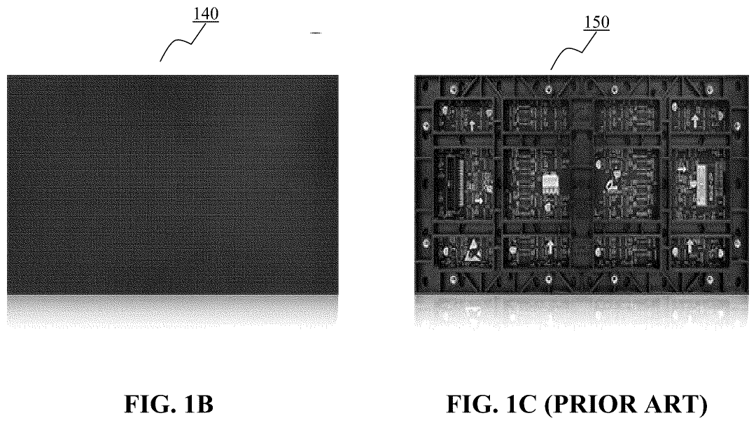

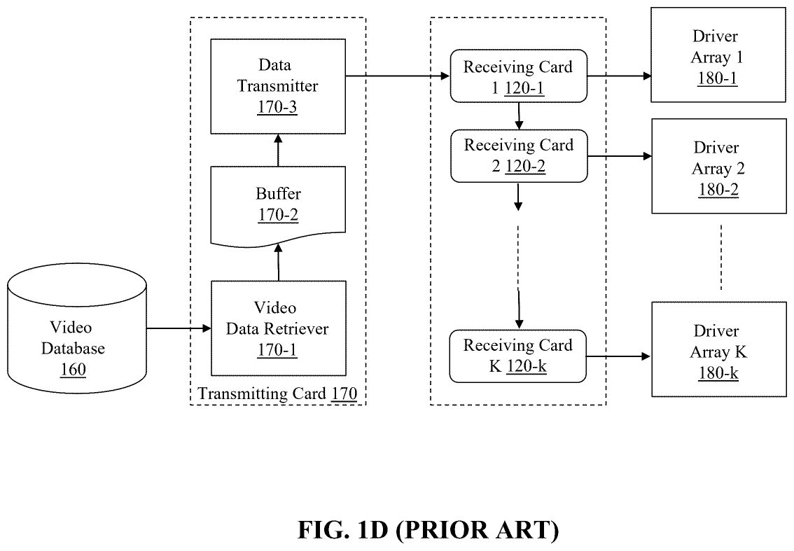

FIG. 1A illustrates a known example of multiple receiving cards 120-1, 120-2, 120-3 interconnected in series using network wires 130-1, 130-2. Each receiving card functions as a controller to control multiple drivers connected thereto. In the example shown in FIG. 1A, an exemplary receiving card 120-2 connects drivers in multiple modules 110-1, . . . , 110-2, 110-3, . . . , 110-4.

FIG. 1B illustrates a known example of the exterior of an LED screen. The LED screen is composed of LED modules. The front of the LED module is made of LED lamp beads. Each LED pixel includes three lights corresponding to red, green, and blue (RGB) lights.

FIG. 1C shows a known example of the back of a LED panel which may include one or more of: LED controllers and drivers, a power interface, a data interface, and/or some transceiver chips.

FIG. 1D shows a known example mechanism for distributing video signals to LED drivers via serially connected receiving cards. With this conventional mechanism, a frame of a video is retrieved from a video database 160 by a transmitting card 170, which then sends the retrieved data of the video frame to serially connected receiving cards. Each receiving card is connected to drivers in a driver array, designated to render a part of the video frame on the LED display screen. When the frame data is passing through the receiving cards, each receiving card retains the part of the frame data designated thereto and passes on the rest to the next serially connected receiving card. With respect to the designated video frame data, each receiving card provides the retained frame data to the connected drivers in the driver array for display.

Within the transmitting card 170, a video data retriever 170-1 retrieves the frame data from the video database 160 and forwards that frame data to a buffer 170-2. A data transmitter 170-3 retrieves the data from the buffer 170-2 and transmits it to a first receiving card 120-1. The first receiving card 120-1 connects to a first driver array 180-1 which produces LED lights on a certain portion of the LED display screen based on a portion of the frame data that it is designated to handle. The first receiving card 120-1 passes on the rest of the frame data to a serially connected second receiving card 120-2, which has its corresponding driver array 180-2 for handling another corresponding part of the frame data. Likewise, the second receiving card 120-2 is connected to an additional receiving card (with an additional associated driver array), and forwards any information received which is not designated to the second driver array 180-2 to the next serially connected receiving card. This process continues until a final receiving card k 120-k, with its associated driver array 180-k, designated to render the last portion of the frame data on the remaining portion of the LED display screen.

In this traditional LED mechanism, receiving cards operate as controllers, each of which controls the operation of an array of drivers connected thereto for rendering a designated portion of the frame data. As shown, receiving cards in the traditional LED mechanism and drivers controlled by these receiving cards reside in separate modules and PCBs. In addition, different receiving cards also reside in different modules. Such a physical arrangement restricts how receiving cards and the connected driver arrays as well as the serially connected receiving cards communicate, causing limitations on LED performances and increased cost.

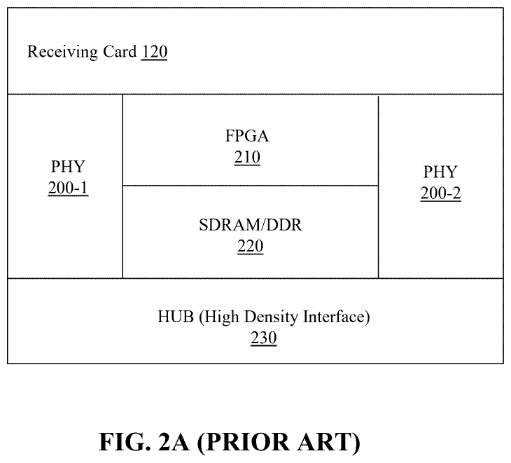

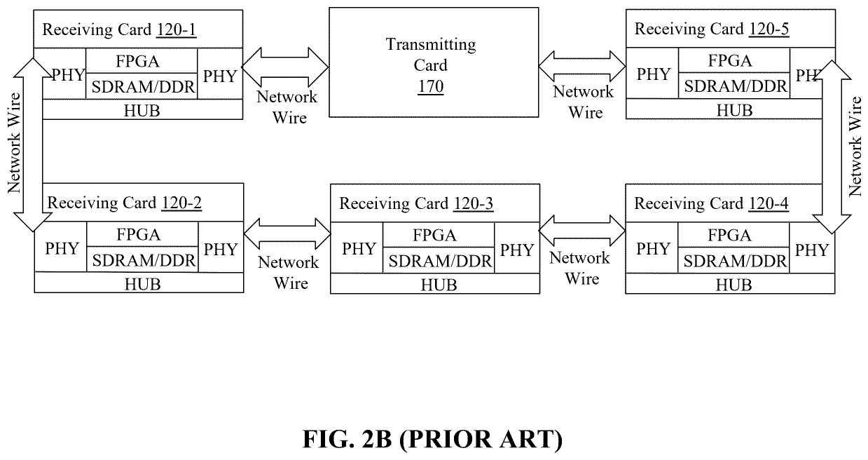

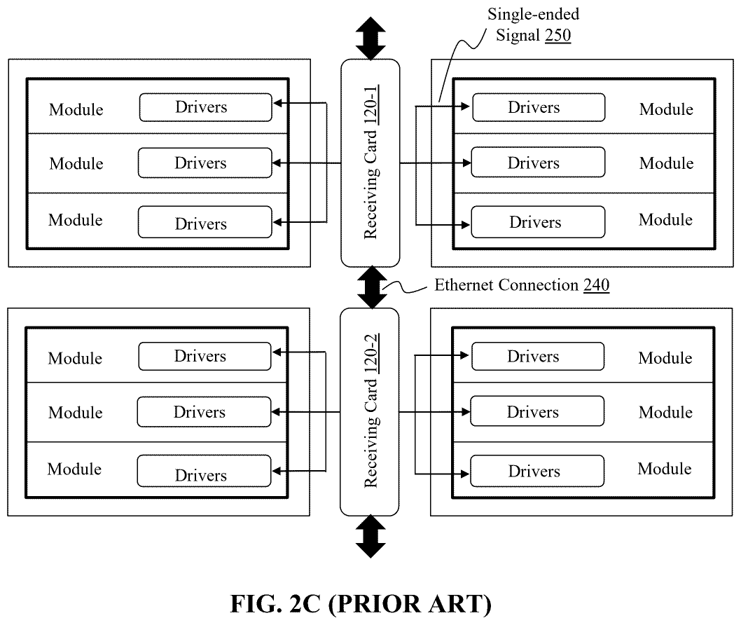

FIG. 2A illustrates a known example of an exemplary receiving card 120. In this example, the receiving card 120 includes an FPGA (Field Programmable Gate Array) 210, which can be configured to perform calculations or other data manipulations as required. The receiving card 120 also includes a memory 220, such as SDRAM (Synchronous Dynamic Random Access Memory) and/or DDR (Double Data Rate) memory. The receiving card 120 may have two physical ports 200-1 and 200-2 for receiving information from either the transmitting card 170 or from another serially connected receiving card and forwarding the frame data designated to other receiving cards. The receiving card 120 may also include a high-density interface (HUB) 230 which may be used by the receiving card to transmit data to the connected driver array. It is noted that the communications between the receiving card 120 and another serially connected receiving card is via a physical port (either 200-1 or 200-2), which limits the speed in data transmission. In addition, as a FPGA generally is more expensive, the use of a FPGA increases the cost of a receiving card.

FIG. 2B illustrates a known example of interconnections between receiving cards. As illustrated, a transmitting card 170 transmits frame data to a first of 5 illustrated serially connected receiving cards via network wire, in either a clockwise or counterclockwise directions. In one direction, frame data is transmitted to a physical port of the receiving card 120-1 which then propagates data designated to other receiving cards via the other physical port via a network wire. Similarly, receiving card 120-2 receives the propagated frame data at one of its physical ports via a network wire and propagates the remaining frame data designated to other receiving cards through the other physical port via a network wire, etc. The information provided to the receiving cards 120-1, 120-2, 120-3, 120-4, 120-5 may be propagated in the other direction (i.e., in parallel), providing redundancy to the system path for distributing the image information. As illustrated, the frame data transmission in either direction is both through the physical ports via network wires, which limits the speed of the data transport.

As discussed herein, each receiving card is provided for control drivers in a driver array for rendering a portion of the frame data at a corresponding portion of the LED screen. Upon receiving frame data designated thereto at a receiving card, it transmits the designated frame data to the connected drivers with some control signals. FIG. 2C illustrates a known example of serially connected receiving cards connecting to associated drivers. In this example, two receiving cards (120-1 and 120-2) are illustrated. Receiving cards 120-1 and 120-2 are serially connected via network wires, e.g., Ethernet connections 240. Each of the receiving cards is respectively connected to different driver modules, each of which comprises a plurality of RGB drivers for distributing control signals (including frame data and instructions) to the RGB drivers. The signal transmissions from a receiving card to RGB drivers are through single-ended signals 250. As discussed herein, the use of network wires 240 to conduct information transmission between different receiving cards limits the transmission speed. It is also noted that the use of single-ended signals 250 as shown in FIG. 2C also provides limitations on the speed to send data/instructions from a receiving card to its connected RGB drivers.

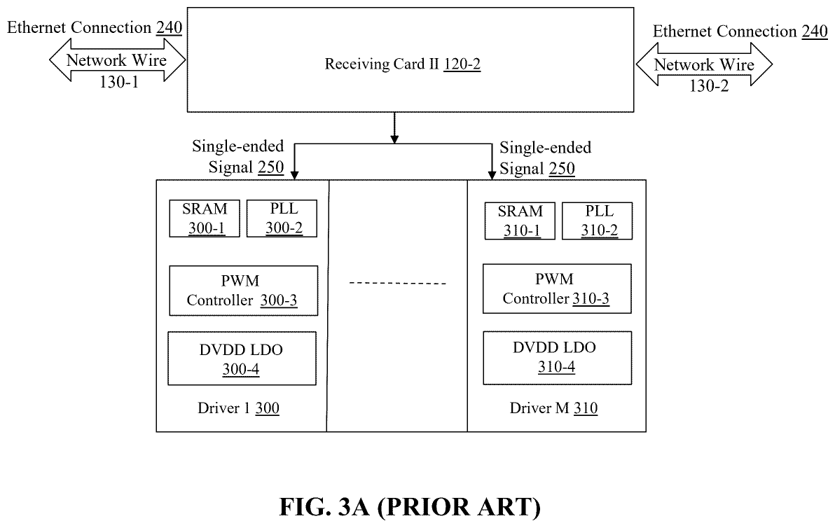

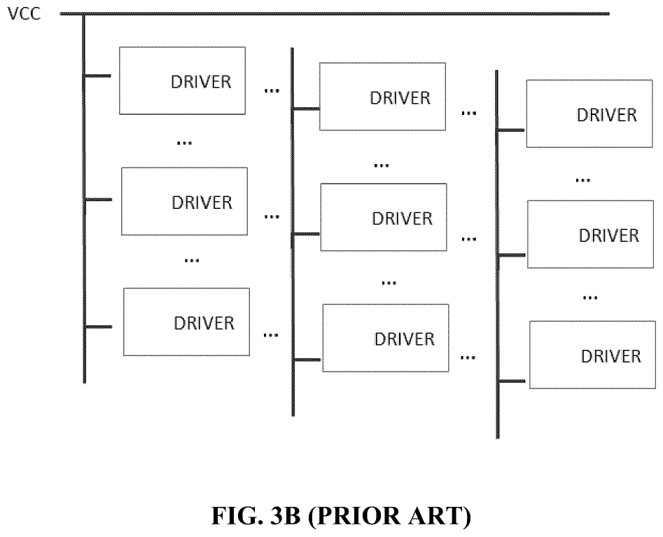

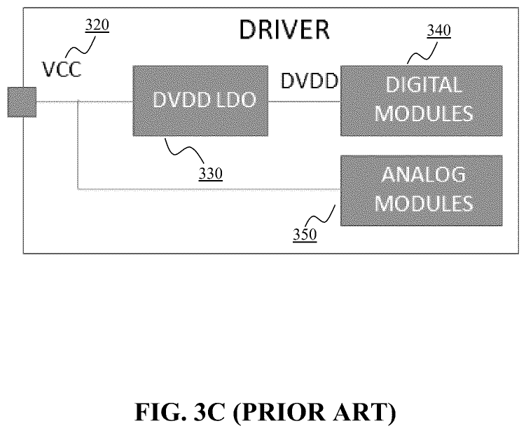

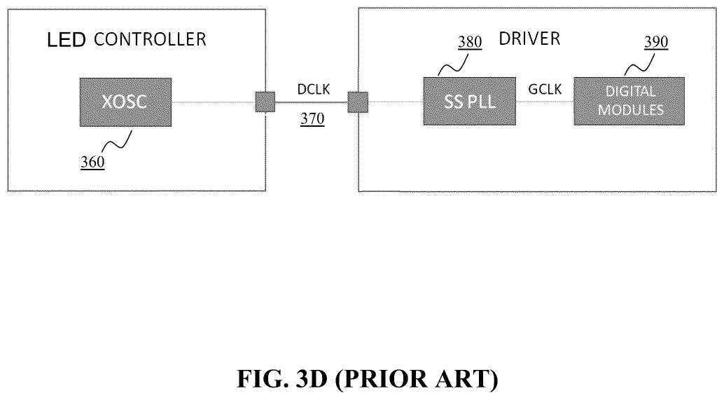

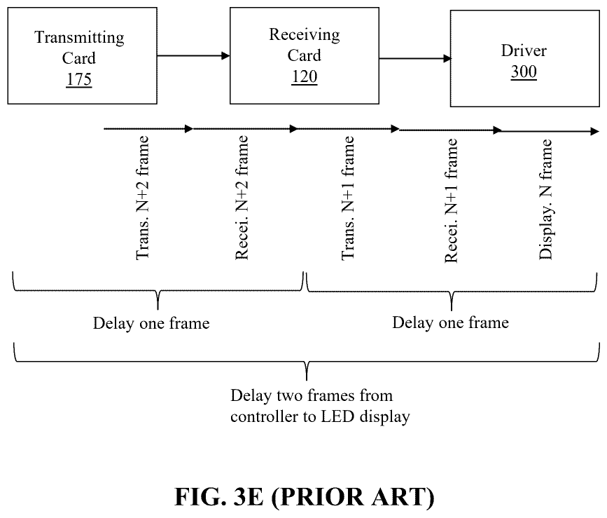

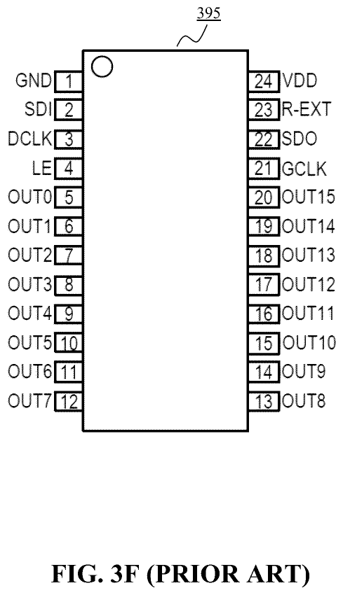

FIG. 3A illustrates a known example of a receiving card distributing information to a driver via single-ended signals and exemplary construct of a driver. In this example, the receiving card II 120-2 receives frame data via a first network wire 130-1 (such as an Ethernet connection 240), then forwards any information intended for other receiving cards to an additional receiving card via a second network wire 130-2 (which may also be an Ethernet connection 240). The information intended for receiving card II 120-2 is then distributed to drivers 300, . . . , 310 with instructions via single-ended signals 250 to those drivers. As illustrated, each driver in a traditional LED mechanism comprises its own SRAM (Static Random Access Memory) 300-1, a PLL (Phase Locked Loop) 300-2, a PWM (Pulse Width Modulation) controller 300-3, and a DVDD (Digital Voltage Drain Drain) LDO (Low Drop Out regulator) 300-4. Each driver is configured to process the frame data received. The PLL and DVDD LDO work together to generate the signals required for the driver to render visual information via LED lights based on the relevant frame data received. That is, each driver is equipped with different circuitries to facilitate the local processing of the designated frame data, which increases the cost of the drivers.

FIG. 3B illustrates a known example of distributing power to LED drivers. In this example, VCC (Voltage Common Collector) is provided to all of the drivers. FIG. 3C illustrates a known example of a driver with analog modules 340 and digital modules 350. The digital modules 340 operate on DVDD signals, which are generated internally by circuitry DVDD LDO 330 within the driver based on VCC 320. In this example, the VCC 320 is provided to the driver as shown in FIG. 3B and then used by circuitry DVDD LDO 330 to generate DVDD signals, which is used by the digital modules 340 to perform digital processing. This example shows that to provide DVDD signals needed for digital processing, each driver is equipped with the DVDD LDO circuitry.

FIG. 3D illustrates a known example of partial internal construct of a driver with circuitry for generating internally its own grayscale clock signal (GCLK) based on DCLK signal provided by a controller. In this example, the LED controller has an XOSC (a Crystal Oscillator) 360 which produces a digital clock signal DCLK 370 and sends to a connected driver. The driver includes a SS (Sub-sampling) PLL (Phase-Locked Loop) 380 and digital modules 390. To facilitate the processing of the digital modules 390, the SS PLL circuitry 380 generates the GCLK for the driver based on the received DCLK 370. The digital modules 390 then use the GCLK to time the outputs of the modules, as well as the transfer of information to/from buffers. It is noted that each driver in a traditional LED system is equipped with its own PLL circuitry to facilitate the digital modules therein, which again increases the costs.

FIG. 3E shows two-frame delays between transmission of frame data from a transmitting card 175 to display of the frame data (or a portion of a frame) carried out by a driver 300. As the transmitting card 175 transmits data in a video frame (N+2) the receiving card 120, the receiving card 120 is sending data of a previous video frame (N+1) to driver 300, and the driver 300 is rendering data from an even earlier frame (N) on LED panel. That is, between transmission to rendering, there is a two-frame delay. The resulting latency may be reduced and/or mitigated using the new architecture of the LED display discussed herein according to the present teaching.

FIG. 3F illustrates a known example of packaging 395 of a driver chip with 24 in/out pins. Preferably, packaging of a driver constructed as disclosed herein according to the present teaching would have the same or similar packaging to that as illustrated in FIG. 3F with, e.g., a similar shape and the same number of pins. However, the inputs and/or outputs of the pins may change as required by specific configurations.

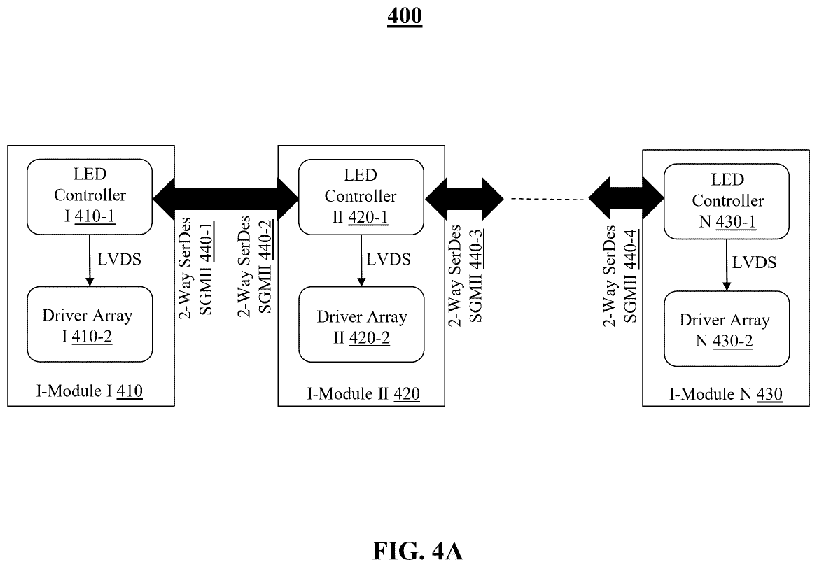

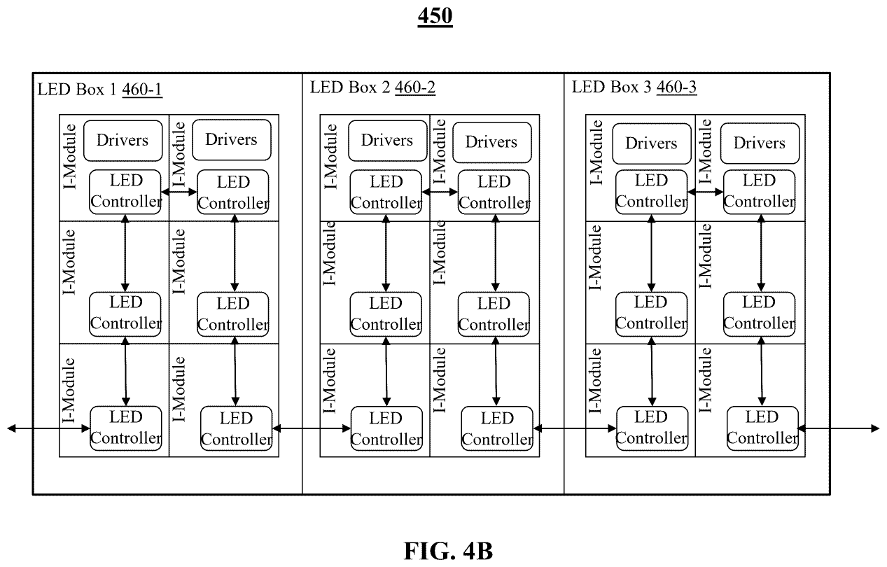

FIG. 4A depicts an exemplary architecture with a plurality of integrated modules, each integrating controllers with drivers on the same PCB, according to the present teaching. As shown, there are multiple N integrated modules (I-modules) 410, 420, . . . , 430, each with a controller and drivers controlled by the controller. For example, I-module I 410 integrates, in one module, a controller 410-1 and drivers in a driver array 410-2 controlled by controller 410-1. Similarly, I-module II 420 integrates, in a single module, a controller 420-1 and drivers in driver array 420-2 controlled by controller 420-1, . . . , and I-module N 430 integrates, in one module, a controller 430-1 and drivers in driver array 430-2 controlled by controller 430-1. In this way, each controller now resides in the same module as drivers in the driver array that it is connected to. In some embodiments, each I-module (410, 420, . . . , or 430) may correspond to a PCB. In some embodiments, multiple I-modules may reside on the same PCB. However, each controller and the driver array that it controls always reside in the same module.

The integration of controller and its controlled drivers in the same module enables different data transmission scheme, yielding, among other things, more efficient information transmission, enhanced LED display performance, and cost reduction. For example, because controllers and drivers are now in the same module, a more efficient data transmission approach may be adopted such as the low voltage differential signaling (LVDS) may be used to transmit signals from controllers to drivers, as shown in FIG. 4A. LVDS based data transport may be carried out not only at a higher frequency than traditional single-ended signaling but also more reliable. That is, the communication between controllers and drivers under the LED architecture according to the present teaching can be carried out at a faster speed with an improved reliability.

In addition, the communications between different I-modules 410, 420, 430 (e.g., the serial connections among controllers in different I-modules as shown in FIG. 4A) may utilize SGMII (Serial Gigabit Media-Independent Interface) or SERDES (Serializer/De-serializer) to achieve enhanced reliability and fault tolerance and at the same time save cost, when the physical connections such as network wires are replaced.

FIG. 4B illustrates example organization of different LED boxes and connections thereof, according to the present teaching. This exemplary LED system 450 comprises a plurality of serially connected LED boxes 460-1, 460-2, . . . , 460-3, according to the principles of the present teaching as disclosed herein. Each LED box has one or more I-modules, with each I-module having an LED controller and multiple LED drivers. Each LED box is associated with a portion of the LED display screen, with individual I-modules therein being responsible for illuminating respective portions of the LED screen in corresponding regions. In some embodiments, each I-module will have one controller and multiple drivers. In each I-module, the controller is configured for performing various centralized processing generating signals to the connected drivers to enable illumination of LED lights according to the video frame data. Within each LED box, the I-modules therein are serially connected via controllers. For instance, in LED box I 461-1, frame data is received by the I-module located in the lower left corner and it propagates the received data to the I-module above it, which further propagates to the I-module at the upper left corner, which then forwards the data to the I-module to its right, and then to the I-module downward until the I-module at the lower right corner of the LED box I 460-1. At that point, the frame data has been traversed across all I-modules in LED box I 460-1. The last I-module at the lower right corner further propagates the data to the I-module at the lower left corner of LED Box II 460-2. This propagation continues until all I-modules in all LED boxes receive the data they are designated to process.

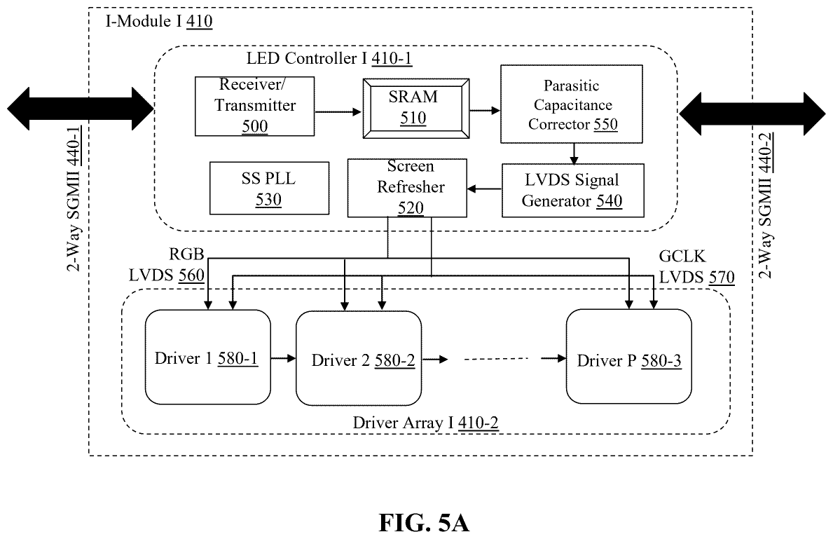

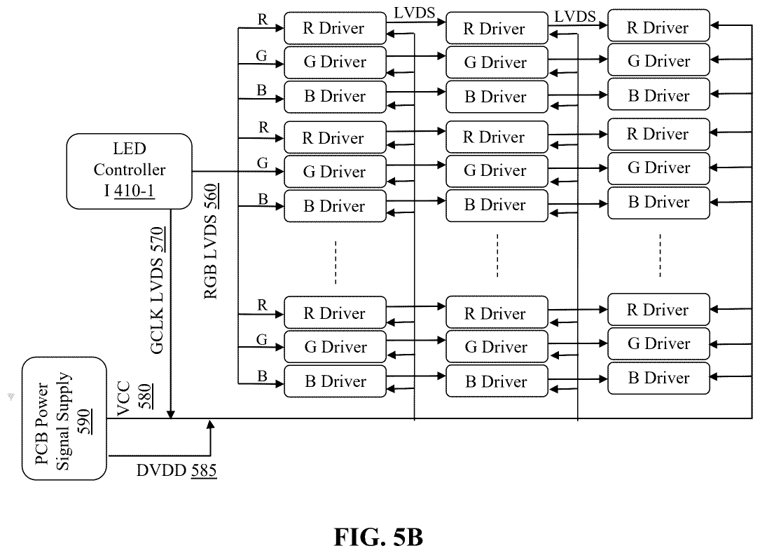

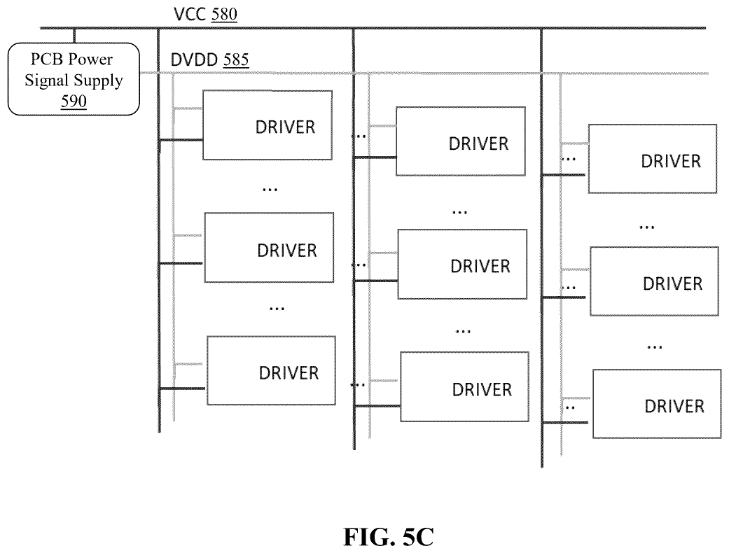

FIG. 5A illustrates an exemplary partial internal structure of an integrated module with an LED controller connected via LVDS signals to multiple drivers, according to the present teaching. An integrated module I-module 410 comprises an LED controller 410-1 and multiple drivers 580-1, 580-2, . . . , 580-3 in a driver array I 410-2. As discussed herein, the communications between controller 410-1 and other serially connected controllers in other I-modules is, in this illustrated embodiment, through 2-way SGMII communication pathways 440-1 and 440-2. As the controller 410-1 and the associated drivers in driver array I 410-2 reside on the same PCB, the connections between the controller 410-1 and drivers 580-1, 580-2, . . . , 580-3 may use LVDS to improve speed and reliability. The communications between controller 410-1 and driver array I 410-2 includes transmission of RGB signals 560 as well as grayscale clock (GCLK) signal 570, both in the form of LVDS signals.

As now each controller resides in the same module as the drivers that it controls on the same PCB and the data transport speed between a controller and drivers is faster and more reliable, certain functions and circuitries that are traditionally implemented in each and every driver may be centralized to make drivers more efficient and cost effective. Different functionalities that may be centrally carried out may be performed by controllers and circuits provided for achieve the functionalities may be consolidated in controllers. In this manner, drivers no longer need to install such circuits to perform these centralized functions. This makes the drivers according to the present teaching light weight, more efficient, and with reduced cost. In addition, with more data/control signals generated centrally, the performance under such data/control signals across different drivers are accordingly more coherent.

When LVDS is used for transmitting both RGB data as well as grayscale clock signal (GCLK) according to the present teaching, there is no longer a need for individual drivers to generate their own GCLK signals. As such, circuits in drivers for generating GCLK signals are also no longer needed. In addition, certain processing to be performed on image data may also be performed centrally by controllers and then processed image data may then be sent to drivers for display. Examples of such image data processing may include image data correction and enhancement, including gamma correction to image data as well as time and/spatial video data enhancement. With such data processing performed centrally, circuits for performing such functions may also be consolidated in controllers and removed from drivers for cost saving without impacting performance. As another example, parasitic capacitance (PC) correction is traditionally performed by individual drivers based on different characteristics associated with LED lights. However, such PC correction may also be centralized at a controller based on known individual characteristics of different LED lights. Similarly, with such centralization, circuits for performing PC correction in each driver may be eliminated and consolidated in a controller. All these reduce the burden on and reduce the cost of the drivers according to the present teaching.

As such, an LED controller may be constructed and configured to include various circuits and functions that are traditionally reside and duplicated in drivers. As illustrated in FIG. 5A, controller 410-1 in I-module I 410 includes various components/circuits that represent improvements of the present teaching. For instance, controller 410-1 includes a receiver/transmitter 500 for receiving/transmitting frame data, via 2-way SGMII SerDes 440-1 and 440-2, from/to serially connected controllers in other I-modules. Controller 410-1 further includes a SRAM 510 for buffering data and for supporting data processing as well as a screen refresher 520 for generating refresher signaling instructions according to the present teaching. As disclosed herein, controller 410-1 also includes various circuits/functions that are consolidated from different drivers to carry out centralized processing. This includes, e.g., a LVDS signal generator 540 for generating central control GCLK signal as well as RGB signals to be distributed to all connected drivers. Other consolidated circuits/functions include an SS PLL 530 for generating signals for digital processing and a PC corrector 550 for carrying out centralized PC correction to produce PC corrected image data before RGB LVDS signals are generated. Other centralized circuits/functions may also be consolidated such as time/spatial data enhancement (not shown in FIG. 5A).

As much of the computation may now be consolidated at a controller, SDRAM 510 provided in a controller may be provided with to increased capacity and speed. However, as the SRAMs previously provided in all drivers for, e.g., image enhancement, are no longer needed, the overall cost under the architecture according to the present teaching is reduced. The centralized parasitic capacitance corrector 550 produces PC corrected instructions per each LED light based on the PC characteristics of individual LED lights.

A process for PC correction may involve the following steps: (1) read the gray value (R, G, or B) of each pixel, (2) calculate the gray value of the current subframe (a frame is split into multiple subframes), and (3) access the known parasitic capacitance correction parameters associated with the RGB LED lights corresponding to this pixel (each of the RGB LED lights corresponding to this pixel has a separate correction parameter), and (4) compute the PC corrected gray value in each color channel as the gray value of the current subframe+the parasitic capacitance correction parameter.

As discussed herein, controller 410-1 includes an LVDS signal generator 540 for generating LVDS signal(s) 560, 570, which are sent to the drivers in the driver array 410-2. Details related to LVDS signal generation will be provided below. The screen refresher 520 may be provided for performing processing/computation previously performed by an FPGA in a traditional LED system. In some embodiments, drivers 580-1, 580-2, . . . , 580-3 within the driver array 410-2 may correspond to RGB drivers per pixel as shown in FIG. 5B. In some configurations, each I-module may only be connected to a single driver (as opposed to multiple) or may include drivers associated with a single color (e.g., monochrome displays).

The number of pixels in an LED display handled by a module may be is related to the pixel pitch. The smaller the pixel pitch, the more pixels a module 410 may be associated with. Because of this, an I-module may include either one or more controllers. For example, if a single controller supports 128*128 pixels, then a module with a pixel count less than or equal to 128*128 needs only a single controller. If a module needs to cover more pixels than 128*128 (e.g., 256*128 or 256*256), then the module may include two or more controllers.

FIG. 5B shows an example of centrally supplying various signals to drivers without needing each driver to generate such signals, according to the present teaching. As shown, an LED controller 410-1 in an I-module generates and sends centrally generated RGB LVDS 560 and GCLK LVDS 570 signals to all RGB drivers in the same I-module. As also shown, a PCB power signal supply circuit 590 generates common shared DVDD signal 585 and provides the centrally generated DVDD signal 585, along with the VCC 580, to all RGB drivers as well as the controller(s) on the same PCB. This is also illustrated in a different form in FIG. 5C. As discussed herein, in a traditional LED system, both GCLK and DVDD signals are generated by each driver using circuits configured therein. For example, the DVDD LDO circuit 330 in each driver in a traditional LED system (see FIG. 3C) is for generating DVDD signals and the SS PLL circuit 380 in each driver (see FIG. 3D) is for generating GCLK signals. With the present teaching, as the generation of both GCLK and DVDD signals is consolidated centrally on controller/PCB, the DVDD LDO circuit 330 and SS PLL circuit 380 are no longer needed, reducing the circuitry and cost of the drivers.

In some embodiments, an LED system may include multiple PCBs and a single power supply may be provided to supply power to multiple PCBs. For example, a single power supply can power 4-8 PCBs. In some embodiments, each PCB can have its own power supply that generates different needed voltages. For instance, an external power supply may input 3.8V to the PCB (or another voltage; alternatively, the external power supply can provide power within a predefined range, e.g., 3.8 V+/−0.01 V), and the DC-DC converter on the PCB can convert the 3.8V to 2.8V. 3.8V can then be used to drive blue and green lights, while 2.8V can be used to drive the red lights. Although some specific voltages may be used to illustrate the point, they are not provided to limit the scope of the present teaching.

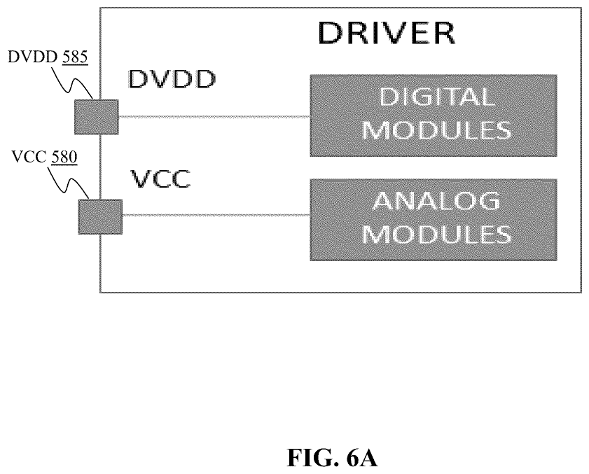

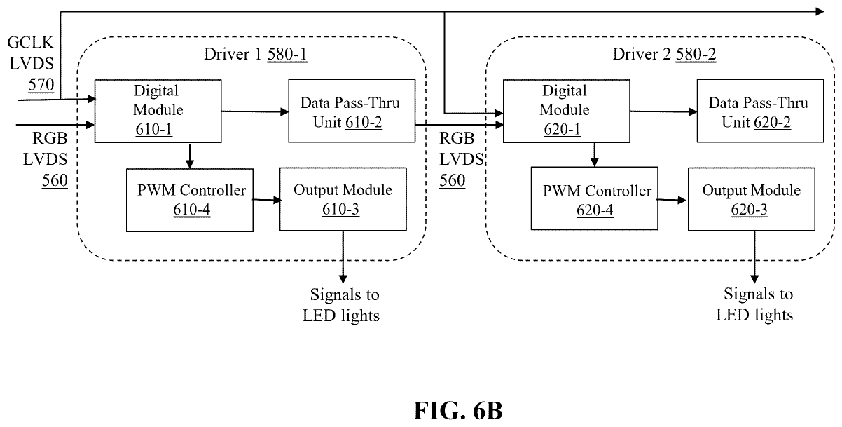

As discussed herein, DVDD signal is used for facilitating digital modules in drivers for processing digital signals. FIG. 6A illustrates an example of a driver according to the present teaching that receives both VCC 580 and DVDD 585, without the driver itself generating the DVDD 585 signal based on VCC 580 (as was done in traditional LED system as shown in FIG. 3C). The received DVDD signal is provided directly to the digital modules to facilitate its operations.

Drivers in a driver array in an integrated module may receive GCLK LVDS signals from a controller in the same module in parallel but receive RGB LVDS signals in series via propagation based on serial connections of the drivers. FIG. 6B illustrates an example of how drivers are serially connected to propagate RGB LVDS signals and exemplary internal construct in each driver, according to the present teaching. In this example, two drivers, i.e., driver 1 580-1 and driver 2 580-2, are used for illustrating the propagation and each is presented with some internal component circuits. As shown, both drivers have the same component configuration. For instance, driver 1 580-1 comprises a digital module 610-1, a data pass-through unit 610-2, a PWM (Pulse Width Modulation) controller 610-4, and an output module 610-3. Similarly, driver 2 580-2 comprises its digital module 620-1, a data pass-through unit 620-2, a PWM controller 620-4, and an output module 620-3. In operation, the digital module (610-1 or 620-1) in each driver is provided for receiving GCLK LVDS signals in parallel. The digital module in each driver also receives RGB LVDS signals in series. As seen in FIG. 6B, when driver 1 580-1 receives RGB LVDS 560, the digital module 610-1 retains the RGB frame data intended for driver 1 and propagates other RGB frame data via the data pass-through unit 610-2 to driver 2 580-2, where the digital module 620-1 in driver 2 580-2 receives the RGB LVDS frame data propagated by the data pass-through unit 610-2 in driver 1 580-1. The digital module 620-1 in driver 2 580-2 then performs the same, retaining frame data intended for driver 2 and then the data pass-through unit 620-2 in driver 2 propagates the remaining RGB data to the next serially connected driver, etc.

The PWM controller in each driver (610-4 or 620-4) generates pulse width modulated (PWM) signals based on the received RGB frame data intended for the driver and the GCLK signal and such generated PWM signals may then be used by the output module (610-3 or 620-3) to generate instructions to be sent to corresponding LED lights, which cause the timed excitation of the LED lights to produce light. It is noted that due to the new architecture according to the present invention, drivers now no longer need their own PLL, DVDD circuitry, and other circuits (to be discussed below). In addition, because of the integration with controllers within the same module on the same PCB, the data transmission between a controller and its drivers can now be conducted using LVDS at a higher speed and with an improved level of reliability. As such, drivers according to the present teaching are lighter weight, lower cost, and yet operate at a faster speed with enhanced quality.

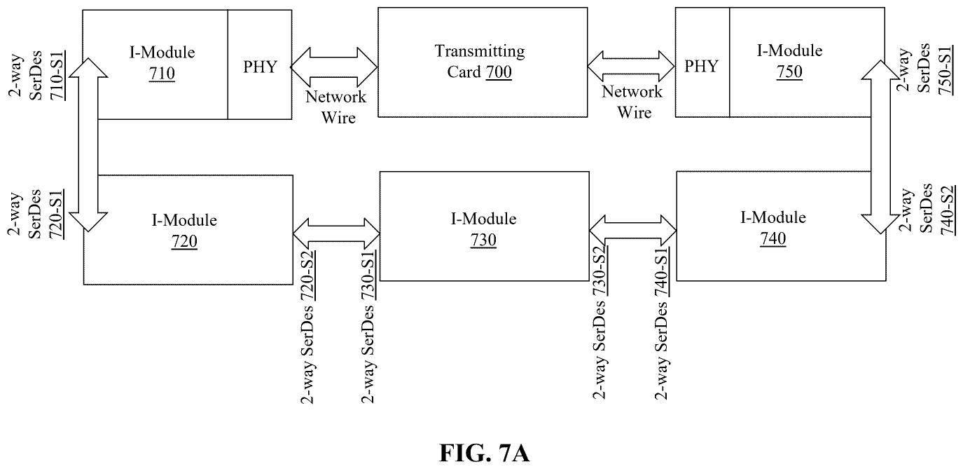

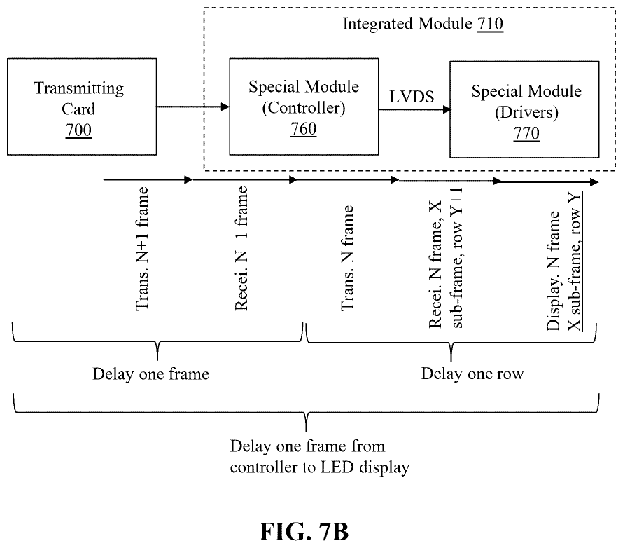

As discussed herein, the integration of controllers and its connected drivers in the same module and PCB makes it possible to use LVDS for data transmission between controllers and drivers in the same integrated module. The communication between different integrated modules according to the present teaching is based on 2-way SGMII SerDes. Compared with the use of network wire for communication between receivers, inter-controller communications via 2-way SGMII SerDes according to the present teaching provides improved performance and fault tolerance. FIG. 7A illustrates an example of integrated modules serially connected via 2-way SGMII with self-error detection and dynamic re-routing for fault tolerance, according to the present teaching. This illustration includes a transmission card 700 and a number (e.g., 5) of serially connected integrated modules, i.e., I-module 1 710, I-module 2 720, I-module 3 730, I-module 4 740, and I-module 5 750. The transmission card 700 may send frame data to either I-module 1 710 or I-module 5 750 in opposite directions via network wire such as an Ethernet connection. However, the serially connected I-modules transmit data to each other via 2-way SerDes, i.e., 710-S1, 720-S1, 730-S1, 730-S2, 740-S1, 740-S2, 750-S1. Each of adjacent I-modules, e.g., I-module 2 720 and I-module 3 730, uses a 2-way SerDes, i.e., 720-S2 and 730-S1 so that the number of configurable alternative transmission paths between 720 and 730 is 4, thus together forming a 4-way SerDes connection. As the transmission of information among serially connected controllers is no longer based on physical ports (PHY) is significantly reduced physical ports (only when connecting to the transmission card 700), the overall performance is improved with reduced costs and power consumption.

A SerDes may include any form of IC transceiver that can convert parallel data to serial data and vice versa. Serial-GMII (SGMII), Universal Serial Bus (USB), and Peripheral Component Interconnect Express (PCIE) are exemplary SerDes-based interfaces that may be used by the present teaching to implement the serial connections between any two integrated modules. As described herein, SerDes can encompass any known type of serializer/deserializer interface known to those of skill in the art.

The LED architecture based on integrated modules architecture according to the present teaching yields enhanced performance in different aspects and with a reduced overall cost. In one aspect, the latency occurring from the time to transmitting a video frame to a controller to the display of the frame data on the LED display screen is reduced. This is because both RGB and GCLK are now transmitted from controllers to drivers within the same integrated module via LVDS, eliminating a one-frame delay occurring in a traditional LED system when a receiving card sends RGB information to drivers. Thus, compared with the two-frame delay in a traditional LED system as shown in FIG. 3E, the improved LED system according to the present teaching has now approximately one-frame delay (plus one row). This is illustrated in FIG. 7B, where it is shown that the delay includes (1) one frame when the transmitting card 700 sends frame data to a special module (controller) 760 in the I-module 710 that connects with the transmitting card 700 via a network wire and (2) one-row delay when the special module (controller) 760 distributes the received frame data to the special module (drivers) 770 in the I-module 710. Specifically, for example, when the transmitting card 700 sends the N+1th frame to controller 760 in I-module 710, the controller 760 is sending content in the Nth frame to drivers 770, e.g., sending content in row Y+1 of X subframe of the frame. At that point, drivers 770 are displaying content in row Y of X subframe on the LED display screen. As each frame has many rows, the delay using I-module architecture according to the present teaching is substantially a single-frame delay. This is a significant reduction from the traditional two-frame delay as shown in FIG. 3G.

Due to the improved integrated module construct, a driver according to the present teaching handles screen refresh in a different manner as compared with a driver in a traditional LED system. In a traditional LED system, a video frame needs to be completely received (buffered) before the frame can be displayed. With the improved LED architecture with integrated modules, as soon as one row of frame data is received, a driver can start to display the data in that row on the LED display screen.

The amount of data that is transmitted/communicated by the improved LED system according to the present teaching differs from that of a traditional LED system. For instance, a traditional LED system sends 1 frame of data, e.g., 16bit*RGB*number of pixels, whereas the improved LED system as discussed herein downloads 1 row of scan data, e.g., 10 bit*RGB*number of pixels/ 64 rows of scan, which is less than 1 frame of data and then sends 1 frame of data, e.g., 1 row scan data*64 line scans*64 subframes, which is more than 1 frame of data.

The fundamental reason is that an integrated modules according to the present teaching needs to send only very little data (one row) to start displaying. However, the total amount of data sent under the present teaching in 1 frame time is, in some embodiments, more than that of a traditional LED system. For example, in some embodiments, each 16-bit gray value is split into 64 10-bit gray values and then transmitted as such, which increases the amount of data communicated. The difference in the amount of data transmitted in a traditional LED system and the improved LED system according to the present teaching is because that the communication between a receiver and drivers in the traditional LED system is via a single-ended signal, while the communication between a controller and drivers in integrated modules of the improved LED system is via LVDS (possible because of the integration), which enables a faster transmission speed and, hence, a higher bandwidth. Because of the faster speed and higher bandwidth, the performance of the LED system based on the present teaching is accordingly enhanced.

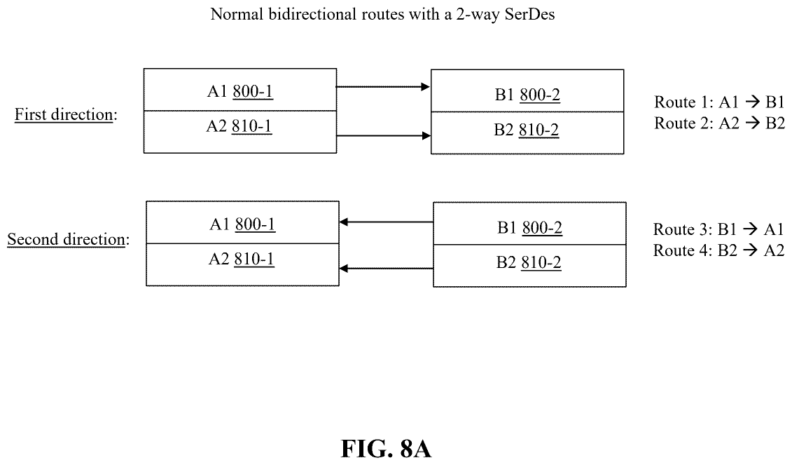

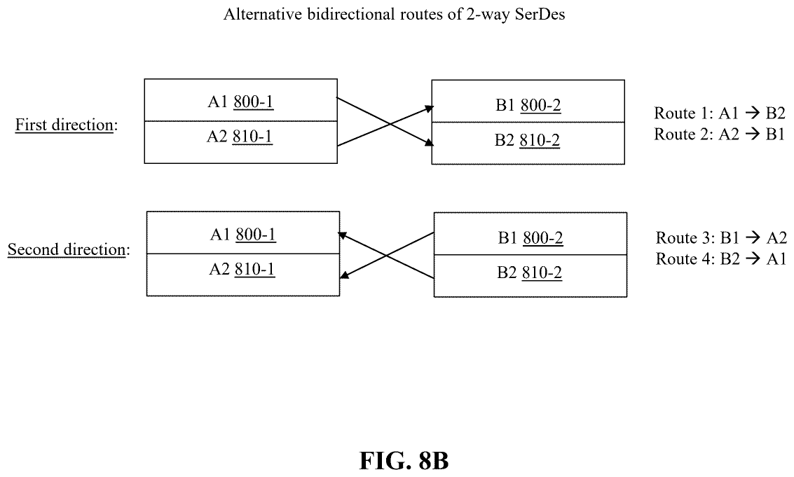

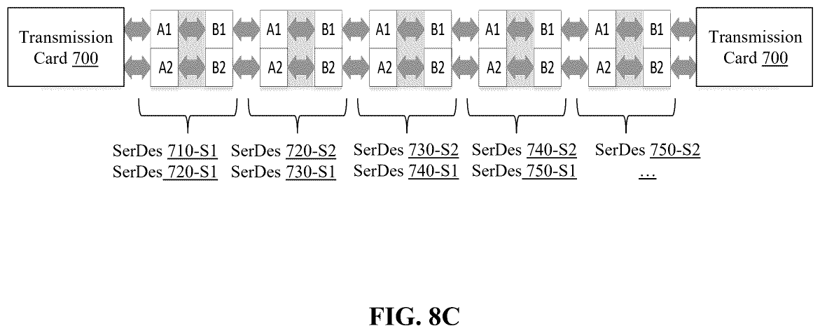

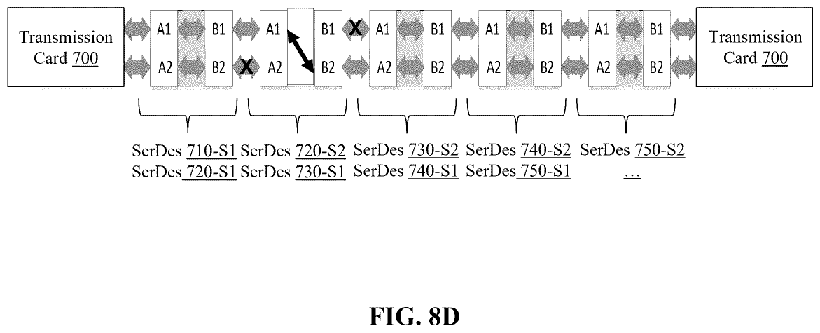

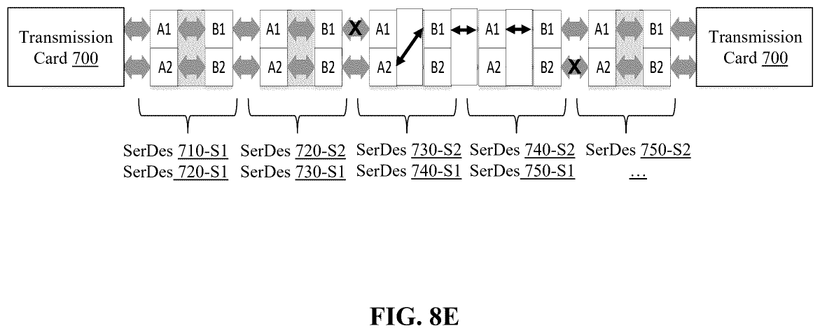

As discussed herein, because of the integrated modules, RGB and GCLK may both be transmitted via LVDS and that enhanced both the speed and bandwidth of data transmission between controllers and drivers. In another aspect of the improved performance, the use of SerDes for communications between controllers further enhance the performance of the LED system according to the present teaching. FIG. 8A illustrates how 2-way SerDes devices may be used to achieve SerDes enabled communication with 4 communication routes (two in one direction and two in the opposite direction), according to the present teaching. In FIG. 8A, A1 800-1 and A2 810-1 represent the two terminals of a 2-way SerDes associated with a first controller, e.g., 720, while B1 800-2 and B2 810-2 represent the terminals of another 2-way SerDes associated with a second controller, e.g., 730, serially connected to the first controller. When A1 connects to B1 and A2 connects to B2, there are two bi-directional communication routes, corresponding to A1-->B1 (route 1) and A2-->B2 (route 2) in the first direction and B1-->A1 (route 3) and B2-->A2 (route 4) in an opposite direction. This forms a 4-way SerDes with four normal routes (two in one direction and two in the opposite direction).

FIG. 8B illustrates additional 4 alternative routes of the 4-way SerDes illustrated in FIG. 8A, where the 4 alternative routes that may be configured as shown, according to the present teaching. These alternative routes may be dynamically configured as needed in the event that any of the normal routes is detected as not functioning. As illustrated in FIG. 8B, rather than going straight across to form normal routes (e.g., A1 800-1 to B1 800-2 and A2 810-1 to B2 810-2), an alternative route instead goes cross, e.g., A1 800-1 to B2 810-2 and A2 810-1 to B1 800-2, etc. This forms 4 alternative routes, corresponding to alternative route 1 A1-->B2, alternative route 2 A2-->B1, alternative route 3 B1-->A2, and alternative route 4 B2-->A1.

FIG. 8C illustrates an example transmission path across different controllers via the 4-way SerDes connecting adjacent controllers in a normal operation. In this example, the controllers each have two avenues for receiving/transmitting data from to/from the transmission card 700 and/or other receiving cards. As illustrated, each pair of adjacent controllers have respective two 2-way SerDes devices with terminals A1/A2 from one and B1/B2 from the other SerDes device to form the connection therebetween. Different SerDes devices are accordingly provided for connecting exemplary controllers 710, 720, 730, 740, and 750 to form serial communication routes. For instance, the connections (based on A1/A2 and B1/B2) between controllers 720 and 730 are established based on SerDes 720-S2 and SerDes 730-S1. Similarly, the connections between controllers 730 and 740 are established by SerDes 730-S1 and 740-S1, etc.

FIG. 8D illustrates an example of dynamically reconfiguring a transmission path across different controllers via the 4-way SerDes to avoid some point of failure detected along the transmission path, according to the present teaching. As shown in this example, during the operation, when some SerDes devices detect certain points of failure, e.g., around controller 720 at two locations (e.g., marked by X in FIG. 8D), SerDes devices that detect the failures (e.g., the devices connected to controller 720) reconfigure the device(s) to use alternative route(s) in order to avoid the failed connections at these locations, such that the traffic across controller 720 is automatically rerouted through the reconfigured transmission path. In this example, the SerDes connection (between 720-S2 and 730-S1) between controller 720 and controller 730 is now reconfigured to be A1-->B2 (rather than the normal paths A1-B1 or A2-B2) as A2 in SerDes 720-S2 is no longer functioning properly.

FIG. 8E illustrates another exemplary fault tolerance situation that the improved LED system is able to achieve, according to the present teaching. In this example, failures are detected in SerDes devices between controllers 720 and 730 as well as between controllers 740 and 750. As illustrated, the initial normal route B1-A1 between SerDes 720-S2 and 730-S1 is not working. In addition, normal route B2-A2 between SerDes 740-S2 and 750-S1 is also not working. To remedy this situation, there may be different possibilities to reconfigure an alternative transmission path to ensure that the LED system remains smooth operation. In the illustrated example as shown in FIG. 8E, an alternative route is now B2-A2 at 720, A2-B1 at 730, B1-A1 and A1-B1 across 730 and 740, and B1-A1 across controllers 740 and 750.

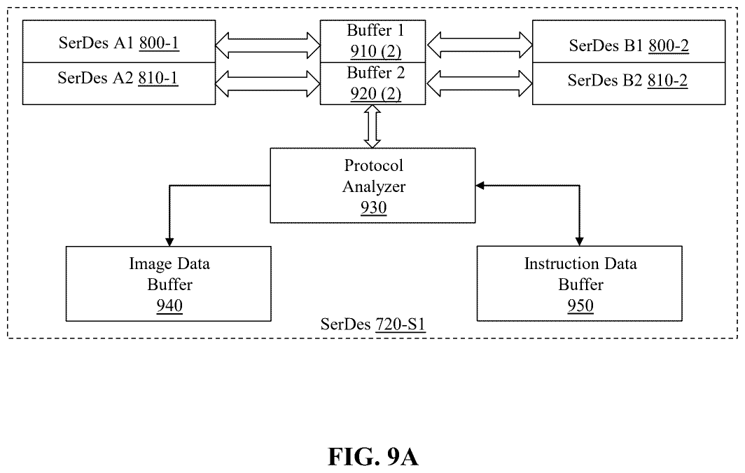

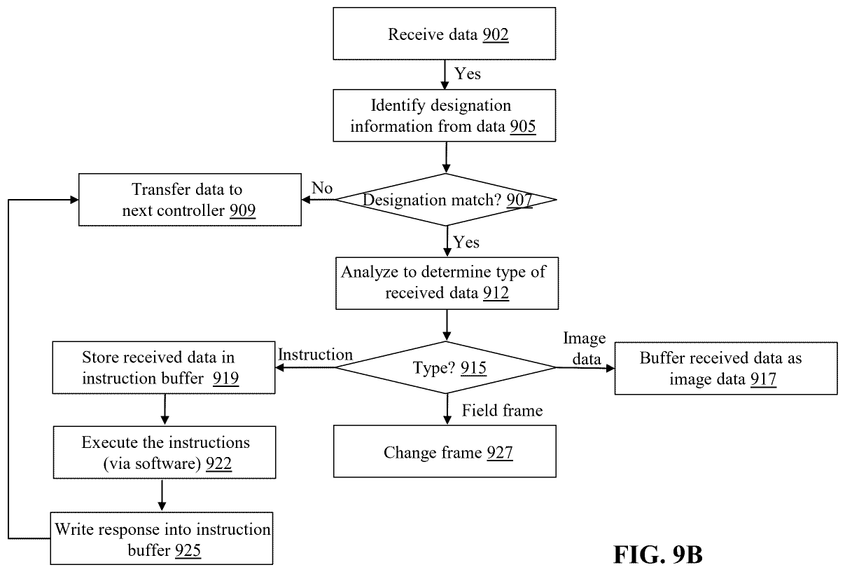

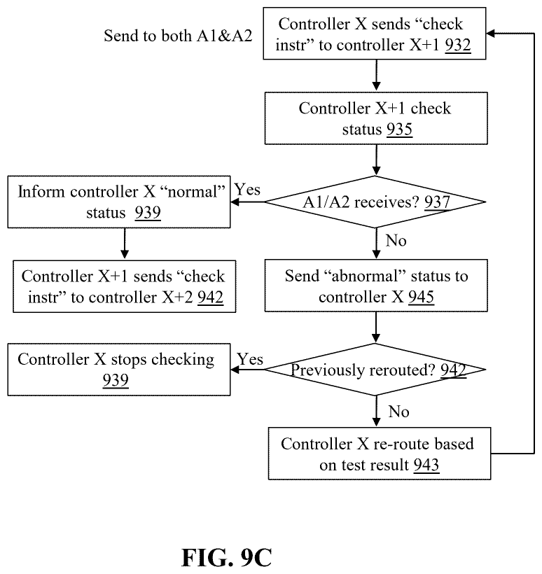

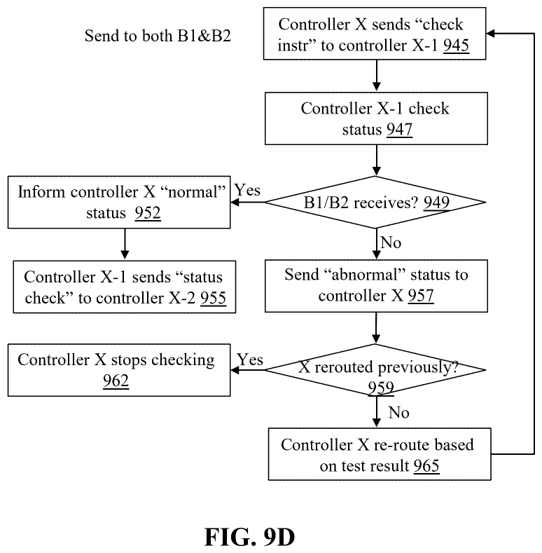

FIG. 9A depicts an example internal construct of a SerDes associated with, e.g., 720-S1, according to an embodiment of the present teaching. As discussed herein, each SerDes device has corresponding two sets of terminals corresponding to A1 (800-1)/A2 (810-1) and B1 (800-2)/B2 (810-2). Between each connection along a normal path, i.e., either A1-B1 path or A2-B2 path, the SerDes device 720-S1 includes a different buffer, i.e., budder 910(1) and 901(2) for each route. The SerDes device 720-S1 also includes a protocol analyzer 930 to perform different tasks. For example, it may be configured to determine if the data received is intended or designated for this controller and then handle accordingly. If the received data is intended for this controller 720, then the received is analyzed further in terms of whether the received data is image data or instructions. If the received data is not intended for this controller 720, then the received data is simply passing through so that it is forwarded to the next controller via SerDes terminal B1 or B2, according to the configuration.

When the received data is designated to this controller, then the protocol analyzer 930 further analyzes the received data to determine whether the received data corresponds to image data or instructions. If the received data corresponds to image data, the protocol analyzer 930 controls to buffer the received data in an image data buffer 940. Otherwise, the received data is buffered in an instruction data buffer 950. The respective buffered data will be further used to perform other operations.

FIG. 9B illustrates an exemplary flowchart of normal operation of a SerDes device, according to the present teaching. As illustrated, upon receiving data at 902, the designation information is identified from the data at 905. The system determines if there is match in the designation information at 907. If the answer is yes, it means that the received data is designated to this controller. In this case, the protocol analyzer 930 analyzes the received data to determine, at 915, the type of received data, i.e., whether it corresponds to image data or instructions. Based on the data type, protocol analyzer 930 may perform alternative actions. That is, if the received data is image data, the received image data is buffered in the image buffer 940 at 917. If the received data corresponds to instructions, the received data is stored, at 919, in the instruction buffer 950. The buffered instructions may then be executed at 922, e.g., via software, and the responses produced by the execution may then be written back to the instruction buffer at 925. The SerDes device then transfers data to the next controller at 909. There is another type of data corresponding to a field frame, which is a special instruction that is used to, e.g., signaling to change frame. If that is the case, the operation is carried out to change frame at 927. In the event that the received data is not designated to this controller 720, i.e., there is no match detected at 907, the received data is forwarded or transferred to the next controller at 909.

FIG. 9C illustrates an exemplary flowchart of a SerDes device performing a test on whether normal routes along a first direction function properly. In some embodiments, the first test may be carried out to test the normal route starting from A-terminals (e.g., left to right when looking at FIG. 8C or other similar figures) to see whether the normal routes in that direction (from A to B) are functioning properly, according to the present teaching. In some embodiments, such a test may involve other connected SerDes devices by sending/receiving signals via both A terminals of the device. As illustrated, a SerDes device X associated with a first controller sends, via A-terminals (both A1 and A2) a “check instructions” to a serially connected SerDes device X+1 associated with a serially connected controller at 932, causing device X+1 to check its status at 935. Then device X+1 checks, at 937, whether it receives, at its A1 and A2 terminals, the instructions transmitted from device X. If device X+1 did receive the instructions, then device X+1 informs device X at 939 that the normal route associated with terminal A is functioning properly. In this situation, SerDes device X+1 sends, at 942, a “check instructions” further to SerDes device X+2 to propagate the testing. If device X+1 does not receive the instructions at A1 and/or A2, determined at 937, then device X+1 sends a signal back to device X, indicating the abnormal status, and determines if the data has previously been rerouted at 942. If yes, device X stops the testing operation at 939 as it indicates that the SerDes device can no longer be reconfigured. If reconfiguration of routes has not been performed previously, then device X may then proceed to reconfigure by changing to an alternative route at 943 (re-route) based on the test result.

FIG. 9D illustrates an exemplary flowchart of a SerDes device performing a test on whether normal routes along a second direction function properly. In some embodiments, this test may be carried out to test the normal route starting from B-terminals (e.g., from right to left when looking at FIG. 8C or other similar figures) to see whether normal routes in this B-A direction are functioning properly, according to the present teaching. As illustrated, a SerDes device X associated with a first controller may send, at 949, a “check instructions” to a coupled SerDes device X-1 associated with a second controller, causing device X-1 to check its status at 947. If device X-1 receives the check instructions at B1 and/or B2 terminals associated therewith, determined at 949, device X-1 informs device X of a normal status at 952. In this case, the SerDes device X-1 propagates the testing by sending, at 955, a “check instructions” command to a SerDes device X-2 associated with a third controller serially connected to the second controller. However, if device X-1 does not receive the instructions from device X at the B1 and/or B2 terminal, determined at 949, device X-1 sends a response to device X, at 957, reporting an abnormal status to device X. In this situation, device X may attempt to reconfigure the SerDes device(s) to set up alternative route(s). To do so, device X first determines, at 959, whether the device(s) have previously been reconfigured or what is operating is already alternative route. If yes, device X terminates the testing at 962. Otherwise, device X may then proceed to carry out the rerouting, at 965, by reconfiguring the connections among terminals.

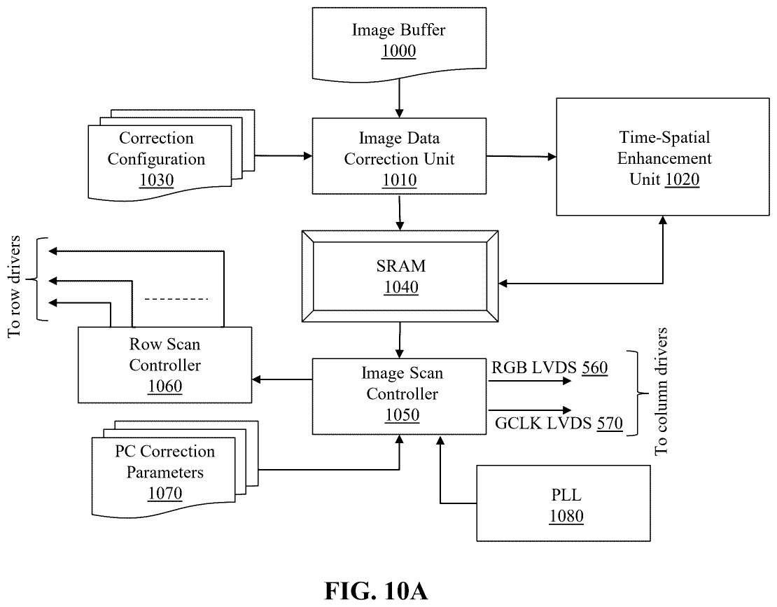

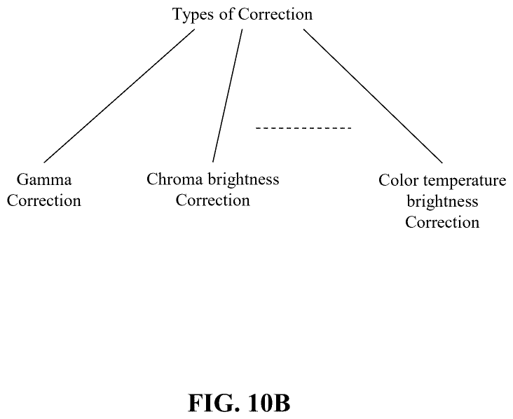

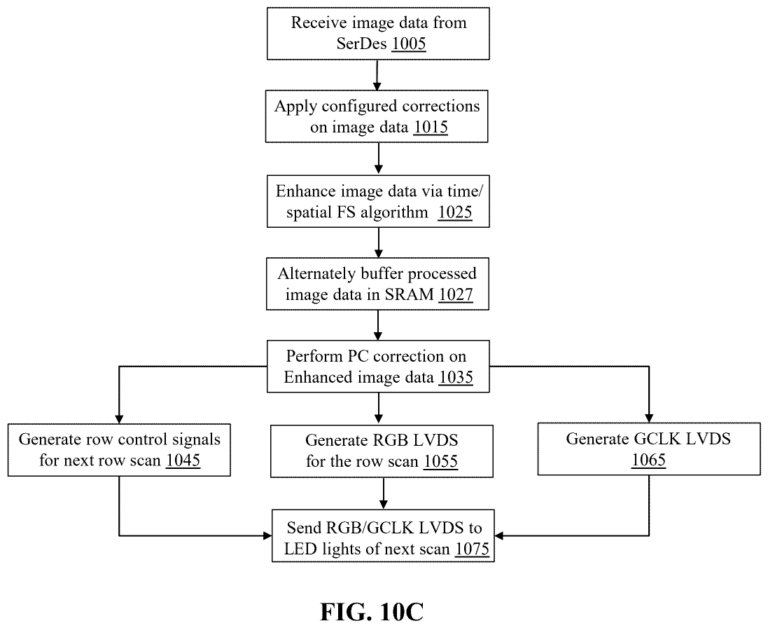

FIG. 10A illustrates an exemplary (partial) construct of a controller, according to an embodiment of the present teaching. In this exemplary embodiment, the controller is provided to generate RGB and GCLK LVDS signals, perform image data corrections, carry out image enhancement on the received image data, and compensate the impact of parasitic capacitance associated with each and every LED light in a corresponding region of the LED display screen. To achieve these functions, the controller comprises an image data correction unit 1010, a time-spatial enhancement unit 1020, an image scan controller 1050 and a PLL circuit 1080. To facilitate the processing, the controller also includes an image buffer 1000 for storing the image data designated to the controller, a SRAM 1040 to provide working memory during the needed processing, a correction configuration 1030 to store, e.g., instructions/parameters used for image correction, as well as PC correction parameters 1070 that stores parasitic capacitance parameters tested with respect to each and every LED lights in the region handled by the controller.

As discussed herein, because of the integrated nature of modules according to the present teaching, some important processing to be applied to image data is consolidated in a controller to make the drivers light weight, efficient, and cost effective. For example, image correction operation, image enhancement (including either or both time and spatial domain enhancement), and PC corrections are now centrally performed by controllers. FIG. 10B illustrates exemplary types of image correction that may be centrally performed by a controller. As shown, image correction may include Gamma correction, Chroma brightness correction, . . . , color temperature brightness correction. Other types of correction may also be possible and can also be centrally performed by a controller before the processed data is transmitted to drivers for lighting the LED lights.

With the needed processing on image data centrally performed by controller, such processed image data may then be transmitted to drivers via LVDS so that drivers no longer need to perform these functions therein. This makes drivers more efficient, less burden, and with reduced costs. The SRAM 1040 as depicted herein is provided centrally in the controller to support such consolidated and centrally performed image data processing. As such, the capacity of SRAM 1040 may be increased compared to the configuration in a traditional LED system. However, as the costs associated with drivers (many of them) are significantly reduced, the overall cost to the entire LED system is still reduced.

In operation, Because of the additional SRAM 1040 available, the amount of computational power available by the time-spatial enhancement unit 1020 is higher than previous configurations. Once the images are enhanced 1020, they are again saved in the SRAM 1040 and forwarded to an image scan controller 1050. Because each LED has a certain level of Parasitic Capacitance (PC), PC correction parameters 1070 can be provided to the image scan controller 1050, along with PLL (Phase-Locked Loop) 1080 data, prior to the image scan controller generating outputs. The image scan controller 1050 can then generate RGB LVDS 560 and GCLK LVDS 570 signals, and forward those LVDS signals 560, 570 to column drivers. The image scan controller 105 can also provide image data to a row scan controller 1060 which communicates with row drivers.

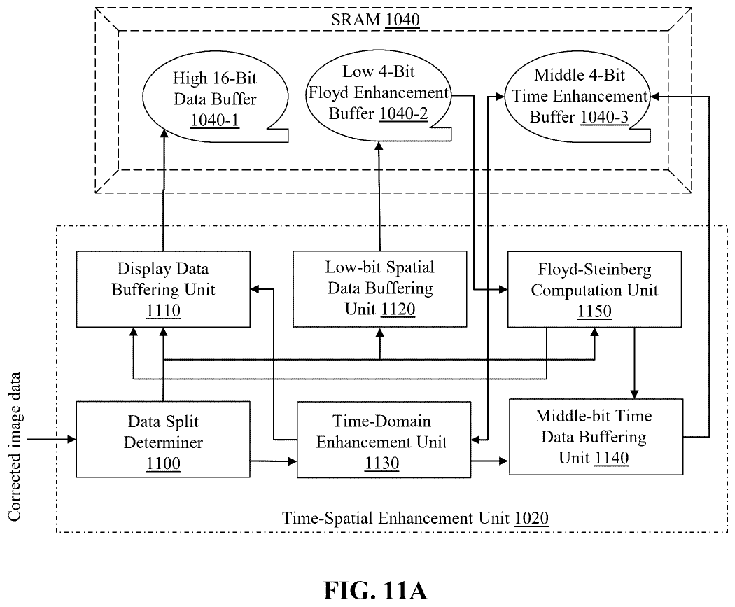

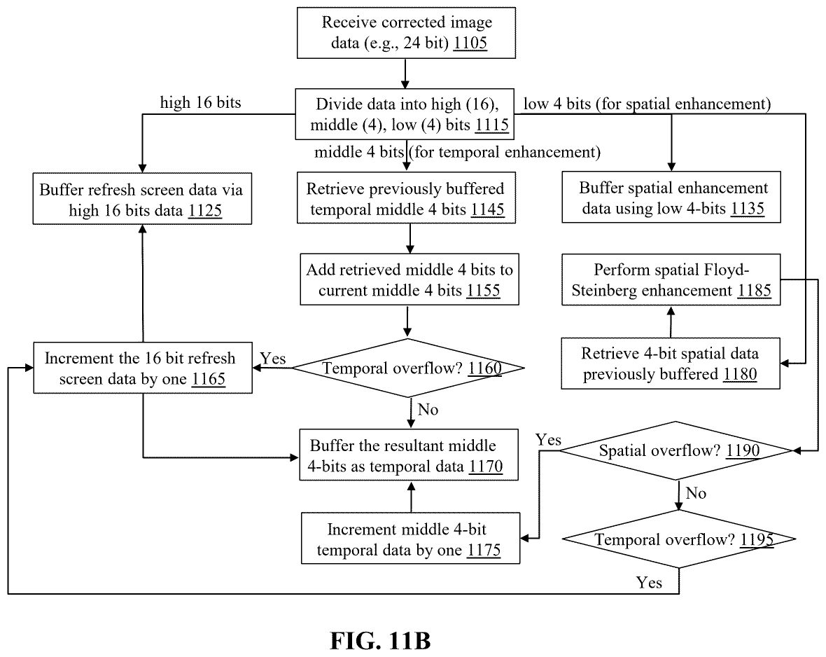

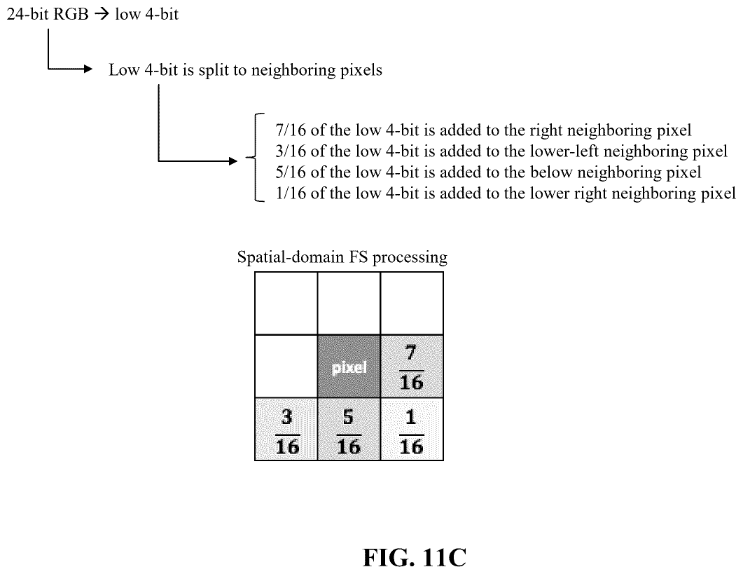

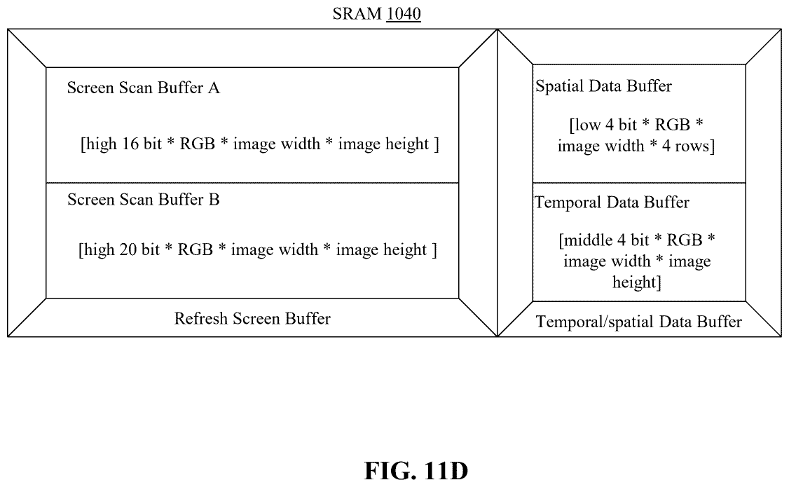

FIG. 10C illustrates an exemplary flowchart of an LED controller as depicted in FIG. 10A, according to the present teaching. In operation, a SerDes device s coupled to the controller receives image data from either the transmitting card 700 or a serially connected controller as shown in FIG. 7A. As discussed herein, the SerDes device recognizes the image data designated to the controller and buffered such image data in the image buffer 1000. The image correction unit 1010 of the controller may then receive, at 1005, the image data from the SerDes device and proceed to process the image data, which includes applying, at 1015, image corrections as configured in 1030 and then stores the corrected image data in SRAM 1040. The stored corrected image data may then be further processed, at 1025, by the time-spatial enhancement unit 1020 to carry out enhancement on the corrected image data in both time and spatial domain. In some embodiments, the enhancement operation may be performed via special allocation of different regions in the memory space to facilitate effective operation. Details related to the time/spatial enhancement will be discuss with reference to FIG. 11A-11D.

The enhanced image data may be stored, at 1027, in the SRAM 1040 to enable further PC corrections. The image scan controller 1050 is provided to carry out multiple tasks, including PC correction on the enhanced image data, generating row control signals for controlling the row scans by row drivers, creating synchronized RGB LVDS signals based on the PC corrected image data and GCLK LVDS based on signals from the PLL circuit 1080. In operation, based on the enhanced image stored in the SRAM 1040, the image scan controller 1050 performs, at 1035, with respect to each RGB LED light at each pixel, PC corrections based on the previously tested individual PC correction parameters stored in 1070. At this point, the needed processing on image data may be completed and such processed data may be used to generate RGB LVDS signals at 1055. In addition, the image scan controller 1050 also generates, at 1045, the row control signals for the next row scan, which are sent to the row scan controller 1060. Furthermore, the image scan controller 1050 also receives the signals from the PLL circuit 1080 for generating, at 1065, the grayscale clock signal via LVDS or GCLK LVDS. Such generated RGB and control data may then be sent, at 1075, to different destinations in the LED system, i.e., RGB/GCLK LVDS to column drivers, and row scan control signals to row drivers, respectively, so that the row and column drivers may operate in a synchronous manner to control the timing of the LED lights in a way that delivers the content of the view frame data correctly.

FIGS. 11A-11D disclose different aspects of the present teaching related to the temporal and spatial image enhancements, according to the present teaching. FIG. 11A depicts an exemplary construct of the time-spatial enhancement unit 1020, and its interactions with the SRAM 1040. In some embodiments, the RGB image data for each pixel corresponds to 24 bits of data, with each color channel having 8 bits to represent the intensity in each channel. In this illustrated embodiment, the time-spatial enhancement unit 1020 comprises a data split determiner 1100, a time-domain enhancement unit 1130, a middle-bit time data buffering unit 1140, a Floyd-Steinberg computation unit 1150, a low-bit spatial data buffering unit 1120, and a display data buffering unit 1110. FIG. 11B illustrates an exemplary flowchart of the time-spatial enhancement unit 1020, according to the present teaching. In operation, when the data split determiner 1100 receives, at 1105, the corrected image data with 24 bits per pixel, it splits the 24-bit data into different portions, each of which may be served for different purposes and processed differently to achieve enhancement. For instance, the data split determiner 1100 may split the 24-bit data into high 16 bits, middle 4 bits, and low 4 bits. The high 16 bits may be sent to the display data buffering unit 1110 so that it can buffer, at 1125, the 16 high bits as refresh screen data in the high 16-bit data buffer 1040-1 in the SRAM 1040. The low 4 bits may be sent to the low-bit spatial data buffering unit 1120, which in turn buffers the low 4-bits in a low 4-bit Floyd Enhancement Buffer 1040-2 in the SRAM 1040. The data split determiner 1100 can also forward the middle 4 bits for temporal enhancement to a time-domain enhancement unit 1130, which forwards the middle 4-bits to the time data buffering unit 1140, which in turns buffers the middle 4-bits in a middle 4-bit time enhancement buffer 1040-3 in the SRAM 1040.

In performing enhancement of the 24 bits, the temporal enhancement is first carried out by retrieving, at 1145, the previously buffered middle 4 bits and then adding, at 1155, such retrieved previously buffered middle 4-bits to the current middle 4 bits. If the addition yields an overflow, determined at 1160, the current 16 bits data is incremented by one at 1165 and then buffers, at 1170, the resultant middle 4-bits as temporal data. If there is no temporal overflow 1160, the temporal enhancement unit 1130 buffers directly, at 1170, the resultant added middle 4-bits (without the overflow) the resultant middle 4-bits as temporal data. The spatial enhancement is initiated at 1180, where the Floyd Steinberg computation unit 1150 retrieves, at 1180, from the low 4-bit Floyd enhancement buffer 1040-2, the low 4-bit data previously buffered therein and then carries out, at 1185, the spatial Floyd-Steinberg enhancement based on the retrieved low 4-bit and the current low 4-bit. If the spatial enhancement results in an overflow, determined at 1190, the middle 4-bit temporal data is incremented by one at 1175 and the newly updated middle 4-bit temporal data is buffered at 1170. If the spatial enhancement performed does not yield a spatial overflow, determined at 1190, it is further determined, at 1195, whether there is a temporal overflow resulting from the spatial Floyd-Steinberg enhancement at 1185. If there is a temporal overflow from the spatial enhancement, the 16-bit refresh screen data is incremented at 1165 by one and the incremented 16-bit data is then buffered, at 1125, as the updated refresh screen data.

FIG. 11C illustrates the concept of Floyd-Stenberg's spatial enhancement scheme, which can give significant edge enhancements to portions of the LED display controlled by different blocks or modules. The Floyd-Stenberg's algorithm achieves dithering using error diffusion, meaning it pushes (adds) the residual quantization error of a pixel onto its neighboring pixels, to be dealt with later. It spreads the debt out according to the distribution (shown as a map of the neighboring pixels), resulting in reduced quantization error.

FIG. 11D illustrates an exemplary memory allocation scheme in the SRAM 1040 in an LED controller to facilitate temporal-spatial enhancement operation, according to an embodiment of the present teaching. As illustrated, the SRAM 1040 is divided into refresh screen buffer area (left in FIG. 11D) and temporal/spatial data buffer area (right in FIG. 11D). The refresh screen buffers include scan buffer A and scan buffer B, for high 16-bit and high 2-bit RGB data, respectively. The temporal/spatial data buffer area is divided into spatial data buffer and temporal data buffer for storing buffered low and middle 4-bits for spatial and temporal enhancement, respectively, as discussed herein. This memory allocation scheme is disclosed merely for the purpose of illustration rather than as a limitation. Other allocation schemes may also be used to facilitate the spatial-temporal image enhancement.

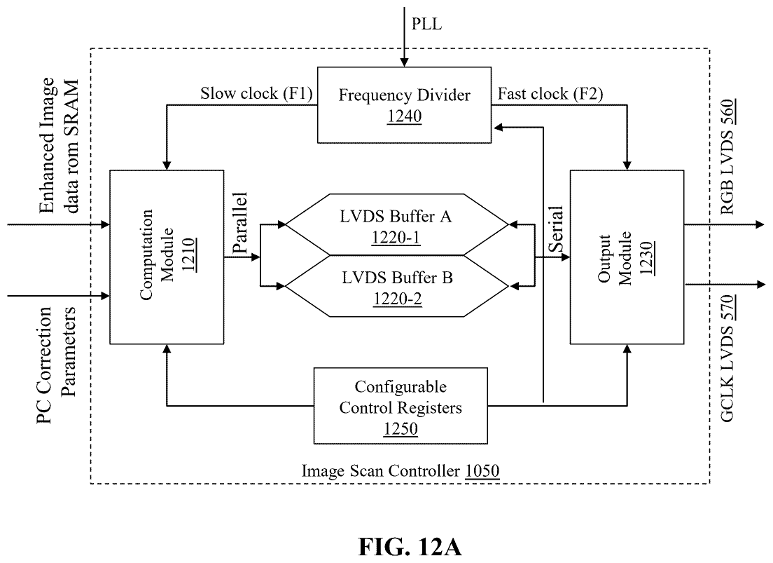

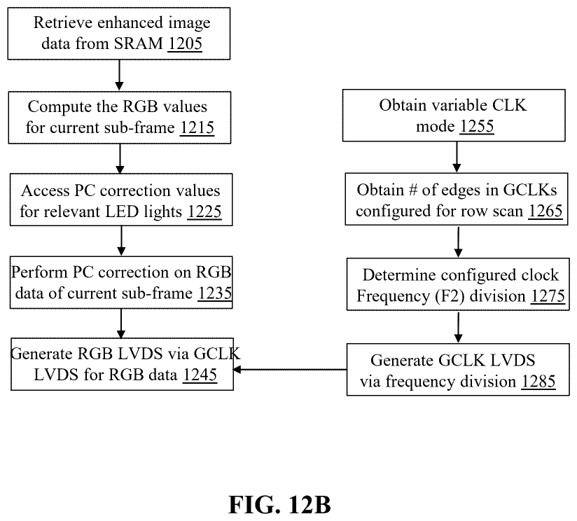

FIG. 12A depicts an exemplary construct of the image scan controller 1050, according to an embodiment of the present teaching. This illustrated construct is partial structure of the image scan controller for PC correction and for generating RGB/GCLK LVDS based on enhanced image data and PLL signals. The exemplary image scan controller 1050 includes a computation module 1210, a pair of LVDS buffers 1220 (buffer A 1220-1 and buffer B 1220-2), a frequency divider 1240, a configurable control registers 1250, and am output module 1230.

The frequency divider 1240 receives clocking signal from the PLL so that the frequency divider 1240 generates, respectively, a slow clock signal F1 and a fast clock signal F2, that operate on different frequencies. The slow clock F1 is used by the computation module for digital signal processing, where digital data is process and sent, in parallel, to the LVDS buffers (e.g., alternately). The input to the LVDS buffers is in parallel and content in the buffers is output serially based on the fast clock F2 to match with the parallel speed. Fast clock F2 is the working clock of the output module 1230, which takes buffered RGB data in 1220 serially and generates the serial RGB LVDS signal. A computation module 1210 corresponds to a digital processing module to perform, e.g., PC correction based on input PC correction parameters that characterize the parasitic capacitance associated with each individual LED light and are obtained via testing of such LED lights.

The output module 1230 generates the GCLK LVDS 570 based on the fast clock F2. As GCLK is a LVDS signal, it is a pair of differential signals going in opposite directions so that it serves as a clock with a timing determined based on zero-crossings of the differential signals. At each zero-crossing, of the GCLK LVDS 570, one bit of RGB data is generated as part of the RGB LVDS 560. Content stored configurable control registers 1250 correspond to different instructions and can be used to control the operations of the computation module 1210, the frequency divider 1240, as well as the output module 1230.

FIG. 12B illustrates an exemplary flowchart of the image scan controller 1050, according to an embodiment of the present teaching. As illustrated, the computation module 1210 retrieves, at 1205, enhanced image data from the SRAM 1040, and determines, at 1215, the values for a current sub-frame. This is for determining which PC parameters to be retrieved that correspond with the LED lights associated with the pixels in the sub-frame. This is because that each LED light has its own PC parameter and the negative effect on each LED light can be compensated only if the correction is performed based on the specific parasitic capacitance detected with respect to each LED light. With the determined sub-frame, the computation module 1210 accesses, at 1225, the PC parameters for the corresponding LED lights and then performs, at 1235, the PC compensation on RGB pixel values in the sub-frame corresponding to the LED lights in the sub-frame. The PC compensated RGB pixels values are then buffered in 1220. At the same time, the frequency divider 1240 may obtain, e.g., from the configurable control registers 1250, different information needed in order to determine how to generate low and fast clocks F1 and F2. For instance, the frequency divider 1240 may obtain, at 1255, variable clock mode data and determine, at 1265, the number of edges in a grayscale clock configured for row scan. Such information may then be used to determine, at 1275, the frequency F2 required so that to operate to carry out the frequency division to achieve that. Based on F2 clock signal, the output module 1230 may then generate, at 1285, the GCLK LVDS based on the clock F2 with divided frequency. Based on the GCLK LVDS so generated, the output module 1230 may then generates RGB LVDS based on the PC corrected RGB data buffered in the 1220. The generated RGB LVDS and GCLK LVDS may then be output, at 1245, to the drivers.

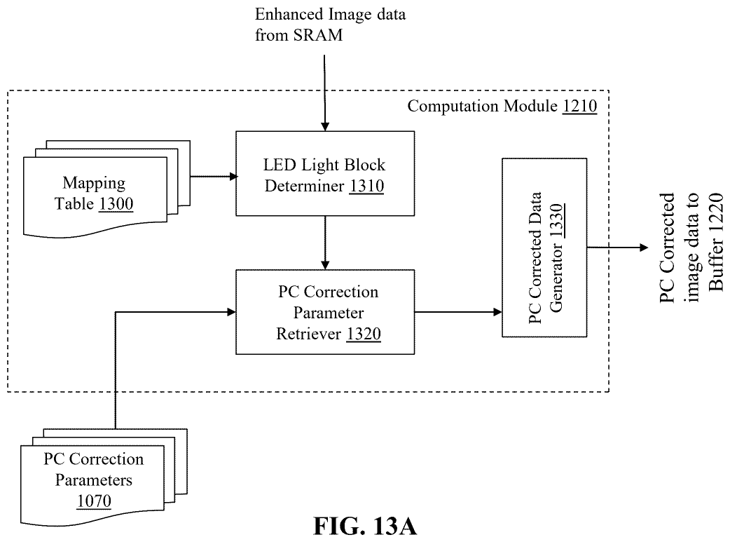

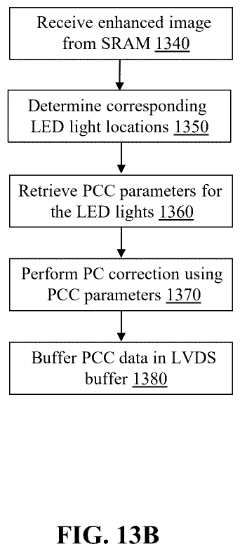

FIG. 13A illustrates an exemplary construct of the computation module 1210 in the image scan controller 1050, according to an embodiment of the present teaching. As discussed herein, the PC correction parameters 1070 can be obtained in a testing process performed on each LED light. In some embodiments, such a test can be performed on all LED lights simultaneously. To perform PC correction on enhanced RGB image data, the computation module 1210 retrieves the enhanced image data from the SRAM 1040. To determine which PC correction parameters are to be used to which pixel (or RGB LED lights), a mapping table 1300 is used that may correspond to a look-up table, where each pixel location in a frame or sub-frame is mapped to a certain location in the mapping table where the PC correction parameters for an LED RGB lights responsible for display the image data at that pixel location is stored. That is, the LED light block determiner 1310 is provided to identify an image block corresponding to the received RGB data which is used to determine the part of the mapping table 1300 for identifying a particular location of the LED display to particular modules/drivers within the system's LED blocks. The PC correction parameter retriever 1320 then retrieves the PC correction parameters for the block identified by the LED light block determiner 1310 and sends the retrieved PC correction parameters to a PC corrected data generator 1330, which in turn compensates the RGB data using the PC correction parameters to produce the PC corrected image data to a buffer in 1220.

FIG. 13B illustrates an exemplary flowchart of the computation module 1210, according to the present teaching. As illustrated, the computation module 1210 receives, at 1340, the enhanced image data from SRAM 1040, and determines, at 1350, the locations of the LED lights corresponding to the received RGB image data. The PC correction parameter retriever 1320 then retrieves, at 1360, the PCC parameters for the LED lights, and performs PC correction, at 1370, using the PCC parameters. The PC corrected RGB data may then be stored, at 1380, in the LVDS buffer 1220.

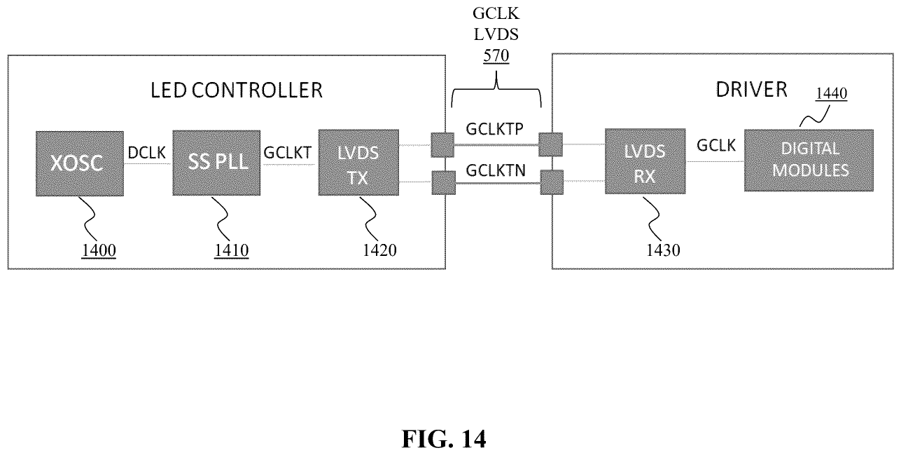

FIG. 14A illustrates an example of consolidating an SS PLL circuit in a controller according to the present teaching for centrally generating grayscale clock signals GCLK via LVDS. In this illustration, a crystal oscillator (XOSC) circuit 1400 produces a digital clock signal DCLK, which is provided to the SS PLL 1410 for generating a grayscale clock for a transmitter GCLKT signal, which is then used by a LVDS transmitter (TX) 1420 to transmit a grayscale clock in LVDS form (GCLK LVDS) 570. As known, LVDS corresponds to a pair of differential signals, one being positive called grayscale clock transmit positive or GCLKTP and the other being negative called grayscale clock transmit negative or GCLKTN. As discussed herein, the differential based signaling (or zero-crossing based signaling) based on LVDS is more reliable and can operate at a much higher frequencies than non-LVDS signaling. Differential signals (such as LVDS) are more stable than single-ended signals. For example, when there is noise interference from the outside world, differential signals will be coupled to the two signal lines almost at the same time. The receiving end identifies the difference between the two signals, so the external common mode noise can be completely offset. The GCLK signals are received in the driver by a LVDS receiver (RX) 1430, which then forwards the Grayscale clock to the digital modules 1440.

As discussed herein, receiving card (controller) in a traditional LED system sends a clock to drivers via single-ended signal. Because a single-ended signal CLK is very slow, each driver has to equipped with a PLL in order to generate a grayscale clock at a higher speed. This increases the cost of each driver.

In contrast, as discussed herein, the present teaching discloses a new LED architecture with controllers and drivers are integrated to form integrated modules, which not only enables the use of LVDS signaling scheme to transmit RGB at a fast and more reliable manner, but also allows centrally generating GCLK at each controller and send such grayscale clock signal directly to the drivers without needing each driver to generate its own GCLK. This also means that the circuits that are needed in each driver in a traditional LED system for generating GCLK in each driver can be eliminated from drivers. As discussed herein, furthermore, because of the use of LVDS scheme and the consequential enhanced speed, reliability, and high bandwidth in controller/driver communication, more processing (e.g., data correction, image enhancement, PC correction) can be consolidated into controllers, making it possible to perform such processing centrally in controllers so that more can be eliminated from drivers, including SRAM, circuits for correction, enhancement, and PC correction. As such, the drivers according to the present teaching are light weight, operating efficiently, and with much reduced costs.

Under the new LED architecture according to the present teaching using integrated modules and other corresponding configurations as illustrated, controllers send centrally generated clock signals CLK via LVDS scheme to drivers to achieve enhanced speed. The drivers in the new LED architecture can use the received CLK LVDS signals directly as grayscale CLK or GCLK. However, as each controller has its own independent clock, there may be some deviation between these clocks. The LED system according to the present teaching uses a “frame change command” to make sure that the frame change operations by different controllers as synchronous as possible. Although some traditional LED systems have applied the concept of a “frame change command” in receiving cards, the controllers according to the present teaching receiving commands through SerDes devices because a SerDes device may transmit both video frame data as well as instructions, where these instructions may be used to coordinate the operations across different controllers. For instance, instructions may be propagated to controllers via SerDes to instruct controllers to, e.g., configure the control registers in 1250 (see FIG. 12A), request frame change, adjust brightness, etc.

To synchronize the time to perform an action by different controllers, a delay may be included in an instruction (e.g., for frame change) so that different controllers may be instructed to wait for a time delay before carrying out the action so that all controllers will act at a synchronized time. Due to the fact that the instruction is propagated to each controller at a time, the time delay by different controllers may also differ in order to be synchronous. Using a “frame change command” as an example, assume the propagation delay to transmit a command from one to the other (e.g., from transmitting card to controller 1, or from controller i to controller i+1) is D. The “frame change command” sent to each controller may include a delay time, which may be adjusted for different controllers. Below includes exemplary few steps to illustrate the point:

The transmitting card sends a “frame change command” with a specified delay time (e.g., 10D) to controller 1;

Time T: controller 1 receives the command from the transmitting card, modifies the delay time from 10D to 9D, and forwards the “frame change command” with the modified delay time 9D to the next serially connected controller 2. Controller 1 waits until T+10D (as instructed by the transmitting card in the command) to carry out the command by changing the frame at T+10D;

Time T+D: controller 2 receives the command from controller 1, modifies the delay time from 9D to 8D, and forwards the “frame change command” with the modified delay time 8D to the next serially connected controller 3. Controller 2 waits until T+9D (as instructed by the received command) to carry out the command and changes frame at T+10D;

Time T+2D: controller 3 receives the command from controller 2, modifies the delay time from 8D to 7D, and forwards the “frame change command” with the modified delay time 7D to the next serially connected controller 4. Controller 3 waits until T+8D (as instructed by the received command) to carry out the command and changes frame at T+10D.

This continues until all controllers change the frame at the same time according to the delay times instructed via the commands propagated to them. If the frame rate is 60, the transmitting card will send a frame change command every 16.67 ms. For controller 1 connected to the transmitting card, after receiving the frame change command with an original delay time (10D), it forwards the frame change command with a modified delay time (9D) to controller 2. When controller 2 receives the command, it is already delayed D as compared with the time T controller 1 receives the command so that the delay time that needs to be observed by controller 2 is shorter (9D). To propagate the command to controller 3, controller 2 modifies the delay time further (to 8D) for controller 3 and propagates the command with the revised delay time to controller 3. Although controllers do not create a frame change command in this process, by modifying the delay time in each controller before the frame change command (with a modified delay time) is propagated to the next serially connected controller, this process ensures that content to be displayed on LED screen is carried out at the same time. Although there may still exist some asynchronous timing, as such deviation is such a short time as compared with one frame delay as in a traditional LED system, such deviation is essentially negligible.

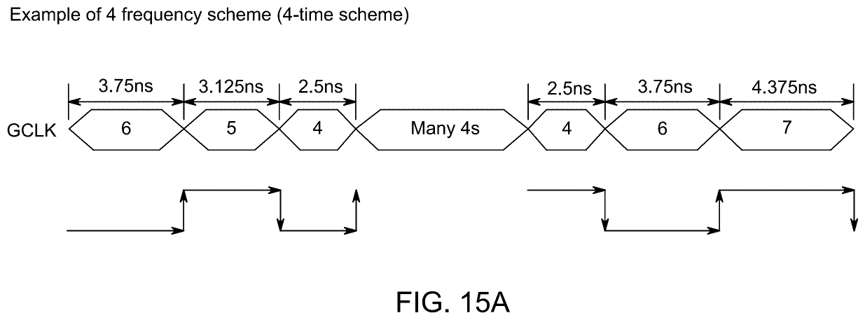

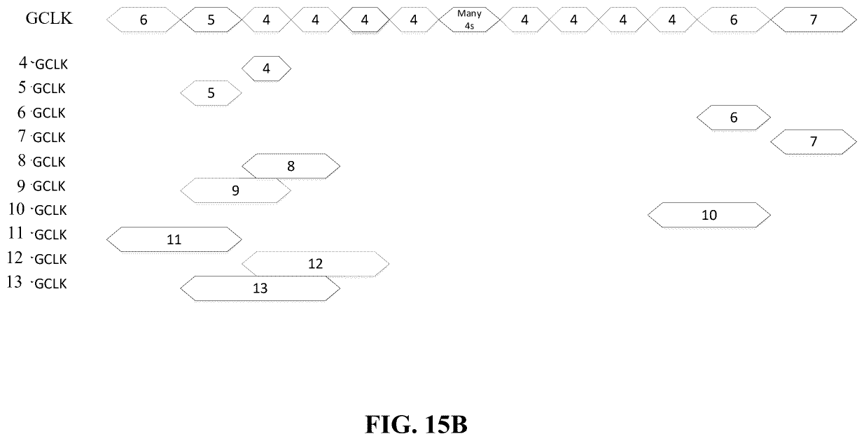

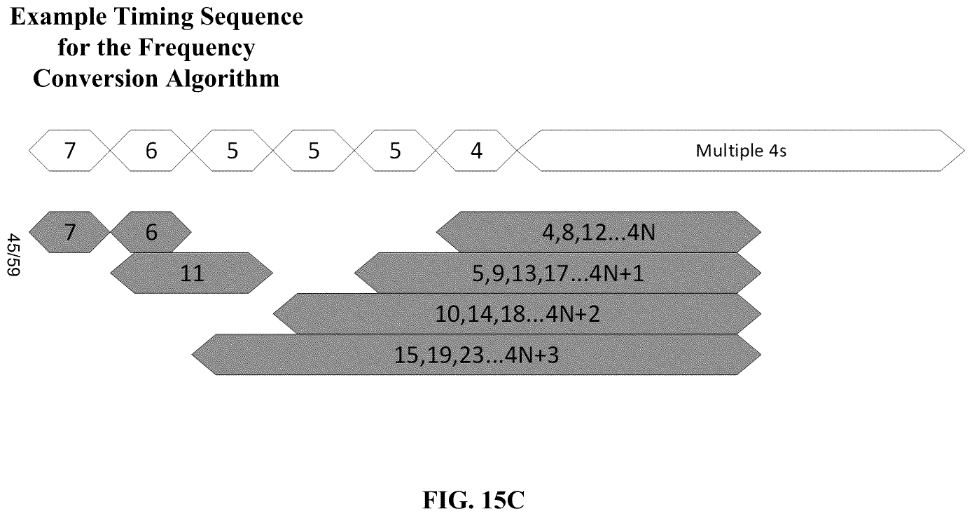

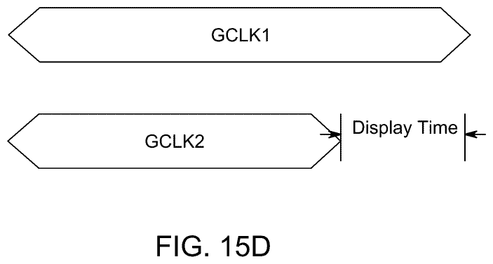

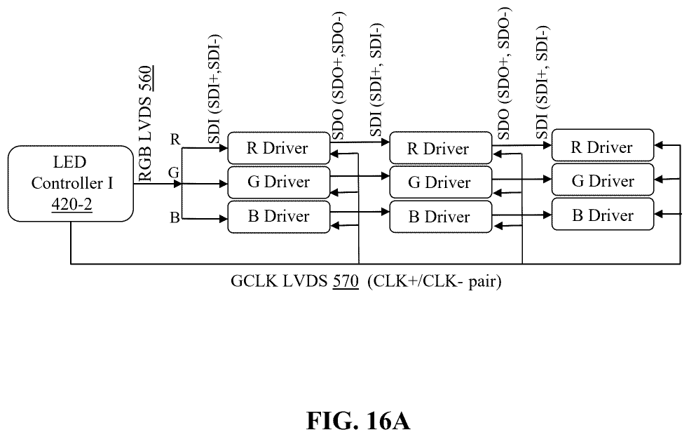

FIG. 15A depicts another important aspect of the present teaching. It is related to the concept of variable grayscale clock. It is to be presented that the variable grayscale clock that can be generated according to the present teaching may be used to improve grayscale resolution without incurring any additional cost to generate a much faster clock signal. The concept may be disclosed via a K-time scheme, where K represents a number of K levels of clock interval. The more levels there are, the higher level of grayscale resolution can be achieved. With this K-time scheme, resolution can be flexibly made higher at choice without requiring the circuit to generate much faster clock signals, which can be quite expensive. A 4-time scheme is used herein to disclose the concept and illustrate how to use it to significantly improve the resolution that an LED system can achieve. As illustrated, the present teaching may generate clock signals with, e.g., 4 frequencies and use such clock signals to form a sequence of clock signals in a certain order. For example, this exemplary 4-time scheme involves 4 levels of clock signals, e.g., 4, 5, 6, and 7, characterized by their respective pulse widths as 4=2.5 ns, 5=3.125 ns, 6=3.75 ns, and 7=4,375 ns, with increment of 0.625 ns. These 4 levels of clock signals can be used to form a clock sequence, such as 6, 5, 4, 4, 4, 4 . . . 4, 6, 7, which may be utilized to generate many different pulse widths beyond these 4 base pulse widths by combining pulse widths of adjacent clock signals in the sequence.

For example, based on this sequence, a clock signal with pulse width 8 may be generated by combining two adjacent 4s, width 9 may be generated using a combination of 5 and 4, 10 using a combination of 4 and 6, 11 using a combination of 6 and 5, 12 using a combination of 3 4s, 13 using a combination of 5+4+4, 14 using a combination of 4+4+6, 15 using a combination of 6+5+4, etc. This is illustrated in FIG. 15B. Given the flexibility of obtaining different pulse width beyond the base widths, the range of the grayscale intensity (i.e., the duration of keeping an LED light “ON”) is much larger.

In this example, 0.625 ns is half of the fast clock. GCLK is generated based on a configuration of how many times of 0.625 ns to turn. Four times means that the grayscale resolution is improved by four times due to the use of GCLK, such that 4 units is 2.5 ns, 5 units is 3.125 ns, 6 units is 3.75 ns, 7 unites is 4.375 ns, etc. The frequency change pattern illustrated is: 1st change=6 units; 2nd change=5 units; 3rd change=4 units; repeat a specified number of times . . . followed by six units; and finally, by 7 units. Leveraging a low-speed clock to achieve four times as high resolution and while also reducing the consumption on the driver side. So, the increments between different combined pulse width can be kept at minimum to achieve a higher resolution can be achieved based on the exemplary sequence.

FIG. 15B illustrates an example of how the exemplary 4-times scheme can provide an improved resolution that is four times higher. With this scheme, the increment of duration of an LED light (grayscale clock) is 1 (0.625 ns) by using the correct combination of the GCLK. As shown, if the grayscale level is (i.e., keep the LED light on for 9×0.625 ns), the duration can be determined by using 5 and 4 as shown. Similarly, for grayscale level 12, the one duration can be controlled by using three 4s periods. In this way, the duration may increment by 0.625 even though the GCLK frequency is much lower than that. So, this scheme enables a higher resolution control on LED lights via variable GCLK.

Similarly to the previous example, the GCLK above is the grayscale clock: 6 means 0.625 ns*6, that is, GCLK flips after 3.75 ns; 5 means 0.625 ns*5, that is, GCLK flips after 3.125 ns; 4 means 0.625 ns*4, that is, GCLK flips after 2.5 ns; and 7 means 0.625 ns*7, that is, GCLK flips after 4.375 ns. Therefore, the fastest GCLK can flip once every 2.5 ns, which is equivalent to a clock with a speed of no more than 200 M Hz.

Consider another example, where 4 GCLK indicates that when the grayscale is 4, the current turn-on time is 0.625 ns*4; 5GCLK indicates: when the grayscale is 5, the current turn-on time is 0.625 ns*5; 12GCLK indicates: when the gray scale is 12, the current opening time is 0.625 ns*12; 13GCLK means: when the gray scale is 13, the current opening time is 0.625 ns*13. In other words, the resolution of the current on time in this example is 0.625 ns. Under normal circumstances, to achieve time control with a precision of 0.625 ns, a clock of 800 M Hz is required. The present system can, for example provide a technology based on a 200 M Hz clock to achieve an accuracy of 0.625 ns (within a predetermined range of accuracy, such as +/−0.001 ns). Other clock frequencies are likewise valid, such that system configured as disclosed herein can operate using clocks of various speeds. When 1 GCLK=0.625 ns, a 200 M Hz clock (4 GCLK =2.5 ns) can be used to achieve 800 M Hz resolution. When 1 GCLK=1 ns, a 125 M Hz clock (4 GCLK=4 ns) can be used to achieve 500 M Hz resolution.

Consider the following example formulation of how to control the duration of LED lights'on/off states based on grayscale values via a 4-times scheme. The GCLK Pattern is: 6, 5, 100 4s, 6, and 7, where T equals “104”.
Gray level=[0, 3], no output
Gray level=7, skip T-1 CLKs, duration=next duration (CLK at 7)
Gray level=4N, N is an integer, skip 2 CLKs, duration=N CLKs
Gray level=4N+1, skip 1 CLK, duration=N CLKs
Gray level=4N+2, skip T-N-1 CLKs, duration=N CLKs
Gray level=4N+3, N>1, duration N CLKs

In this example, gray level 6 means six times 0.625 ns. The exemplary formulations determine, for each grayscale, a combination of GCLK to achieve the desired grayscale.

FIG. 15C illustrates an example timing which can also be used to achieve frequency conversion. The principle is the same as illustrated other timing examples, except that the frequency conversion is on the same side, so the control timing is relatively simple. In this example of a grayscale clock: 7 GCLKs flip once; 6 GCLKs flip once; 5 GCLKs flip once; 5 GCLKs flip once; 5 GCLKs flip once; Followed by 4 GCLK flips once. To display grayscale 9, the system: turns on the current on the 3rd rising edge of the grayscale clock and turns off the current on the 4th rising edge of the grayscale clock.

FIG. 15D illustrates another exemplary use of the 4-time scheme by leveraging subtraction using a variable grayscale clock. For example, a subtraction can be used to achieve a clock signal that has a pulse width smaller than any of the base pulse widths. In some situations, subtraction requires that two clock signals be provided at the same time (i.e., would require more pins). For this reason, while subtraction is feasible and can be useful to derive smaller pulse widths, addition using a single clock signal may be more operable. Overall, both addition and subtraction can enable substantial flexibility to obtain a wider range of pulse widths as needed, which significantly improve the performance of the LED system according to the present teaching.

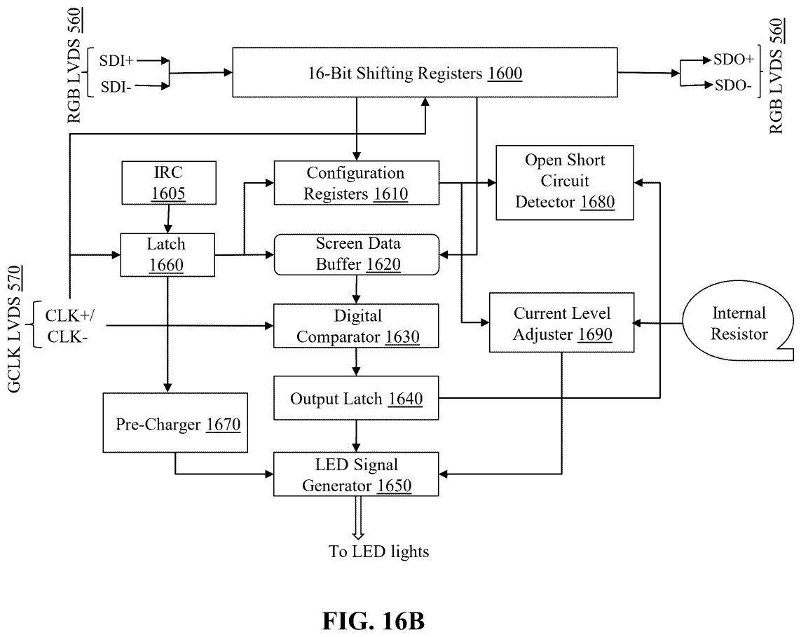

FIG. 16A illustrates LVDS Connection between controller and drivers, as shown and discussed herein. As illustrated, an LED controller 420-2 uses RGB LVDS 560 and GCLK LVDS 570 to distribute signals to the drivers. The discussion above focuses on different aspects of a controller, its internal construct, implementation, and functionalities under the present teaching. The discussion below is related to different aspects of a driver that is integrated in the same module with a controller that is to control its operations according to the present teaching.

FIG. 16B illustrates exemplary construct of a driver, according to an embodiment of the present teaching. As discussed herein, a driver in an integrated module constructed based on the present teaching no longer needs or includes different components that are traditionally included therein in a traditional LED system. This includes a PLL, the SRAM, and circuits required to generate DVDD, perform data correction/enhancement, and PC compensation. In addition, a driver according to the present teaching uses an internal resistor (rather than provided on a pin externally to the driver chip) to determine a reference current. In this way, a pin is saved for other In/Out without changing the number of pins on the chip packaging. In some embodiments, the internal resistor adopted herein may also simplify the PCB and reduce at least one otherwise fixed resistor. Each module may have the same internal resistor value or different internal resistor values, as required by a specific configuration.

As illustrated, the driver as illustrated in FIG. 16B comprises a shifting register 1600, configuration registers 1610 for storing information/instructions, an internal resistor circuit (IRC) 1605, a screen data buffer for storing data to be used for LED display, a latch 1660, a digital comparator 1630, a, open short circuit detector 1680, an output latch 1640, a pre-charger 1670, a current level adjuster 1690, and an LED signal generator 1650. As seen, the 16-bit shifting register 1600 is provided for receiving RGB LVDS signal 560 (SDI+, SDI−). A determination is made as to whether the received RGB LVDS is intended for this driver. If it is not, then the shifting register 1600 forward by shifting the received portion of the RGB LVDS signal that is not intended for the current driver to the next driver (SDO+, SDO−) based on the timing controlled by the received GCLK LVDS 570. The IRC 1605 establishes the internal resistor value. In some embodiments, the internal bandgap (a reference voltage generator) may be used to generate a zero-temperature current source, with a typical value being, e.g., 10 mA (or a range from that value, e.g., +/−0.1 mA). Other current values may also be selected (prior to the resistance determination) and used to determine the internal resistor value. Due to process and device variation, the output current may be trimmed (calibrated) during the CP (Circuit Probe) or wafer test. The result may be compared with the reference 10 mA and, if the value is smaller, then the trimming can increase the reference resistor. If the value is bigger, then the internal resistor can be trimmed to decrease reference resistor.

The latch 1660 may use the internal resistor value and provide outputs to the configuration registers 1610 (which receive the RGB data from the 16-bit shifting registers 1600), the screen data buffer 1620, and the pre-charger 1670. In this illustrated embodiment, the GLCK LVDS 570 is used by a digital comparator 1630, along with data from the screen data buffer 1620, to create output latch data 1640, which, when combined with data from the configuration registers 1610, can be used to perform an open short circuit detection 1680. The data from the configuration registers 1610 may also be used by one or more current level adjustor 1690, along with an internal resistor (which may or may not be the same resistance produced by the IRC 1605), to produce data for the LED signal generator 1650. Regarding the current level adjustor 1690, the brighter the environment, the harder it is to see the LED display clearly. In that situation, the brightness of the LED light may be increased. To do so, the controller may detect the ambient brightness based on an analog signal (e.g., a current) (using, e.g., an analog to digital converter or ADC) produced by an environmental brightness sensor which determines the current size based on the ambient brightness: the brighter the environment, the greater the current. In alternative configurations, a lower current can indicate a brighter environment. A controller may send instructions to the driver through LVDS to configure the current level adjuster 1690 therein. The greater the current, the brighter the LED light. The LED signal generator 1650 can also use the output latch data 1640 and pre-charger data 1670, produced by the latch 1660, to excite the LED lights.

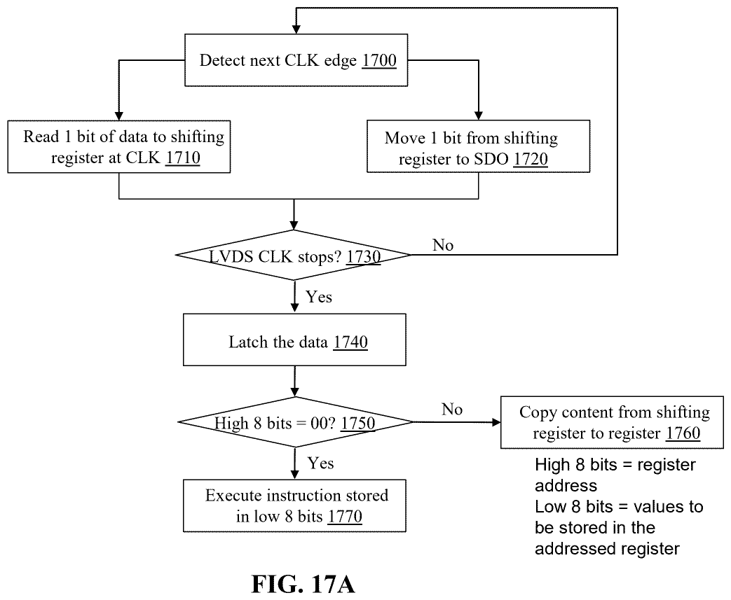

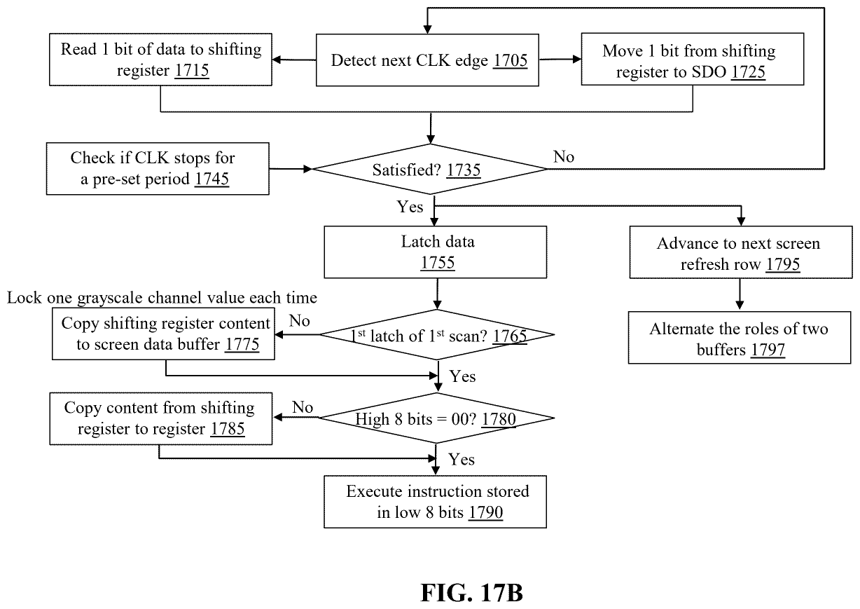

FIG. 17A illustrates an exemplary flowchart of a driver in a configuration mode, according to the present teaching. As illustrated, at each clock cycle regulated by the GCLK LVDS detected at 1700, the 16-bit shifting register 1600 reads in one bit of data from SDI at 1710 and moves out one bit at 1720 to SDO 1720 (a serial data out). Upon detecting, at 1730, that the LVDS CLK stops, the latch 1660 latches the data at 1740, and determines, at 1750, if the received data indicates that it corresponds to instructions. In some embodiments, when high 8 bits equal “00,” the received data corresponds to instructions instead of being image data. In this situation, the instructions are executed at 1770 and stored in the low 8 bits. If the received data is not instructions, it corresponds to image data so that it is moved, at 1760, from the shifting register to an addressed register.

FIG. 17B illustrates an exemplary flowchart of a driver in a screen refreshing mode, according to an embodiment of the present teaching. As illustrated, upon detecting a next zero cross of the LVDS at 1705, the shifting registers 1600 read in one bit of data at 1715 from SDI and shifts out one bit at 1725 to SDO. It is then checked, at 1735, whether the received CLK number is the same as a pre-set value. If it is, the system advances to a next screen refresh row at 1795, and alternates the roles of the two buffers at 1797 (that is, the system alternatively loads one buffer while retrieving information from a second buffer, then switches which buffer is used for a given operation for the subsequent clock cycle). At the same time, the system latches the data at 1755, and determines if this is the last latch of the last scan at 1765. If not, the system copies the content in the shifting register to the screen data buffer at 1775. The system may then determine if the high 8 bits equal “00” at 1780. If not, the system copies the content from the shifting register to the addressed register at 1785. The system then executes, at 1790, the instructions stored in the low 8 bits.

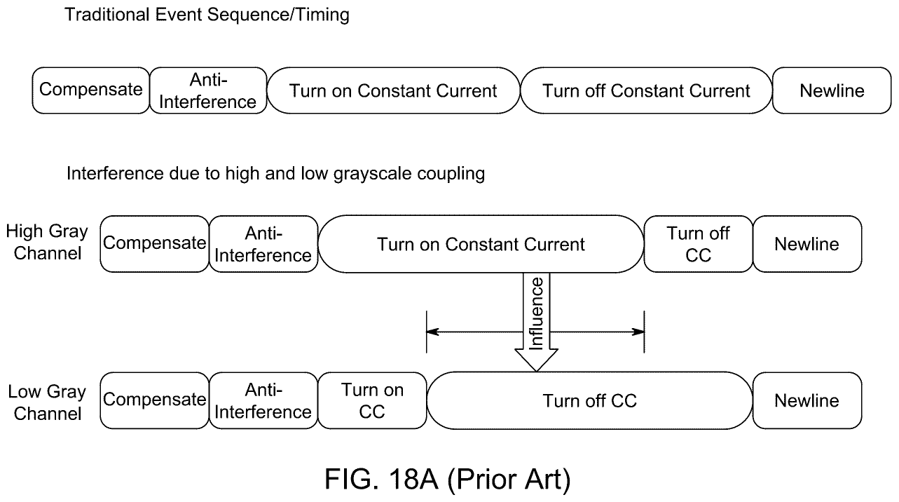

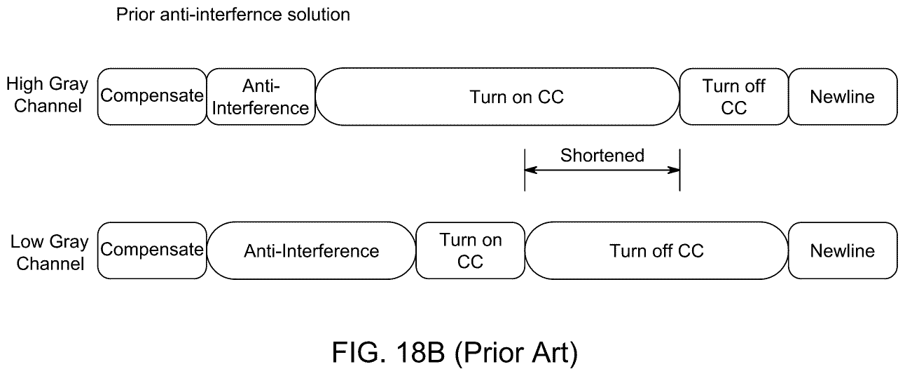

Another aspect of the present teaching is related to reducing interferences in LED display. There are some noted interference situations known to the LED industry. FIG. 18A illustrates some typical timing related schemes in a traditional LED system. First, a common basic timing scheme for controlling an LED light is shown, with the understanding that a constant current is used to light up an LED light and a constant current drive is used to provide, when it is on, a constant current to an LED light for a duration determined based on the grayscale value of an associated pixel. Typically, the timing scheme for each lighting cycle of an LED light is divided into five time periods, including a compensate period, an anti-interference period, a constant current turn on period, a constant current turn off period, and a line change (or new line) period. The operation associated with each period is defined below.

Compensate: all outputs are set to the same voltage. The purpose is to put the channel at a fixed voltage after line wrapping, thereby eliminating the differences between each line of scanning to ensure that the time to turn on the constant current driver at output terminal is the same.

Anti-Interference: all outputs are kept at a stable voltage (so as not to be disturbed).

Turn on constant current: constant current output is turned on to light up the LED light.

Turn off constant current: constant current output is turned off, which corresponds to a period that is in a floating state and therefore susceptible to interference.

Newline: the constant current output of all output channels (i.e., the RGB channels and, in some configurations, a grayscale channel) are turned off, i.e., no current representing a discharge state to release the parasitic capacitance on the channel to prevent ghosting.

In some periods, constant voltage is applied, such as during the compensation, anti-interference, and line change time periods. During these periods, the constant voltages applied thereto correspond to those that will not light up the LED light. When the constant current driver is turned on, its output is a constant current supplied to the LED light to light it up. When the constant current driver is turned off, there is no output constant current provided to the LED light so that it is in an uncontrolled state and is thus susceptible to interference. With respect to the anti-interference period (known as coupling optimization), the longer the anti-interference time, although it leads to less interferences received by the LED light, it also increases the power consumption. Given that, in determining the length of the anti-interference period, it is to balance the consideration between desiring a low power consumption and the quality of the LED display.

Another source of interference is due to the so called high and low gray coupling. It is noted that given the same refresh rate and the number associated with the line scans, the total time for a one-line scan is fixed. That is, the length of time for anti-interference period, constant current turn on period, and constant current turn off period is essentially also fixed. The length of time for the turn-on period depends on the gray value of the LED light. The greater the gray value, the brighter the LED light needs to be and, hence, the longer the turn-on period, which means a longer period that the associated driver needs to be on. Consequently, this also means that the turn-off period is shorter. That is, once the total time for a one-line scan is fixed, the amount of time that each period may be allocated may not be able to change that much.

The interference due to high and low gray coupling is illustrated in the lower portion of FIG. 18A. A high grayscale output channel is open at a constant current most of the time and supplies a constant current to an LED light in the turn on period. A low grayscale output channel is open closed at a constant current most of the time, corresponding to the constant current turn off period. The high grayscale output channel interferes with the voltage of the low grayscale output channel, causing the low grayscale LED light possibly to light up in a situation that the light should be in an off state. This is shown in FIG. 18A where when the high grayscale channel provides the constant current in a turn-on period for one LED light, it may change the voltage of the low grayscale output channel in a different (e.g., adjacent) LED light that should be in a turn-off state and the changed voltage may make the interfered LED light to erroneously light up. This high and low gray coupling phenomenon may degrade the display quality.

FIG. 18B illustrates an example of anti-interference timing that was used traditionally to address the interference due to high and low grayscale coupling. As seen, the anti-interference time associated with the low grayscales channel may be increased, thereby shortening the period with high and low grayscale coupling as much as possible. It is known that the performance of an LED driver chip depends on the grayscale clock frequency. The grayscale clock frequency is generally very high (e.g., between 160 M Hz and 200 M Hz, and is effective on both edges) and has reached the performance upper limit of 180 nm process (driver chips generally do not use very high process). The five-states timing sequence for a driver as shown in FIG. 18A (compensation, anti-interference, turn on the constant current, turn off the constant current, and newline) are controlled based on the grayscale clock. For example, grayscale 100 means turning on the constant current for 50 grayscale clocks (both edges are valid). Under the fastest possible grayscale clock, the time counting algorithm should be as simple as possible (avoid multiplication and division as much as possible); the simpler the algorithm, the higher the grayscale clock frequency that can be supported.

With this solution as shown in FIG. 18B, in the process of refreshing the screen, the total time for scanning a line, compensation time, and line feed time is fixed and the anti-interference time is configurable. The greater the anti-interference period, the smaller the coupling effect, yet the greater the power consumption. The anti-interference period is also affected by the gray value. The larger the gray value, the less time that can be allocated for the anti-interference period. The maximum anti-interference time may be configured. When the actual output timing is used, the anti-interference period may be reduced according to the gray value. The constant current turn on period is determined based on the gray value. For instance, if the gray value is N, then the turn-on period is measured by N/2 GCLK cycles. The constant current turn off period is determined based on the remaining time, i.e., total scanning time for one line-compensation time-line feed time-anti-interference time opening time. For example, if the total scanning time for one line=1000 ns, compensation time=100 ns, line feed time=200 ns, the maximum anti-interference time is configured as 300 ns, then when turn-on time=200 ns, closing time=200 ns. But when turn-on time=400 ns and anti-interference time is configured to be 200 ns, then turn off time=100 ns. If turn-on time=600 ns, anti-interference time=100 ns, then turn-off time=0 ns. As can be seen from these examples, the anti-interference time is impacted by the gray value via the turn-on time.

Different applications may adopt different approaches to determine how to maximally reduce high low grayscale coupling by adjusting the anti-interference time. For example, some may benchmark turn-on time with respect to a certain anti-interference time to obtain a reference value. When the turn-on time is less than the reference value, the anti-interference time may remain unchanged. When the turn-on time is greater than the reference value, the anti-interference time may be reduced by (e.g., turn-on time-reference value)/2. This base value+offset approach may be difficult to adapt to different total scanning times in one line (the scanning time of each line is different on different displays). For example, if the total scanning time in one line is extended to 1500 ns and the turn-on time=400 ns, if the anti-interference time is still 200 ns, there will be a 600 ns turn-off time. In this case, the resulting negative impact from high and low gray channel coupling will be more serious. Some traditional solutions may adapt better. For example, some applications adaptively determine the anti-interference time as anti-interference time=(total scanning time of one line−compensation time−line feed time−opening time)*a, where a is a configurable ratio. This scheme may allow adaptation to various total scanning times of each line. But this still requires multiplication and division in its computation, requiring more complex circuit to do the job, ultimately negatively affecting the grayscale clock frequency.

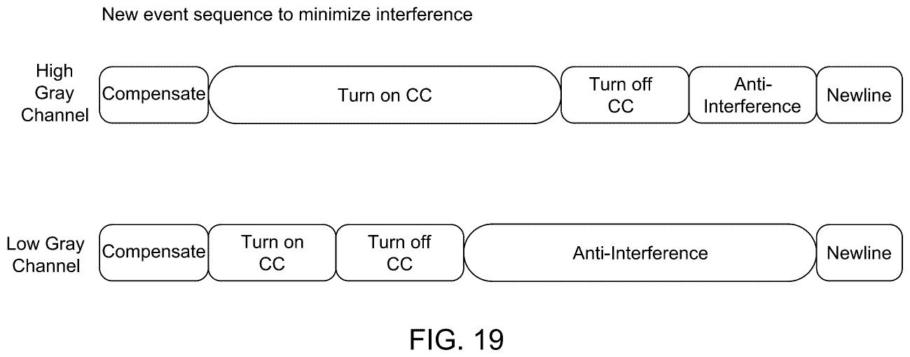

To overcome those shortcomings of the industry, the present teaching discloses further an improvement to reduce interference associated with the high low grayscale coupling. FIG. 19 provides a new scheme for the timing sequence, which can be applied in the LED system incorporating the various aspects of improvement as disclosed herein. As illustrated, the new timing sequence presents a different sequence of timing events, with the anti-interference period now after the compensate, turn-on, and turn-off periods and make the turn-off period adjustable or configurable. The shorter the constant current turn-off period, the smaller the high low grayscale coupling. That is, by configuring the turn-off period during the process of refreshing the screen, the anti-interference time is also adjusted to take the remaining time. That is, the adjusted anti-interference time is, the total scanning time for one line-compensation time-line feed time-turn-off time-turn-on time.

The distinctions between this improved solution and other traditional solutions include the following. The order of the events scheduled in the timing sequence is different as the anti-interference period now occurs after the compensate, turn-on, turn-off period and before the newline period. Which event is directly configurable is different because this improved solution allows reconfiguration of the turn-off time, thereby impacting the maximum anti-interference time. These distinctions lead to different improvements. First, the prior solution allows configuration of the maximum value of the anti-interference time. That is, in operation, the actual anti-interference time needs to be adjusted according to the grayscale value. In contrast, the improved solution according to the present teaching allows to configure the turn-off time, which yields the actual anti-interference time without having to rely on gray values and take direct effect. As such, the improved solution is simpler, and the user configuration for it to take effect is straightforward and more intuitive than the prior solution illustrated in FIG. 18B. For example, if a zero turn-off time is planned, with the improved solution, the turn-off time may be directly set to zero, which will automatically maximize the anti-interference time. However, as the priori solution in FIG. 18B does not allow directly configure the turn-off time so that the conversion relationship is relatively complicated.

Another benefit as compared to the prior solutions is the following. To convert grayscale clock frequency, it generally requires that each channel be in a turn-on state for a period. As different lengths of anti-interference time are possible using the prior solution shown in FIG. 18B, this may cause the turn-on time becoming misaligned so that the frequency conversion scheme may not be used to improve performance. However, according to the improved solution as discuss herein according to the present teaching, as the anti-interference time is after both the turn-on and turn-off events, this will not cause any negative impact on a frequency conversion operation.

Yet another aspect of the present teaching developed to be deployed either in the improved LED system of the present teaching or in other traditional LED systems is related to LVDS timing. A receiver receiving a clock signal may need to adjust the clock frequency or timing to facilitate the processing that it needs to form. For example, a device may receive a clock that has a different frequency from that of the data so that in order to sample the data at the data frequency rate, the received clock needs to be upgraded to a signal with the same frequency as that of the data. For example, if a driver in an LED system receives both a clock signal CLK and image data for display but CLK has a lower frequency than the data frequency. In this case, the received CLK may be processed to generate an updated clock signal such as grayscale clock GCLK at the same frequency to allow correct data sampling. This is how a traditional LED system operates to add a PLL circuit in each and every driver to upgrade a received CLK to a GCLK at a higher frequency so that each driver may sample the data from a data stream received according to the timing of the GCLK. The reason for the CLK having a lower frequency is that a controller and a driver connects via single ended signals, which operate at a lower speed. Also as discussed herein, with the new improved LED system, as controllers and drivers are now integrated and communicate with LVDS signals (faster), a controller may generate synchronous RGB LVDS (data) and GCLK LVDS (clock) centrally and transmit to the connected drivers. This makes it possible to significantly reduce the burden and cost of drivers by eliminating various circuits in drivers, including the PLL circuit. Given that, drivers according to the present teaching receive synchronous data and clock signals and do not need to change the frequency of the received clock signal so that without the PLL circuit therein does not cause a problem.

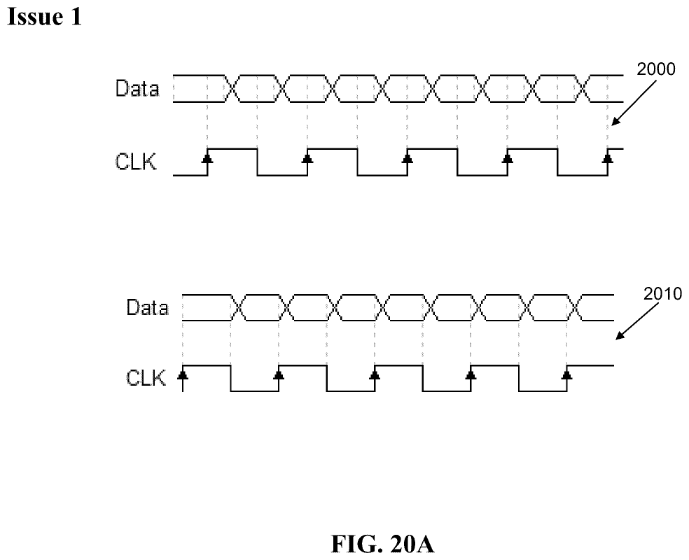

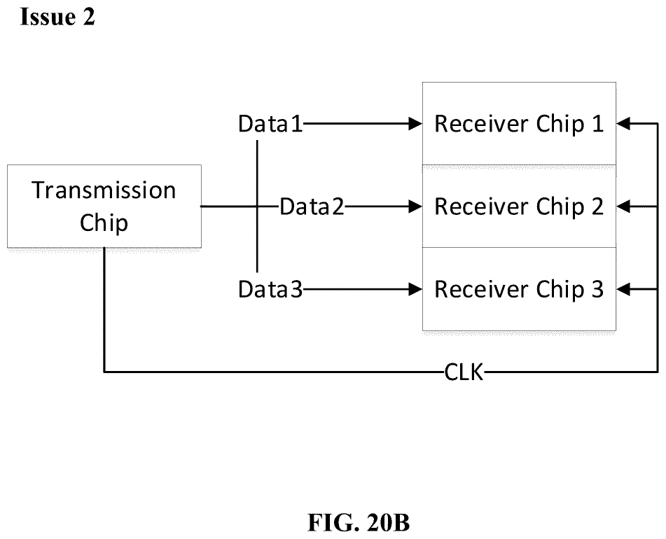

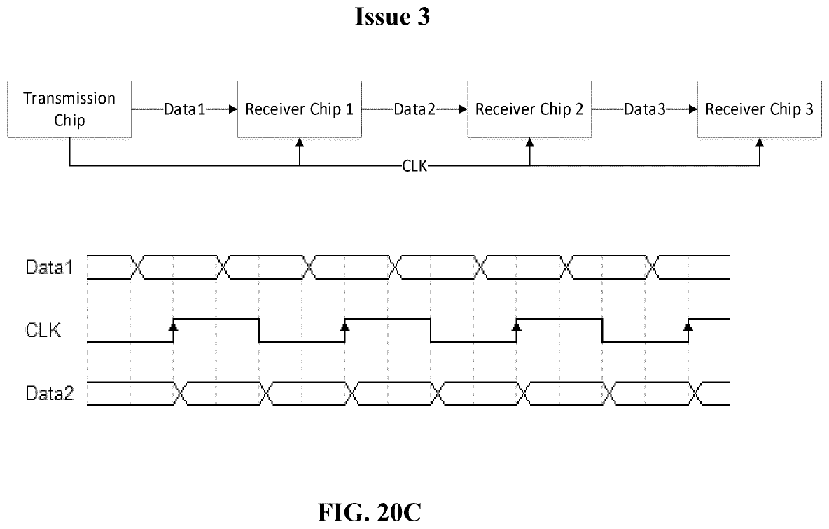

However, due to different reasons, even when a device receives clock and data with the same frequency, the device may still encounter misalignment issues between the clock and the data, making it difficult to sample the data at the right timing to ensure quality and, hence, impacting the performance of the device. Another improvement of the present teaching relates to how a device may adjust the timing of a received signal to ensure that data can be sampled correctly at a timing regulated by the adjusted clock signal. First, different situations are presented to shown what may cause misalignment between data and clock even when they are generated synchronously. FIG. 20A-20C illustrates different scenarios where synchronous data/clock may become misaligned from a transmission end to a receiving end. FIG. 20A shows first data signal and clock signal in the upper portion of the figure. As seen, the data is sent via LVDS with differential signals where the boundary of different bits may be determined based on the zero crossings of the differential signals. This is consistent with the RGB LVDS as disclosed herein. In this figure, the clock signal is shown to have rising and falling edges signaling the timing of the clock signal. If the clock is also transmitted as LVDS signals, as GCLK LVDS according to the present teaching, the locations of the rising and falling edges thereof may also be determined based on the zero crossings of the differential signals.

The issue illustrated in FIG. 20A is the following. Although the data and clock are synchronous (2000) when they are generated or transmitted, when the data and clock trace lengths are inconsistent, the waveforms of the transmitter and the receiving device will be different. For example, the rising edge/falling edges of the transmitter may initially fall in the middle of data (to ensure secure sampling considering, e.g., setup time and hold time). But when received by the receiver, the rising edge/falling edges of CLK may fall near the edges of data. While it is possible to overcome the trace length issue by modifying the PCB design to have the similar or equal length trace to improve alignment between data and clock, it may not be possible in every situation, and it increases the difficulty of PCB design.

FIG. 20B illustrates another scenario where misalignment likely will occur. In this scenario, a clock signal is transmitted in a one-to-many setting, i.e., the transmission device sends a clock signal CLK to multiple receivers. However, the same transmission device transmits data in a different mode through a one-to-one communication mode. As the driving capabilities and load resistance of the two transmission modes are different, this likely will also cause that the waveforms of the transmitter and receiver become different, causing misalignment between the two.

FIG. 20C shows yet another scenario where unintended misalignment occurs due to serial communications. Some applications require serial connections between/among different devices. In this illustration, a receiving device 1 receives data 1 according to a clock signal CLK. Initially, the rising edge/falling edge of CLK are synchronized in the middle of the data. Then receiving device sends data 2 to a receiving device 2, at timings according to CLK, which causes the rising edge/falling edge of CLK to fall at the edge of data 2. When this occurs, the CLK and data 2 are now no longer aligned in a manner intended to ensure correct data sampling. As such, when receiving device 2 receives data 2 and CLK, as the timings of the CLK likely cannot enable receiving device 2 to sample data correctly.

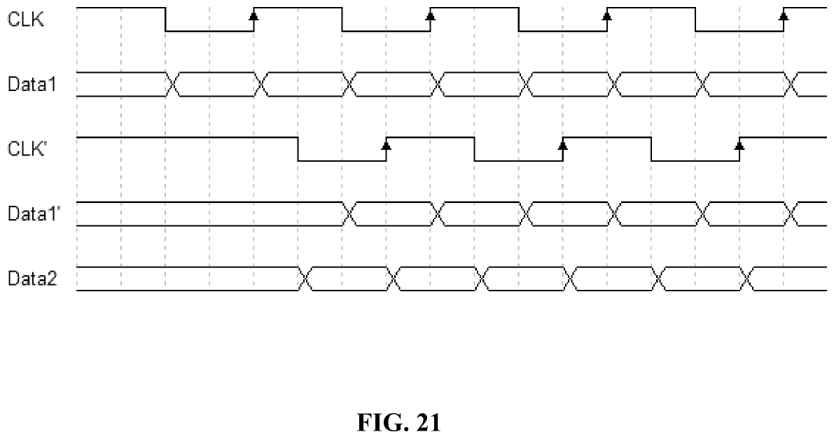

FIG. 21 illustrates an updated scheme to address the unintended misalignment between data and clock, according to the present teaching. The updated scheme may not be directed to enforce the original alignment between data and clock signals but rather focus on how to remedy the situation to ensure secure data sampling. To achieve that, the updated scheme according to the present teaching incorporates a delay register in a receiving device and configures the delay register with a value representing the length of delay to some signal, where to delay which signal and the length of delay may be determined in different situations. In some embodiments, an instruction may be provided to configure the delay register and the instruction may be coded. For instance, an instruction may be provided by configuring the delay register with a value ranging in 0-31, to indicate to delay the clock relative to data by a length represented by the value within 0-31. On the other hand, an instruction may be provided to configure the delay register with a value ranging in 32-63 to indicate to delay the data relative to the clock by a length represented by the value in the range of 32-63. In some embodiments, a default value may also be used to delay data. For instance, a default value 63 indicates to delay data relative to the clock by a maximum amount that can be represented by the delay register.

With this scheme, when a transmitting device sends data 1 (see FIG. 21) to a receiving device 1, with the rising edge/falling edge of CLK falls on the rising/falling edge of data 1. Assume that the receiving device 1 is configured with a default delay, i.e., 63 meaning a maximum delay on data relative to clock. Upon receipt of the transmission and after the configured delay on data 1, CLK′ and data 1′ represent what is accessible by the receiving device 1. As can be seen, after the delay, the rising/falling edge of CLK fall now in the middle of data, ensuring secure sampling. Thus, with the configured (maximum) delay, in the case of low speed (CLK cycle is larger than the register delay and PCB delay), data can be reliably sampled. That is, even without a calibration, so long as the LVDS speed is slow enough and the delay register is configured to have a maximum delay on data, the data may be sampled correctly.

When the receiving device 1 sends data 2 (e.g., data it needs to send out to a connected device), it synchronized the sending at the rising/falling edge CLK′. In this way, the next receiving device 2 is now in a same receiving condition as receiving device 1. As such, receiving device 2 may follow the same scheme (by delaying maximum on data 2) to ensure reliable sampling of data 2 using received clock signal.

In the above examples, the delay scheme is carried out without any prior calibration. That is, the delay register is simply in a default setting to provide a maximum delay in each situation. The delay register may also be configured using any delay amount via a calibration operation. In some embodiments, automatic calibration may be performed, according to the present teaching. Such a calibration may be performed automatically to configure any delay register in any receiving device with a predetermined delay length. An automatic calibration timing may be controlled in the following manner. Initially, all receiving devices (chips) may be set in a default calibrated mode. A sending chip may send an instruction to a receiving chip 1 at a low speed, requesting it to enter into a calibration mode. Other receiving chips remain in the calibrated mode absent of receiving explicit instructions.

Once the receiving chip enters into the calibration mode, the sending chip sends a special value (such as 0x5a3c, which may represent the delay length to be used to configure the delay register in the receiving chip) multiple times at a high speed. Based on the special value received in the calibration mode, the receiving chip 1 adjusts the configuration of its delay register with the new delay length represented by the special value. The receiving chip may then either return to the default calibrated mode or some other mode as required by different applications. Similarly, to calibrate a receiving chip 2, the sending chip sends an instruction at a low speed to receiving chip 2 to request it to enter into the calibration mode. Then the sending chip sends the receiving chip 2 special values (such as 0x5a3c) multiple times at ahigh speed, which enables receiving chip 2 to adjust or reconfigure the delay register therein.

This process may be leveraged to dynamically calibrate any of the receiving devices at any time needed. In addition, the sending chip as described in the example above to calibrate a receiving chip may itself be a receiving chip in another round of calibration. For instance, if a receiving chip 1 has been calibrated, it may turn around to calibrating a receiving chip 2. In this case, the receiving chip 1 sends a request at a low speed to instruct the receiving chip 2 to change to a calibration mode. When that is complete, the receiving chip 1 sends special values (e.g., 64) multiple times at a high speed based on a CLK. When the receiving chip 2 receives the special value, it may then adjust the 64 gears of the delay register to obtain a range of gears that can be received correctly. The receiving chip 2 may then configure the delay register to the middle value of the correct range.

The updated scheme to ensure correct data sampling based on clock signal despite of unintended misalignment represents a solution that finds a way to guarantee correct data sampling without incur structural changes or additional costs. For example, it avoids the costs associated with effort to design the PCB layout to avoid trace length differences. It does not need any change made to the clock signal, the way to transmit data/clock signals. This improved scheme effectively solves the unintended misalignment problem caused by latency difference due to the use of different transmission patterns (one-to-one and one-to-many) in the same system. By focusing on ensuring correct data sampling, this approach can tolerate differences, whether cause by nature of the signal or transmission paths, or transmission patterns, yet still achieve the fundamental need for correct data sampling in LED display.

The improved LED system according to the present teaching with a new architecture, internal constructs, implementations, and functionalities are described herein. The new architecture of integrated modules of the present teaching yields improved performance (high speed and reliable data transmission, resolution, bandwidth, etc.), efficiency (various centrally performed data processing, much reduced circuits in all drivers, light weight drivers, etc.), and costs (the cost to various circuits in devices that are consolidated centrally). The overall overhaul of the LED architecture provides different improvements as described herein to also address different issues encountered by the LED industry with new and improved solutions that further enhance the capability, performance, reliability, and fault tolerance. With the various improvements over the conventional ways of doing things, the issues associated with maintaining the consistency in chip packaging as much as possible to effectively incorporate the new architecture for LED display are also considered and addressed in a coherent fashion. For example, although the use of LVDS for chip-to-chip communication significantly improves the speed, bandwidth, and reliability of the LED system, as each LVDS needs two differential signals and therefore two separate pins in packaging. As such, to preserve the number of pins in chip packaging, some signals traditionally transmitted In/Out of the chip may need to be removed yet without impact the functionality of the entire system.

As such, the goal is to retain the number of pins on each chip. Effort has been made to introduce changes to the operations of different components in a way that not only certain signals transmitted via In/Out pins on chips are no longer needed but also the changes have improved the performance. Throughout this document, various such changes have been described in detail and there are part of the inventions/improvements according to the present teaching to produce a much enhanced LED system, including the packaging aspect of chips that utilizes the same number of pins as a traditional chip but able to provide and transmit any signal needed or output by the chip in order to achieve the overall improved performance as disclosed herein.

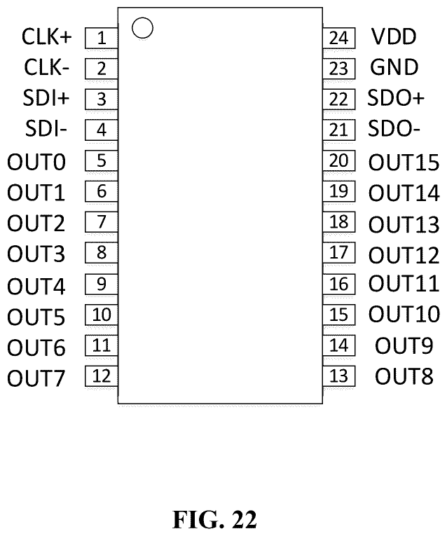

FIG. 22 shows an exemplary packaging with the same number of pins as that for a traditional chip and accommodating LVDS signals needed during the LED display operation according to the present teaching. As seen, both RGB LVDS and GCLK LVDS have respective four pins allocated thereon. For example, CLK+ and CLK−on pins two and three are for GCLK LVDS, SIN+ and SING−on pins four and five are for RGB LVDS provided to the chip, and SDO+ and SDO−on pins twenty-two and twenty-three are for RGB LVDS that are forwarded to a connected chip in a serial transmission.

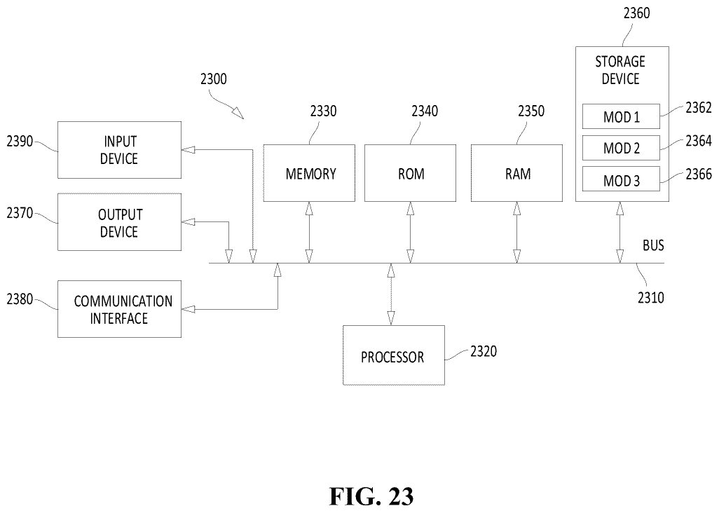

With reference to FIG. 23, an exemplary system includes a computing device 2300 (such as a general-purpose computing device), including a processing unit (CPU or processor) 2320 and a system bus 2310 that couples various system components including the system memory 2330 such as read-only memory (ROM) 2340 and random access memory (RAM) 2350 to the processor 2320. The computing device 2300 can include a cache of high-speed memory connected directly with, in close proximity to, or integrated as part of the processor 2320. The computing device 2300 copies data from the system memory 2330 and/or the storage device 2360 to the cache for quick access by the processor 2320. In this way, the cache provides a performance boost that avoids processor 2320 delays while waiting for data. These and other modules can control or be configured to control the processor 2320 to perform various actions. Other system memory 2330 may be available for use as well. The system memory 2330 can include multiple different types of memory with different performance characteristics. It can be appreciated that the disclosure may operate on a computing device 2300 with more than one processor 2320 or on a group or cluster of computing devices networked together to provide greater processing capability. The processor 2320 can include any general-purpose processor and a hardware module or software module, such as module 1 2362, module 2 2364, and module 3 2366 stored in storage device 2360, configured to control the processor 2320 as well as a special-purpose processor where software instructions are incorporated into the actual processor design. The processor 2320 may essentially be a completely self-contained computing system, including multiple cores or processors, a bus, memory controller, cache, etc. A multi-core processor may be symmetric or asymmetric.

The system bus 2310 may be any of several types of bus structures including a memory bus or memory controller, a peripheral bus, and a local bus using any of a variety of bus architectures. A basic input/output (BIOS) stored in memory ROM 2340 or the like, may provide the basic routine that helps to transfer information between elements within the computing device 2300, such as during start-up. The computing device 2300 further includes storage devices 2360 such as a hard disk drive, a magnetic disk drive, an optical disk drive, tape drive or the like. The storage device 2360 can include software modules 2362, 2364, 2366 for controlling the processor 2320. Other hardware or software modules are contemplated. The storage device 2360 is connected to the system bus 2310 by a drive interface. The drives and the associated computer-readable storage media provide nonvolatile storage of computer-readable instructions, data structures, program modules and other data for the computing device 2300. In one aspect, a hardware module that performs a particular function includes the software component stored in a tangible computer-readable storage medium in connection with the necessary hardware components, such as the processor 2320, system bus 2310, output device 2370 (such as a display or speaker), and so forth, to carry out the function. In another aspect, the system can use a processor and computer-readable storage medium to store instructions which, when executed by a processor (e.g., one or more processors), cause the processor to perform a method or other specific actions. The basic components and appropriate variations are contemplated depending on the type of device, such as whether the computing device 2300 is a small, handheld computing device, a desktop computer, or a computer server.

Although the exemplary embodiment described herein employs the storage device 2360 (such as a hard disk), other types of computer-readable media which can store data that are accessible by a computer, such as magnetic cassettes, flash memory cards, digital versatile disks, cartridges, random access memories (RAMs) 2350, and read-only memory (ROM) 2340, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 2300, an input device 2390 represents any number of input mechanisms, such as a microphone for speech, a touch-sensitive screen for gesture or graphical input, keyboard, mouse, motion input, speech and so forth. An output device 2370 can also be one or more of a number of output mechanisms known to those of skill in the art. In some instances, multimodal systems enable a user to provide multiple types of input to communicate with the computing device 2300. The communications interface 2380 generally governs and manages the user input and system output. There is no restriction on operating on any particular hardware arrangement and therefore the basic features here may easily be substituted for improved hardware or firmware arrangements as they are developed.

The technology discussed herein refers to computer-based systems and actions taken by, and information sent to and from, computer-based systems. One of ordinary skill in the art will recognize that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

Use of language such as “at least one of X, Y, and Z,” “at least one of X, Y, or Z,” “at least one or more of X, Y, and Z,” “at least one or more of X, Y, or Z,” “at least one or more of X, Y, and/or Z,” or “at least one of X, Y, and/or Z,” are intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure. For example, unless otherwise explicitly indicated, the steps of a process or method may be performed in an order other than the example embodiments discussed above. Likewise, unless otherwise indicated, various components may be omitted, substituted, or arranged in a configuration other than the example embodiments discussed above.

Further aspects of the present disclosure are provided by the subject matter of the following clauses.

A light emitting diode (LED) display, comprising: display panels connected to form the LED display, wherein each of the display panels includes a matrix of units, each of which is represented by multiple LED lights that can be lit in a manner determined based on a corresponding pixel of an image to be visualized on the LED display; and modules for controlling the multiple LED lights in the LED display based on content of the image, wherein each of the modules includes therein at least one controller and a plurality of drivers operating together to control an amount of light emitted by each LED light in the multiple LED lights in some of the display panels according to pixel values in a corresponding portion of the image, wherein each of the at least one controller and the plurality of drivers in each of the modules communicate via low voltage differential signaling (LVDS) signals.

The LED display of any preceding clause, wherein the multiple LED lights include a red, a green, and a blue (RGB) lights, each of which is to be separately controlled to emit an amount of light in accordance with corresponding red, green, and blue grayscale values of a pixel of the image.

The LED display of any preceding clause, wherein the LVDS signals include RGB LVDS and grayscale (GCLK) LVDS, wherein the RGB LVDS corresponds to signals transmitted from each of the at least one controller to drivers connected thereto to control emission of light by the LED lights with respect to each pixel of the image; and the GCLK LVDS corresponds to clock signals transmitted from the at least one controller to drivers connected thereto and to be used to centrally control timings of emissions of the LED lights.

The LED display of any preceding clause, wherein the modules are connected in a series and communicate via serializer/deserializer (SerDes) devices.

The LED display of any preceding clause, wherein each of the at least one controller in each of the modules comprises: a synchronous random-access memory (SRAM); and a circuitry for performing, via the SRAM, one or more centralized operations with respect to the image.

The LED display of any preceding clause, wherein: the circuitry of the at least one controller comprises at least one of: an image data correction unit for carrying out centralized image correction; a time-spatial enhancement unit for performing centralized time and spatial domain image enhancement; and a computation module for centralized parasitic capacitance correction.

The LED display of any preceding clause, wherein each module within the modules is a distinct Printed Circuit Board (PCB), resulting in a plurality of PCBs.

The LED display of any preceding clause, wherein on each module a controller within the at least one controller transmits data to at least a portion of drivers within the plurality of drivers.

The LED display of any preceding clause, wherein a single power supply provides power to each PCB in the plurality of PCBs.

The LED display of any preceding clause, wherein each PCB in the plurality of PCBs has a distinct power supply.

The LED display of any preceding clause, wherein: a common power supply provides a first voltage to each PCB in the plurality PCBs; and each PCB in the plurality of PCBs has a distinct power supply, the distinct power supply of each PCB providing a second voltage to the each PCB, the distinct power supply of each PCB only extending power to a PCB on which the distinct power supply is located.

The LED display of any preceding clause, wherein the at least one controller generates the LVDS signals.

A module for controlling LED lights in an LED display, comprising: at least one controller; and a plurality of drivers operating together to control an amount of light emitted by each of the LED lights in at least a portion of the LED display according to pixel values in a corresponding portion of an image, wherein each of the at least one controller and the plurality of drivers in each of the modules communicate via low voltage differential signaling (LVDS) signals.

The module of any preceding clause, further comprising: at least one serializer/deserializer (SerDes) device used to communicate with at least one neighboring module.

The module of any preceding clause, wherein the LED lights include a red, a green, and a blue (RGB) lights, each of which is to be separately controlled to emit an amount of light in accordance with corresponding red, green, and blue grayscale values of a pixel of the image.

The module of any preceding clause, wherein the LVDS signals include RGB LVDS and grayscale (GCLK) LVDS, wherein the RGB LVDS corresponds to signals transmitted from each of the at least one controller to drivers connected thereto to control emission of light by the LED lights with respect to each pixel of the image; and the GCLK LVDS corresponds to clock signals transmitted from the at least one controller to drivers connected thereto and to be used to centrally control timings of emissions of the LED lights.

The module of any preceding clause, wherein: each of the at least one controller comprises: a synchronous random-access memory (SRAM); and a circuitry for performing, via the SRAM, one or more centralized operations with respect to the image.

The module of any preceding clause, wherein: the circuitry of the at least one controller comprises at least one of: an image data correction unit for carrying out centralized image correction; a time-spatial enhancement unit for performing centralized time and spatial domain image enhancement; and a computation module for centralized parasitic capacitance correction.

The module of any preceding clause, wherein each module includes a power supply specific to the module.

The module of any preceding clause, wherein the at least one controller generates the LVDS signals.

A light emitting diode (LED) display, comprising: display panels connected to form the LED display, wherein each of the display panels includes a matrix of units, each of which is represented by multiple LED lights that can be lit in a manner determined based on a corresponding pixel of an image to be visualized on the LED display; and modules for controlling the LED lights in the LED display based on content of the image, wherein each of the modules comprises: a power supply generating VCC (Voltage Common Collector, also known as power input) and DVDD (Digital Voltage Drain, also known as digital power); at least one controller; and a plurality of drivers operating together to control an amount of light emitted by each of LED lights in some of the display panels according to pixel values in a corresponding portion of the image, wherein the at least one controller receives at least the VCC; and wherein each driver in the plurality of drivers receives both the VCC and the DVDD.

The LED display of any preceding clause, wherein the VCC is within a predetermined range of 3.8V.

The LED display of any preceding clause, wherein the DVDD is within a predetermined range of 2.8V.

The LED display of any preceding clause, wherein the LED lights comprise red, green, and blue (RGB) lights, each of which is to be separately controlled to emit an amount of light in accordance with corresponding red, green, and blue grayscale values of a pixel of the image.

The LED display of any preceding clause, wherein the VCC is used to drive the blue lights and the green lights, and wherein the DVDD is used to drive the red lights.

The LED display of any preceding clause, wherein the power supply for each module in the modules comprises a Digital Current (DC)-DC converter, wherein the DC-DC converter converts the VCC to the DVDD.

A module for controlling light emitting diode (LED) lights in at least one display panel included in an LED display having a plurality of connected display panels, comprising: a power supply generating a VCC (Voltage Common Collector, also known as power input) and DVDD (Digital Voltage Drain, also known as digital power); at least one controller each of which having a centralized synchronous random access memory (SRAM) and a circuitry for performing at least one centralized operation on image data to be visualized on the at least one display panel of the LED display; and a plurality of drivers, including row and column drivers, coupled with the at least one controller and the at least one display panel in the LED display for driving the LED lights, wherein the at least one controller receives at least the VCC; and wherein each driver in the plurality of drivers receives both the VCC and the DVDD.

The module of any preceding clause, wherein the VCC is within a predetermined range of 3.8V.

The module of any preceding clause, wherein the DVDD is within a predetermined range of 2.8V.

The module of any preceding clause, wherein the LED lights comprise red, green, and blue (RGB) lights, each of which is to be separately controlled to emit an amount of light in accordance with corresponding red, green, and blue grayscale values of a pixel of the image.

The module of any preceding clause, wherein the VCC is used to drive the blue lights and the green lights, and wherein the DVDD is used to drive the red lights.

The module of any preceding clause, wherein the power supply comprises a Digital Current (DC)-DC converter, wherein the DC-DC converter converts the VCC to the DVDD.

A light emitting diode (LED) display, comprising: display panels connected to form the LED display, wherein each of the display panels includes a matrix of units, each of which is represented by multiple LED lights that can be lit in a manner determined based on a corresponding pixel of an image to be visualized on the LED display; and modules for controlling the LED lights in the LED display based on content of the image, wherein each of the modules includes therein at least one controller and a plurality of drivers operating together to control an amount of light emitted by each of LED lights in some of the display panels according to pixel values in a corresponding portion of the image, wherein each of the at least one controller and the plurality of drivers in each of the modules communicate via low voltage differential signaling (LVDS) signals, the LVDS signals comprising a clock signal and a Red Green Blue (RGB) signal.

The LED display of any preceding clause, each module in the modules comprising at least one two-way Serial Gigabit Media-Independent Interface (SGMII).

The LED display of any preceding clause, wherein communications between the modules occur via the at least one two-way SGMII.

The LED display of any preceding clause, wherein each of the at least one controller in each of the modules comprises: a synchronous random-access memory (SRAM); and a circuitry for performing, via the SRAM, one or more centralized operations with respect to the image.

The LED display of any preceding clause, wherein the SRAM within the at least one controller is the only SRAM within each of the modules.

The LED display of any preceding clause, wherein each driver in the plurality of drivers lack a driver-specific Phase-Locked Loop (PLL) unit.

The LED display of any preceding clause, wherein each driver in the plurality of drivers lack a driver specific DVDD (Digital Voltage Drain, also known as digital power) circuitry.

The LED display of any preceding clause, wherein each driver in the plurality of drivers includes a digital module, the digital module configured to identify (1) first data to be output by each driver, and (2) second data to be forwarded to other drivers.

The LED display of any preceding clause, wherein each driver in the plurality of drivers further includes: a Pulse Width Modulation (PWM) controller which receives the first data; and an output module which receives PWM output from the PWM controller and causes the LED lights to light.

A module for controlling light emitting diode (LED) lights in at least one display panel included in an LED display having a plurality of connected display panels, comprising: at least one controller each of which having a centralized synchronous random access memory (SRAM) and a circuitry for performing at least one centralized operation on image data to be visualized on the at least one display panel of the LED display; and a plurality of drivers, including row and column drivers, coupled with the at least one controller and the at least one display panel in the LED display for driving the LED lights associated therewith in accordance with low voltage differential signaling (LVDS) signals from the at least one controller, the LVDS signals comprising a clock signal and a Red Green Blue (RGB) signal, wherein the at least one controller controls, via the LVDS signals to the plurality of drivers in the module: timing based on the clock signal; and an amount of light emitted by the LED lights in the at least one display panel based on values of pixels in a portion of an image corresponding to the at least one display panel according to the RGB signal.

The module of any preceding clause, the module comprises at least one two-way Serial Gigabit Media-Independent Interface (SGMII).

The module of any preceding clause, wherein communications with other modules occurs via the at least one two-way SGMII.

The module of any preceding clause, wherein the SRAM within the at least one controller is the only SRAM within the module.

The module of any preceding clause, wherein each driver in the plurality of drivers lack a driver-specific Phase-Locked Loop (PLL) unit.

The module of any preceding clause, wherein each driver in the plurality of drivers lack a driver specific DVDD (Digital Voltage Drain, also known as digital power) circuitry.

The module of any preceding clause, wherein each driver in the plurality of drivers includes a digital module, the digital module configured to identify (1) first data to be output by each driver, and (2) second data to be forwarded to other drivers.

The module of any preceding clause, wherein each driver in the plurality of drivers further includes: a Pulse Width Modulation (PWM) controller which receives the first data; and an output module which receives PWM output from the PWM controller and causes the LED lights to light.

A light emitting diode (LED) display, comprising: display panels connected to form the LED display, wherein each of the display panels includes a matrix of units, each of which is represented by multiple LED lights that can be lit in a manner determined based on a corresponding pixel of an image to be visualized on the LED display; modules for controlling the LED lights in the LED display based on the image, wherein each of the modules includes therein at least one controller and a plurality of drivers operating together to control an amount of light emitted by each of LED lights in some of the display panels according to pixel values in a corresponding portion of the image, wherein each of the at least one controller in each of the modules includes a centralized time-spatial enhancement unit for: receiving data from a Serializer/De-serializer, the data comprising a portion of the image, performing time-spatial enhancement on the portion of the image to generate a time-spatial enhanced sub-image, and storing the time-spatial enhanced sub-image in a synchronous random access memory (SRAM) until the controller sends the time-spatial enhanced sub-image from the SRAM to drivers within the plurality of drivers to control an amount of light emitted by LED lights associated with the drivers.

The LED display of any preceding clause, wherein the at least one controller further comprises a synchronous random-access memory (SRAM), wherein the SRAM is used as a buffer during the time-spatial enhancement.

The LED display of any preceding clause, wherein the SRAM has a high 16-bit data buffer, a low 4-bit Floyd enhancement buffer, and a middle 4-bit time enhancement buffer.

The LED display of any preceding clause, wherein output of the low 4-bit Floyd enhancement buffer is provided to a Floyd-Steinberg computation unit within the centralized time-spatial enhancement unit, wherein the Floyd-Steinberg computation unit modifies pixel values according to a Floyd-Stenberg spatial enhancement scheme.

The LED display of any preceding clause, wherein the SRAM comprises at least one refresh screen scan buffer, at least one scan data buffer, and at least one temporal data buffer.

The LED display of any preceding clause, wherein the at least one refresh screen scan buffer, the at least one scan data buffer, and the at least one temporal data buffer are separate from one another within the SRAM.

The LED display of any preceding clause, wherein the centralized time-spatial enhancement unit modifies an amount of time a given pixel are illuminated.

The LED display of any preceding clause, wherein the data is received by the Serializer/De-serializer from an image data correction unit.

The LED display of any preceding clause, wherein the image data correction unit performs at least one of a color correction and a temperature correction with respect to the image, as recorded in the data.

A module for controlling light emitting diode (LED) lights in at least one display panel included in an LED display having a plurality of connected display panels, comprising: at least one controller each of which having: a time-spatial enhancement unit which performs spatial enhancement using a Floyd-Stenberg (FS) spatial enhancement algorithm on data of an image; a centralized synchronous random access memory (SRAM), the centralized SRAM including FS enhanced image data received from the time-spatial enhancement unit; and a circuitry for performing at least one centralized operation on the FS enhanced image data to be visualized on the at least one display panel of the LED display; wherein the time-spatial enhancement unit receives data from a Serializer/De-serializer, applies the spatial enhancement, and forwards the FS enhanced image data to the centralized SRAM for storage until required by a driver; and a plurality of drivers, including row and column drivers, coupled with the at least one controller and the at least one display panel in the LED display for driving the LED lights associated therewith in accordance with the FS enhanced image data.

The module of any preceding clause, wherein the SRAM is used as a buffer during execution of the FS spatial enhancement algorithm.

The module of any preceding clause, wherein the SRAM has a high 16-bit data buffer, a low 4-bit Floyd enhancement buffer, and a middle 4-bit time enhancement buffer.

The module of any preceding clause, wherein output of the low 4-bit Floyd enhancement buffer is provided to a Floyd-Steinberg computation unit within the time-spatial enhancement unit, wherein the Floyd-Steinberg computation unit modifies pixel values according to the FS spatial enhancement algorithm.

The module of any preceding clause, wherein the SRAM comprises at least one refresh screen scan buffer, at least one scan data buffer, and at least one temporal data buffer.

The module of any preceding clause, wherein the at least one refresh screen scan buffer, the at least one scan data buffer, and the at least one temporal data buffer are separate from one another within the SRAM.

The module of any preceding clause, wherein the time-spatial enhancement unit modifies an amount of time a given pixel are illuminated.

The module of any preceding clause, wherein the data is received by the Serializer/De-serializer from an image data correction unit.

The module of any preceding clause, wherein the image data correction unit performs at least one of a color correction and a temperature correction with respect to the image, as recorded in the data.

A light emitting diode (LED) display, comprising: display panels connected to form the LED display, wherein each of the display panels includes a matrix of units, each of which is represented by multiple LED lights that can be lit in a manner determined based on a corresponding pixel of an image to be visualized on the LED display; modules for controlling the LED lights in the LED display based on content of the image, wherein each of the modules includes therein a controller and a plurality of drivers operating together to control an amount of light emitted by each of LED lights in some of the display panels according to pixel values in a corresponding portion of the image; and a plurality of Serializers/De-Serializers (SerDes) devices for serially connecting controllers of the modules to allow content of the image to be transmitted to the controllers of the modules in a serial manner, wherein each of the plurality of SerDes devices has redundant two-way transmission paths.

The LED display of any preceding clause, wherein each of the plurality of SerDes devices is configured for: detecting an error related to a transmission path along a transmission direction, and automatically reconfiguring the SerDes device to obtain an alternative transmission path in the transmission direction upon detection of the error.

The LED display of any preceding clause, wherein the redundant two-way transmission paths comprise four normal routes prior to detection of the error, with two of the four normal routes advancing in a first direction and two of the normal routes advancing in a second direction, the second direction being opposite to the first direction.

The LED display of any preceding clause, wherein the plurality of drivers comprise row drivers and column drivers.

The LED display of any preceding clause, the LED lights include a red, a green, and a blue (RGB) lights, each of which is to be separately controlled to emit an amount of light in accordance with corresponding red, green, and blue grayscale values of a pixel of the image.

A module for controlling light emitting diode (LED) lights in at least one display panel included in an LED display having a plurality of connected display panels, comprising: at least one controller each of which having a centralized synchronous random access memory (SRAM) and a circuitry for performing at least one centralized operation on image data to be visualized on the at least one display panel of the LED display; a plurality of drivers coupled with the at least one controller and the at least one display panel in the LED display for driving the LED lights associated therewith in accordance with the image data; and a plurality of Serializers/De-Serializers (SerDes) devices for serially connecting controllers of the modules to allow content of the image data to be transmitted to the controllers of the modules in a serial manner, wherein each of the plurality of SerDes devices has redundant two-way transmission paths.

The module of any preceding clause, wherein each of the plurality of SerDes devices is configured for: detecting an error related to a transmission path along a transmission direction, and automatically reconfiguring the SerDes device to obtain an alternative transmission path in the transmission direction upon detection of the error.

The module of any preceding clause, wherein the redundant two-way transmission paths comprise four normal routes prior to detection of the error, with two of the four normal routes advancing in a first direction and two of the normal routes advancing in a second direction, the second direction being opposite to the first direction.

The module of any preceding clause, wherein the plurality of drivers comprise row drivers and column drivers.

The module of any preceding clause, the LED lights include a red, a green, and a blue (RGB) lights, each of which is to be separately controlled to emit an amount of light in accordance with corresponding red, green, and blue grayscale values of a pixel of the image data.

A light emitting diode (LED) display, comprising: display panels connected to form the LED display, wherein each of the display panels includes a matrix of units, each of which is represented by multiple LED lights that can be lit in a manner determined based on a corresponding pixel of an image to be visualized on the LED display; and modules for controlling the LED lights in the LED display based on content of the image, wherein each of the modules includes therein at least one controller and a plurality of drivers operating together to control an amount of light emitted by each of LED lights in some of the display panels according to pixel values in a corresponding portion of the image, wherein: each controller in each of the modules generates a variable grayscale clock signal to be transmitted to the plurality of drivers for controlling a duration of lighting each of the LED lights.

The LED display of any preceding clause, wherein the variable grayscale clock signal modifies a grayscale intensity of the LED display by determining how long a given LED light within the multiple LED lights is turned on.

The LED display of any preceding clause, wherein: the variable grayscale clock signal corresponds to a sequence of K types of pulse signals arranged in a predetermined order; and each of the K types of pulse signals is associated with a different duration with a predetermined increment, resulting in K different durations.

The LED display of any preceding clause, wherein the sequence of K types of pulse signals arranged in the predetermined order enables the plurality of drivers to control corresponding LED lights to light for: any of the K different durations; and any duration determined by combining the durations of consecutive pulse signals in the sequence.

The LED display of any preceding clause, wherein a shorter clock width is achieved via subtraction using a combination of at least two of the pulse signals.

The LED display of any preceding clause, wherein a longer clock width is achieved via addition using a combination of at least two of the pulse signals.

The LED display of any preceding clause, wherein the K types of pulse signals have widths which are multiples of 0.625 ns.

The LED display of any preceding clause, wherein the K types of pulse signals are within a predetermined range of accuracy.

A module for controlling light emitting diode (LED) lights in at least one display panel included in an LED display having a plurality of connected display panels, comprising: at least one controller each of which having a centralized synchronous random access memory (SRAM) and a circuitry for performing at least one centralized operation on image data to be visualized on the at least one display panel of the LED display; and a plurality of drivers, including row and column drivers, coupled with the at least one controller and the at least one display panel in the LED display for driving the LED lights associated therewith in accordance with the image data, wherein: each controller in the at least one controller generates a variable grayscale clock signal to be transmitted to the plurality of drivers for controlling a duration of lighting each of the LED lights.

The module of any preceding clause, wherein the variable grayscale clock signal modifies a grayscale intensity of the LED display by determining how long a given LED light within the LED lights is turned on.

The module of any preceding clause, wherein: the variable grayscale clock signal corresponds to a sequence of K types of pulse signals arranged in a predetermined order; and each of the K types of pulse signals is associated with a different duration with a predetermined increment, resulting in K different durations.

The module of any preceding clause, wherein the sequence of K types of pulse signals arranged in the predetermined order enables the plurality of drivers to control corresponding LED lights to light for: any of the K different durations; and any duration determined by combining the durations of consecutive pulse signals in the sequence.

The module of any preceding clause, wherein a shorter clock width is achieved via subtraction using a combination of at least two of the pulse signals.

The module of any preceding clause, wherein a longer clock width is achieved via addition using a combination of at least two of the pulse signals.

The module of any preceding clause, wherein the K types of pulse signals have widths which are multiples of 0.625 ns.

The module of any preceding clause, wherein the K types of pulse signals are within a predetermined range of accuracy.

A light emitting diode (LED) display, comprising: display panels connected to form the LED display, wherein each of the display panels includes a matrix of units, each of which is represented by multiple LED lights that can be lit in a manner determined based on a corresponding pixel of an image to be visualized on the LED display; modules for controlling the LED lights in the LED display based on content of the image, wherein each of the modules is provided to light at least one of the display panels based on image content in a portion of the image and comprises: a controller; and a plurality of drivers coupled to the controller for operating based on instructions from the controller to control an amount of light emitted by each of LED lights in the at least one of the display panels according to pixel values in the portion of the image, wherein: the controller comprises a parasitic capacitance corrector configured for, with respect to each pixel in the portion of the image, generating a corrected gray value for lighting each of the LED lights in the at least one of the display panels corresponding to the pixel based on parasitic capacitance associated with the LED light.

The LED display of any preceding clause, wherein the corrected gray value generated by the parasitic capacitance corrector for the lighting of each of the LED lights is sent from the controller to the plurality of drivers for controlling the lighting of the LED lights in at least some of the display panels.

The LED display of any preceding clause, wherein the parasitic capacitance corrector performs operations to generate the corrected gray value, the operations comprising: reading a gray value of a pixel from a centralized synchronous random access memory (SRAM) located in the controller; and reading a parasitic capacitance correction parameter associated with the pixel from the centralized SRAM, wherein the corrected gray value equals the gray value plus the parasitic capacitance correction parameter.

The LED display of any preceding clause, wherein the parasitic capacitance correction parameter is provided to the centralized SRAM of the controller prior to an image scan controller generating outputs.

The LED display of any preceding clause, wherein the parasitic capacitance correction parameter is stored in a low voltage differential signaling (LVDS) buffer.

The LED display of any preceding clause, wherein the LVDS buffer is one of two separate LVDS buffers configured in parallel, where data is loaded into each of the two separate LVDS buffers on alternating clock cycles.

A module for controlling light emitting diode (LED) lights in at least one display panel included in an LED display having a plurality of connected display panels, comprising: at least one controller each of which having a parasitic capacitance corrector, and a circuitry for performing at least one centralized operation on image data to be visualized on the at least one display panel of the LED display; and a plurality of drivers, including row and column drivers, coupled with the at least one controller and the at least one display panel in the LED display for driving the LED lights associated therewith in accordance with the image data, wherein: the parasitic capacitance corrector generates, with respect to each pixel in a portion of the image data, a corrected gray value for lighting each of the LED lights in the at least one display panel corresponding to the pixel based on parasitic capacitance associated with the LED light.

The module of any preceding clause, wherein the corrected gray value generated by the parasitic capacitance corrector for the lighting of each of the LED lights is sent from the controller to the plurality of drivers for controlling the lighting of the LED lights in at least some of the display panels.

The module of any preceding clause, wherein the parasitic capacitance corrector performs operations to generate the corrected gray value, the operations comprising: reading a gray value of the pixel from a centralized synchronous random access memory (SRAM) located in the controller; and reading a parasitic capacitance correction parameter associated with the pixel from the centralized SRAM, wherein the corrected gray value equals the gray value plus the parasitic capacitance correction parameter.

The module of any preceding clause, wherein the parasitic capacitance correction parameter is provided to the centralized SRAM of the controller prior to an image scan controller generating outputs.

The module of any preceding clause, wherein the parasitic capacitance correction parameter is stored in a low voltage differential signaling (LVDS) buffer.

The module of any preceding clause, wherein the LVDS buffer is one of two separate LVDS buffers configured in parallel, where data is loaded into each of the two separate LVDS buffers on alternating clock cycles.

A light emitting diode (LED) display, comprising: display panels connected to form the LED display, wherein each of the display panels includes a matrix of units, each of which is represented by multiple LED lights that can be lit in a manner determined based on a corresponding pixel of an image to be visualized on the LED display; modules for controlling the LED lights in the LED display based on content of the image, wherein each of the modules includes therein at least one controller and a plurality of drivers operating together to control an amount of light emitted by each of LED lights in some of the display panels according to pixel values in a corresponding portion of the image, wherein the at least one controller comprises a Phase-Locked Loop (PLL) unit which generates a grayscale clock which is distributed to the plurality of drivers.

The LED display of any preceding clause, wherein the plurality of drivers do not include PLL units, and instead receive the grayscale clock from the PLL unit within the at least one controller.

The LED display of any preceding clause, wherein the PLL unit performs sub-sampling of a digital clock signal to generate the grayscale clock.

The LED display of any preceding clause, wherein the digital clock signal is generated via a crystal oscillator.

The LED display of any preceding clause, wherein the grayscale clock is distributed to the plurality of drivers using low voltage differential signaling (LVDS) signals.

A module for controlling light emitting diode (LED) lights in at least one display panel included in an LED display having a plurality of connected display panels, comprising: at least one controller each of which having: a centralized synchronous random access memory (SRAM); a Phase-Locked Loop (PLL) unit which generates a grayscale clock which is distributed to a plurality of drivers; and a circuitry for performing at least one centralized operation on image data to be visualized on the at least one display panel of the LED display; and the plurality of drivers, including row and column drivers, coupled with the at least one controller and the at least one display panel in the LED display for driving the LED lights associated therewith in accordance with the image data.

The module of any preceding clause, wherein the plurality of drivers do not include PLL units, and instead receive the grayscale clock from the PLL unit within the at least one controller.

The module of any preceding clause, wherein the PLL unit performs sub-sampling of a digital clock signal to generate the grayscale clock.

The module of any preceding clause, wherein the digital clock signal is generated via a crystal oscillator.

The module of any preceding clause, wherein the grayscale clock is distributed to the plurality of drivers using low voltage differential signaling (LVDS) signals.

A light emitting diode (LED) display, comprising: display panels connected to form the LED display, wherein each of the display panels includes a matrix of units, each of which is represented by multiple LED lights that can be lit in a manner determined based on a corresponding pixel of an image to be visualized on the LED display; modules for controlling the LED lights in the LED display based on content of the image, wherein each of the modules includes therein at least one controller and a plurality of drivers operating together to control an amount of light emitted by each of LED lights in some of the display panels according to pixel values in a corresponding portion of the image, wherein each driver in the plurality of drivers comprises an internal resistor circuit which establishes an internal resistor value for the each driver.

The LED display of any preceding clause, wherein the internal resistor value is determined during one of a CP (Circuit Probe) or wafer test for each module in the modules.

The LED display of any preceding clause, wherein the CP or the wafer test output a current value, and the internal resistor value is determined by matching the current value to a predefined value.

The LED display of any preceding clause, wherein the current value is within a predetermined range of 10 mA.

The LED display of any preceding clause, wherein the internal resistor value of the each driver in the plurality of drivers is a single value.

The LED display of any preceding clause, wherein the internal resistor value of the each driver in the plurality of drivers is customized to the each driver, such that different internal resistor values between drivers in the plurality of drivers occurs.

The LED display of any preceding clause, wherein the internal resistor value for the each driver is used to establish a reference current.

A module for controlling light emitting diode (LED) lights in at least one display panel included in an LED display having a plurality of connected display panels, comprising: at least one controller each of which having a centralized synchronous random access memory (SRAM) and a circuitry for performing at least one centralized operation on image data to be visualized on the at least one display panel of the LED display; and a plurality of drivers, including row and column drivers, coupled with the at least one controller and the at least one display panel in the LED display for driving the LED lights associated therewith in accordance with the image data, wherein each driver in the plurality of drivers comprises an internal resistor circuit which establishes an internal resistor value for the each driver.

The module of any preceding clause, wherein the internal resistor value is determined during one of a CP (Circuit Probe) or wafer test for each module in the modules.

The module of any preceding clause, wherein the CP or the wafer test output a current value, and the internal resistor value is determined by matching the current value to a predefined value.

The module of any preceding clause, wherein the current value is within a predetermined range of 10 mA.

The module of any preceding clause, wherein the internal resistor value of the each driver in the plurality of drivers is a single value.

The module of any preceding clause, wherein the internal resistor value of the each driver in the plurality of drivers is customized to the each driver, such that different internal resistor values between drivers in the plurality of drivers occurs.

The module of any preceding clause, wherein the internal resistor value for the each driver is used to establish a reference current.

A light emitting diode (LED) display, comprising: display panels connected to form the LED display, wherein each of the display panels includes a matrix of units, each of which is represented by LED lights that can be lit in a manner determined based on a corresponding pixel of an image to be visualized on the LED display; modules for controlling the LED lights in the LED display based on content of the image, wherein each of the modules includes therein at least one controller and a plurality of drivers operating together to control an amount of light emitted by each of LED lights in some of the display panels according to pixel values in a corresponding portion of the image, wherein each of the at least one controller and the plurality of drivers in each of the modules communicate via low voltage differential signaling (LVDS) signals such that there is a delay from transmission of the image to the modules and output of the image onto the LED display, the delay being a single frame plus a single line scan.

The LED display of any preceding clause, wherein when a sending card within the modules sends a new frame to a receiving card within the modules, the at least one controller sends a current frame, a X subframe, and a Y+1 line scan to a driver within the plurality of drivers.

The LED display of any preceding clause, wherein the driver within the plurality of drivers controls based on the current frame, the X subframe, and a Y line scan to control a lighting time of the LED lights.

The LED display of any preceding clause, wherein as the plurality of drivers receive a line of scan data within a frame, it can begin to display the line of scan data within the frame.

The LED display of any preceding clause, wherein the at least one controller receives the image while simultaneously transmitting a previous image to the plurality of drivers.

The LED display of any preceding clause, wherein communication between the at least one controller and the plurality of drivers comprises low voltage differential signaling (LVDS) signals.

The LED display of any preceding clause, wherein the modules are connected in a series and communicate via serializer/deserializer (SerDes) devices.

The LED display of any preceding clause, wherein the plurality of drivers are connected in a series and communicate via serializer/deserializer (SerDes) devices.

The LED display of any preceding clause, wherein each module within the modules is a distinct Printed Circuit Board (PCB), resulting in a plurality of PCBs.

A module for controlling light emitting diode (LED) lights in at least one display panel included in an LED display having a plurality of connected display panels, comprising: at least one controller each of which having a centralized synchronous random access memory (SRAM) and a circuitry for performing at least one centralized operation on image data to be visualized on the at least one display panel of the LED display; and a plurality of drivers, including row and column drivers, coupled with the at least one controller and the at least one display panel in the LED display for driving the LED lights associated therewith in accordance with low voltage differential signaling (LVDS) signals from the at least one controller, wherein the at least one controller controls, via the LVDS signals to the plurality of drivers, timing and amount of light emitted by the LED lights in the at least one display panel based on values of pixels in a portion of an image corresponding to the at least one display panel such that there is a delay from transmission of the image to the modules and output of the image onto the LED display, the delay being a single frame plus a single line scan.

The module of any preceding clause, wherein when a sending card sends a new frame to a receiving card, the at least one controller sends a current frame, a X subframe, and a Y+1 line scan to a driver within the plurality of drivers.

The module of any preceding clause, wherein the driver within the plurality of drivers controls based on the current frame, the X subframe, and a Y line scan to control a lighting time of the LED lights.

The module of any preceding clause, wherein as the plurality of drivers receive a line of scan data within a frame, it can begin to display the line of scan data within the frame.

The module of any preceding clause, wherein the at least one controller receives the image while simultaneously transmitting a previous image to the plurality of drivers.

The module of any preceding clause, wherein communication between the at least one controller and the plurality of drivers comprises low voltage differential signaling (LVDS) signals.

The module of any preceding clause, wherein the plurality of drivers are connected in a series and communicate via serializer/deserializer (SerDes) devices.

The module of any preceding clause, wherein the is a distinct Printed Circuit Board (PCB).

A light emitting diode (LED) display, comprising: display panels connected to form the LED display, wherein each of the display panels includes a matrix of units, each of which is represented by multiple LED lights that can be lit in a manner determined based on a corresponding pixel of an image to be visualized on the LED display; modules for controlling the LED lights in the LED display based on content of the image, wherein each of the modules includes therein at least one controller and a plurality of drivers operating together to control an amount of light emitted by each of LED lights in some of the display panels according to pixel values in a corresponding portion of the image, wherein each driver in the plurality of drivers comprises at least one current level adjustor, wherein the at least one current level adjustor adjusts current drawn by an LED signal generator based on an ambient brightness of environment including the LED display.

The LED display of any preceding clause, wherein the at least one controller determines the ambient brightness of the environment based on a current level, where a higher current level indicates a brighter environment.

The LED display of any preceding clause, wherein each of the at least one controller and the plurality of drivers in each of the modules communicate via low voltage differential signaling (LVDS) signals.

The LED display of any preceding clause, wherein the multiple LED lights include a red, a green, and a blue (RGB) lights, each of which is to be separately controlled to emit the amount of light in accordance with corresponding red, green, and blue grayscale values of a pixel of the image.

The LED display of any preceding clause, wherein the LVDS signals include RGB LVDS and grayscale (GCLK) LVDS, wherein the RGB LVDS corresponds to signals transmitted from each of the at least one controller to drivers connected thereto to control emission of light by the LED lights with respect to each pixel of the image; and the GCLK LVDS corresponds to clock signals transmitted from the at least one controller to the drivers connected thereto and to be used to centrally control timings of emissions of the LED lights.

The LED display of any preceding clause, wherein the modules are connected in a series and communicate via serializer/deserializer (SerDes) devices.

The LED display of any preceding clause, wherein each of the at least one controller in each of the modules comprises: a synchronous random-access memory (SRAM); and a circuitry for performing, via the SRAM, one or more centralized operations with respect to the image.

The LED display of any preceding clause, wherein: the circuitry of the at least one controller comprises at least one of: an image data correction unit for carrying out centralized image correction; a time-spatial enhancement unit for performing centralized time and spatial domain image enhancement; and a computation module for centralized parasitic capacitance correction.

The LED display of any preceding clause, wherein each module within the modules is a distinct Printed Circuit Board (PCB), resulting in a plurality of PCBs.

The LED display of any preceding clause, wherein a single power supply provides power to each PCB in the plurality of PCBs.

A module for controlling light emitting diode (LED) lights in at least one display panel included in an LED display having a plurality of connected display panels, comprising: at least one controller each of which having a centralized synchronous random access memory (SRAM) and a circuitry for performing at least one centralized operation on image data to be visualized on the at least one display panel of the LED display; and a plurality of drivers, including row and column drivers, coupled with the at least one controller and the at least one display panel in the LED display for driving LED lights associated therewith in accordance with the image data, wherein each driver in the plurality of drivers comprises at least one current level adjustor, wherein the at least one current level adjustor adjust current drawn by an LED signal generator based on an ambient brightness of environment including the LED display.

The module of any preceding clause, wherein the at least one controller determines the ambient brightness of the environment based on a current level, where a higher current level indicates a brighter environment.

The module of any preceding clause, wherein the at least one controller and the plurality of drivers communicate via low voltage differential signaling (LVDS) signals.

The module of any preceding clause, wherein the LED lights include a red, a green, and a blue (RGB) lights, each of which is to be separately controlled to emit an amount of light in accordance with corresponding red, green, and blue grayscale values of a pixel of the image data.

The module of any preceding clause, wherein the LVDS signals include RGB LVDS and grayscale (GCLK) LVDS, wherein the RGB LVDS corresponds to signals transmitted from each of the at least one controller to drivers connected thereto to control emission of light by the LED lights with respect to each pixel of the image data; and the GCLK LVDS corresponds to clock signals transmitted from the at least one controller to the drivers connected thereto and to be used to centrally control timings of emissions of the LED lights.

The module of any preceding clause, wherein the at least one controller and the plurality of drivers are connected in a series and communicate via serializer/deserializer (SerDes) devices.

The module of any preceding clause, wherein the at least one controller comprises: a synchronous random-access memory (SRAM); and a circuitry for performing, via the SRAM, one or more centralized operations with respect to the image data.

The module of any preceding clause, wherein: the circuitry of the at least one controller comprises at least one of: an image data correction unit for carrying out centralized image correction; a time-spatial enhancement unit for performing centralized time and spatial domain image enhancement; and a computation module for centralized parasitic capacitance correction.

The module of any preceding clause, wherein the module is a Printed Circuit Board (PCB).

The module of any preceding clause, wherein a single power supply solely associated with the PCB provides power to the PCB.

A light emitting diode (LED) display, comprising: display panels connected to form the LED display, wherein each of the display panels includes a matrix of units, each of which is represented by LED lights that can be lit in a manner determined based on a corresponding pixel of an image to be visualized on the LED display; modules for controlling the LED lights in the LED display based on content of the image, wherein each of the modules includes therein at least one controller and a plurality of drivers operating together to control an amount of light emitted by each of LED lights in some of the display panels according to pixel values in a corresponding portion of the image, wherein each driver in the plurality of drivers undergoes five states, for all channels, which repeat in an order of: a Compensation state, a Turn on constant current state, a Turn off constant current state, an Anti-Interference state, and a Newline state.

The LED display of any preceding clause, wherein the channels comprise a red channel, a green channel, and a blue channel.

The LED display of any preceding clause, wherein the channels further comprise at least one grayscale channel.

The LED display of any preceding clause, wherein the at least one grayscale channel comprises a high grayscale output channel and a low grayscale output channel.

The LED display of any preceding clause, wherein each driver in the plurality of drivers increases a duration of the Anti-Interference state for the low grayscale output channel, thereby shortening an amount of coupling time between the high grayscale output channel and the low grayscale output channel.

The LED display of any preceding clause, wherein configuration of the Anti-Interference state provides a tradeoff between power consumption and quality of the LED display, where a longer time in the Anti-Interference state results in a greater power consumption and a smaller coupling effect.

The LED display of any preceding clause, wherein the Compensation state places each channel at a fixed voltage after line wrapping.

The LED display of any preceding clause, wherein a grayscale clock is generated by the at least one controller, the grayscale clock being used by the plurality of drivers to control timings of emissions of the LED lights.

The LED display of any preceding clause, wherein the grayscale clock does not use multiplication or division.

The LED display of any preceding clause, wherein performance of each driver in the plurality of drivers depends on a frequency of the grayscale clock.

A module for controlling light emitting diode (LED) lights in at least one display panel included in an LED display having a plurality of connected display panels, comprising: at least one controller each of which having a centralized synchronous random access memory (SRAM) and a circuitry for performing at least one centralized operation on image data to be visualized on the at least one display panel of the LED display; and a plurality of drivers, including row and column drivers, coupled with the at least one controller and the at least one display panel in the LED display for driving the LED lights associated therewith in accordance with the image data, wherein each driver in the plurality of drivers undergoes five states, for all channels, which repeat in an order of: a Compensation state, a Turn on constant current state, a Turn off constant current state, an Anti-Interference state, and a Newline state.

The module of any preceding clause, wherein the channels comprise a red channel, a green channel, and a blue channel.

The module of any preceding clause, wherein the channels further comprise at least one grayscale channel.

The module of any preceding clause, wherein the at least one grayscale channel comprises a high grayscale output channel and a low grayscale output channel.

The module of any preceding clause, wherein each driver in the plurality of drivers increases a duration of the Anti-Interference state for the low grayscale output channel, thereby shortening an amount of coupling time between the high grayscale output channel and the low grayscale output channel.

The module of any preceding clause, wherein configuration of the Anti-Interference state provides a tradeoff between power consumption and quality of the LED display, where a longer time in the Anti-Interference state results in a greater power consumption and a smaller coupling effect.

The module of any preceding clause, wherein the Compensation state places each channel at a fixed voltage after line wrapping.

The module of any preceding clause, wherein a grayscale clock is generated by the at least one controller, the grayscale clock being used by the plurality of drivers to control timings of emissions of the LED lights.

The module of any preceding clause, wherein the grayscale clock does not use multiplication or division.

The module of any preceding clause, wherein performance of each driver in the plurality of drivers depends on a frequency of the grayscale clock.

A light emitting diode (LED) display, comprising: display panels connected to form the LED display, wherein each of the display panels includes a matrix of units, each of which is represented by multiple LED lights that can be lit in a manner determined based on a corresponding pixel of an image to be visualized on the LED display; modules for controlling the LED lights in the LED display based on content of the image, wherein each of the modules includes therein at least one controller and a plurality of drivers operating together to control an amount of light emitted by each of LED lights in some of the display panels according to pixel values in a corresponding portion of the image, wherein: each of the at least one controller and the plurality of drivers in each of the modules communicate via low voltage differential signaling (LVDS) signals; a send chip sending data via the LVDS signals; and a receiving chip receiving the LVDS signals comprises a delay register which controls a relative delay of a clock signal and the data.

The LED display of any preceding clause, wherein the send chip sends the data via the LVDS signals on a rising edge of a clock signal and on a falling edge of the clock signal.

The LED display of any preceding clause, wherein additional receiving chips receive data from the receiving chip, the additional receiving chips comprise delay registers; and wherein when the receiving chip is in a calibration mode, the additional receiving chips are in a calibrated mode.

The LED display of any preceding clause, wherein after calibrating of the receiving chip, each of the additional receiving chips are calibrated in succession.

The LED display of any preceding clause, wherein when the LVDS signals are below a threshold speed and the delay register is at a maximum delay, the data can be received without timing errors.

The LED display of any preceding clause, wherein the send chip places the receiving chip into a calibration mode by sending a predetermined value multiple times at high speed.

The LED display of any preceding clause, wherein the receiving chip, upon receiving the predetermined value, adjusts the delay register until the predetermined value is received correctly.

A module for controlling light emitting diode (LED) lights in at least one display panel included in an LED display having a plurality of connected display panels, comprising: at least one controller each of which having a centralized synchronous random access memory (SRAM) and a circuitry for performing at least one centralized operation on image data to be visualized on the at least one display panel of the LED display; and a plurality of drivers, including row and column drivers, coupled with the at least one controller and the at least one display panel in the LED display for driving the LED lights associated therewith in accordance with low voltage differential signaling (LVDS) signals from the at least one controller, wherein: the at least one controller controls, via the LVDS signals to the plurality of drivers in the module, timing and amount of light emitted by the LED lights in the at least one display panel based on values of pixels in a portion of an image corresponding to the at least one display panel; a send chip sending data via the LVDS signals; and a receiving chip receiving the LVDS signals comprises a delay register which controls a relative delay of a clock signal and the data.

The module of any preceding clause, wherein the send chip sends the data via the LVDS signals on a rising edge of a clock signal and on a falling edge of the clock signal.

The module of any preceding clause, wherein additional receiving chips receive data from the receiving chip, the additional receiving chips comprise delay registers; and wherein when the receiving chip is in a calibration mode, the additional receiving chips are in a calibrated mode.

The module of any preceding clause, wherein after calibrating of the receiving chip, each of the additional receiving chips are calibrated in succession.

The module of any preceding clause, wherein when the LVDS signals are below a threshold speed and the delay register is at a maximum delay, the data can be received without timing errors.

The module of any preceding clause, wherein the send chip places the receiving chip into a calibration mode by sending a predetermined value multiple times at high speed.

The module of any preceding clause, wherein the receiving chip, upon receiving the predetermined value, adjusts the delay register until the predetermined value is received correctly.

Those skilled in the art will recognize that the present teachings are amenable to a variety of modifications and/or enhancements. For example, although the implementation of various components described above may be embodied in a hardware device, it may also be implemented as a software only solution, e.g., an installation on an existing server. In addition, the techniques as disclosed herein may be implemented as a firmware, firmware/software combination, firmware/hardware combination, or a hardware/firmware/software combination.

While the foregoing has described what are considered to constitute the present teachings and/or other examples, it is understood that various modifications may be made thereto and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

1. A light emitting diode (LED) display, comprising:
display panels connected to form the LED display, wherein each of the display panels includes a matrix of units, each of which is represented by multiple LED lights that can be lit in a manner determined based on a corresponding pixel of an image to be visualized on the LED display; and
modules for controlling the multiple LED lights in the LED display based on content of the image, wherein each of the modules includes therein at least one controller and a plurality of drivers operating together to control an amount of light emitted by each LED light in the multiple LED lights in some of the display panels according to pixel values in a corresponding portion of the image,
wherein each of the at least one controller and the plurality of drivers in each of the modules communicate via low voltage differential signaling (LVDS) signals.

2. The LED display of claim 1, wherein the multiple LED lights include a red, a green, and a blue (RGB) lights, each of which is to be separately controlled to emit an amount of light in accordance with corresponding red, green, and blue grayscale values of a pixel of the image.

3. The LED display of claim 2, wherein
the LVDS signals include RGB LVDS and grayscale (GCLK) LVDS, wherein the RGB LVDS corresponds to signals transmitted from each of the at least one controller to drivers connected thereto to control emission of light by the LED lights with respect to each pixel of the image; and
the GCLK LVDS corresponds to clock signals transmitted from the at least one controller to drivers connected thereto and to be used to centrally control timings of emissions of the LED lights.

4. The LED display of claim 1, wherein the modules are connected in a series and communicate via serializer/deserializer (SerDes) devices.

5. The LED display of claim 1, wherein each of the at least one controller in each of the modules comprises:
a synchronous random access memory (SRAM); and
a circuitry for performing, via the SRAM, one or more centralized operations with respect to the image.

6. The LED display of claim 5, wherein:
the circuitry of the at least one controller comprises at least one of:
an image data correction unit for carrying out centralized image correction;
a time-spatial enhancement unit for performing centralized time and spatial domain image enhancement; and
a computation module for centralized parasitic capacitance correction.

7. The LED display of claim 1, wherein each module within the modules is a distinct Printed Circuit Board (PCB), resulting in a plurality of PCBs.

8. The LED display of claim 7, wherein on each module a controller within the at least one controller transmits data to at least a portion of drivers within the plurality of drivers.

9. The LED display of claim 7, wherein a single power supply provides power to each PCB in the plurality of PCBs.

10. The LED display of claim 7, wherein each PCB in the plurality of PCBs has a distinct power supply.

11. The LED display of claim 7, wherein:
a common power supply provides a first voltage to each PCB in the plurality PCBs; and
each PCB in the plurality of PCBs has a distinct power supply, the distinct power supply of each PCB providing a second voltage to the each PCB, the distinct power supply of each PCB only extending power to a PCB on which the distinct power supply is located.

12. The LED display of claim 1, wherein the at least one controller generates the LVDS signals.

13. A module for controlling LED lights in an LED display, comprising:
at least one controller; and
a plurality of drivers operating together to control an amount of light emitted by each of the LED lights in at least a portion of the LED display according to pixel values in a corresponding portion of an image,
wherein each of the at least one controller and the plurality of drivers in each of the modules communicate via low voltage differential signaling (LVDS) signals.

14. The module of claim 13, further comprising:
at least one serializer/deserializer (SerDes) device used to communicate with at least one neighboring module.

15. The module of claim 13, wherein the LED lights include a red, a green, and a blue (RGB) lights, each of which is to be separately controlled to emit an amount of light in accordance with corresponding red, green, and blue grayscale values of a pixel of the image.

16. The module of claim 15, wherein
the LVDS signals include RGB LVDS and grayscale (GCLK) LVDS, wherein the RGB LVDS corresponds to signals transmitted from each of the at least one controller to drivers connected thereto to control emission of light by the LED lights with respect to each pixel of the image; and
the GCLK LVDS corresponds to clock signals transmitted from the at least one controller to drivers connected thereto and to be used to centrally control timings of emissions of the LED lights.

17. The module of claim 13, wherein:
each of the at least one controller comprises:
a synchronous random access memory (SRAM); and
a circuitry for performing, via the SRAM, one or more centralized operations with respect to the image.

18. The module of claim 17, wherein:
the circuitry of the at least one controller comprises at least one of:
an image data correction unit for carrying out centralized image correction; a time-spatial enhancement unit for performing centralized time and spatial domain image enhancement; and
a computation module for centralized parasitic capacitance correction.

19. The module of claim 13, wherein each module includes a power supply specific to the module.

20. The module of claim 13, wherein the at least one controller generates the LVDS signals.
